(19) United States
(12) Patent Application Publication
(10) Pub. No.: US 2012/0142415 A1
(43) Pub. Date: Jun. 7, 2012

(54) Video Show Combining Real Reality and Virtual Reality

(76) Inventor: L. Jon Lindsay, Houston, TX (US)

(21) Appl. No.: 13/309,242

(22) Filed: Dec. 1, 2011

Related U.S. Application Data
(60) Provisional application No. 61/419,318, filed on Dec. 3, 2010.

(51) Int. Cl. A63F 13/00

(52) U.S. Cl. 463/33

(57) ABSTRACT

A video show is recorded in a tangible medium for distribution and presentation to an audience. The video show comprises video portions of a player based on a real person wearing a head mounted display through which the real person sees a virtual reality object with which the real person attempts to interact while moving within a real environment. The video show also comprises generated virtual video portions of the virtual reality object within a virtual reality environment and depicting any action of the virtual reality object in response to attempts by the real person to interact with the virtual reality object, at least a portion of the virtual reality environment corresponding to the real environment.

### CROSS-REFERENCE TO RELATED APPLICATIONS

This patent document claims priority to Provisional Patent Application No. 61/419,318 filed Dec. 3, 2010, under 35 U.S.C. §119(e), which is incorporated herein by reference in its entirety.

### BACKGROUND

Head mounted displays have been available for many years to enable a user to see a three-dimensional (3D) scene while wearing the head mounted display like a visor or helmet. Additionally, as the user's head turns, the displayed scene can be changed in such a manner that the user has the impression of looking around at, and possibly moving around within, the 3D scene. Consequently, it has long been a desire of video game makers to develop video games that use head mounted displays, so the game player can experience full-immersion virtual reality (VR) as if actually being inside a computer-generated world of the game.

Various limitations have hampered commercial realization of such full-immersion VR video games. For example, some head mounted displays can be so bulky, or may require the use of such additional hardware, as to render the head mounted display too difficult or inconvenient for a game player to use comfortably while moving around, even if it is only the player's head that is moving. Additionally, the quality or resolution of the image (often due to the difficulty of making a high-resolution display in the small form factor of head mounted displays, as well as to the processing power or speed limitations of a consumer-level computer or game console) is typically relatively poor and, thus, dissatisfying compared to the capability of a common computer display or television screen. Furthermore, the hardware and software needed to render a realistic and compelling 3D game environment is typically too expensive for most game enthusiasts to afford. In addition, most game enthusiasts do not have sufficient available physical space in which to move around, so the game designers are thus hampered in their ability to create a truly compelling illusion of moving around within a large, complex or interesting computer-generated world of the game.

Due to these (and possibly other) limitations, video game makers have failed to develop video games that adequately take advantage of the 3D capabilities of the available head mounted displays. In fact, some of these limitations, such as insufficient available physical space, may render it impossible to ever successfully merge the capabilities of head mounted displays with video games to create a commercially viable, truly compelling full-immersion VR gaming experience for the average consumer. A long-felt need thus exists for a commercially viable video gaming use for head mounted displays.

It is with respect to these and other background considerations that the present invention has evolved.

### SUMMARY

According to some embodiments of the present invention, the problems associated with finding a legitimate, commercially-viable use for head mounted displays in video gaming are resolved or alleviated primarily by merging such technologies with various apparatus and processes for making a video show for the viewing pleasure of an audience, rather than for the benefit of the participants in the video show. The audience generally views a video show generated by combining real persons with VR elements to create a viewing experience similar to a televised sporting event, a game show or a reality-TV show, but with players who appear to interact with the VR elements.

The audience members do not have to buy the head mounted displays. Instead, the company producing or staging the event or show may buy only as many head mounted displays as are needed for the real persons/players participating in the event or show. The price of the hardware and software may, therefore, be a relatively insignificant expense in comparison to other costs of producing the event or show.

Additionally, the processing power of the hardware used to stage the event or show does not have to be very great, since the real persons/players do not necessarily have to see fully rendered scenes in order to participate in the event or show. Therefore, any details of scenes or objects that are cosmetic in nature, or are generated primarily for the viewing pleasure of the audience, do not have to be generated for the real persons/players to see. Instead, such details may be generated solely in the video that is distributed to the audience, rather than in the video seen by the real persons/players via their head mounted displays. In this manner, the hardware used to stage the event or show may be minimized to reduce cost, complexity or the risk of malfunctions.

Additionally, in order to make the video show more compelling for the audience, a variety of techniques for enhancing game play are described herein. Such enhancement techniques generally include causing the players to appear to move faster or farther than they actually can, making the game environment appear larger or more complex or more spectacular than it actually is and/or enabling the players or game objects to appear to defy the laws of nature.

A more complete appreciation of the present disclosure and its scope, and the manner in which it achieves the above noted improvements, can be obtained by reference to the following detailed description of presently preferred embodiments taken in connection with the accompanying drawings, which are briefly summarized below, and the appended claims.

### BRIEF DESCRIPTION OF THE DRAWINGS

FIG. 1 is a simplified view of example real and virtual reality elements for making a video show or playing a virtual reality video game according to at least one embodiment of the present invention.

FIG. 2 is a simplified view of example real elements for use in making a video show or playing a virtual reality video game, as shown in FIG. 1, according to at least one embodiment of the present invention.

FIG. 3 is a simplified enlarged view of a real person/player shown in FIGS. 1 and 2 in accordance with at least one embodiment of the present invention.

FIG. 4 is a simplified view of example virtual reality elements for use in making a video show or playing a virtual reality video game, as shown in FIG. 1, according to at least one embodiment of the present invention.

FIG. 5 is a simplified schematic diagram of a video camera and video merger equipment for use in making a video show according to at least one embodiment of the present invention.

FIG. 6 is a simplified schematic diagram of example hardware attached to or carried by real persons/players along with computers for use in making a video show or playing a virtual reality video game according to at least one embodiment of the present invention.

FIG. 7 is a simplified schematic diagram of alternative example hardware attached to or carried by real persons/players along with computers for use in making a video show or playing a virtual reality video game according to at least one embodiment of the present invention.

FIG. 8 is a simplified schematic diagram of example hardware for use in making a video show or playing a virtual reality video game according to at least one embodiment of the present invention.

FIG. 9 is a simplified elevation view of a real setting or environment and a virtual reality setting or environment illustrating one or more features for use in making a video show or playing a virtual reality video game according to at least one embodiment of the present invention.

FIG. 10 is a simplified drawing of a real person/player and a virtual reality player illustrating one or more features for use in making a video show or playing a virtual reality video game according to at least one embodiment of the present invention.

FIGS. 11 and 12 are simplified drawings of a real person/player and virtual reality elements illustrating one or more features for use in making a video show or playing a virtual reality video game according to at least one embodiment of the present invention.

FIG. 13-21 are simplified drawings of real persons/players, real settings or environments and virtual reality settings or environments illustrating various features for use in making a video show or playing a virtual reality video game according to at least one embodiment of the present invention.

FIGS. 22-26 are simplified drawings of real and virtual reality persons/players, real and virtual reality settings or environments and real and virtual reality devices illustrating one or more features for use in making a video show or playing a virtual reality video game according to at least one embodiment of the present invention.

FIG. 27 is a simplified drawing of real and/or virtual reality persons/players making a video show and/or playing a virtual reality video game according to at least one embodiment of the present invention.

FIGS. 28-30 are simplified drawings of virtual reality elements illustrating one or more features for use in making a video show or playing a virtual reality video game according to at least one embodiment of the present invention.

FIG. 31-33 are simplified drawings of real and/or virtual reality persons/players making a video show and/or playing a virtual reality video game according to at least one embodiment of the present invention.

FIG. 34 is a simplified drawing of real and virtual reality persons/players in real and virtual reality settings or environments illustrating one or more features for use in making a video show or playing a virtual reality video game according to at least one embodiment of the present invention.

### DETAILED DESCRIPTION

Various embodiments and features of the present invention involve augmented/virtual reality video games or sports and/or video shows based on such augmented/virtual reality video games or sports. The video shows are generally made for the benefit, amusement or entertainment of a viewing audience. The video games are generally made as the primary subject matter of the video shows, but are also made for the benefit, amusement or entertainment of people or players who play or participate in the video games. In some embodiments, therefore, the video games do not necessarily involve the video shows.

In order to make the video games, and the video shows based thereon, interesting to the players, as well as to the viewing audience, many of the features described herein involve various devices and/or techniques for creating the appearance that the real persons/players are actually “in” the video game. The video audience, thus, sees the real persons/players, or virtual reality players based on the real persons/players, appear to move around in a virtual reality (VR) setting or environment (or a hybrid real/VR setting or environment) and/or to interact with VR objects, devices or characters. And the real persons/players wear a head mounted display (preferably 3D, but 2D is an option) through which they see the VR setting or environment and/or the VR objects, devices or characters while they participate in the video game and attempt to interact with any of the VR objects, devices or characters.

It is desirable according to various embodiments of the present invention, not only to create the appearance that the players are actually “in” the video game, but also to maintain some realism in the “look and feel” of the video game. To this end, some of the features and embodiments described herein enable a real camera operator to record real video footage of the real persons/players in the act of playing or participating in the video game in a manner that takes into account the VR setting or environment and/or the VR objects, devices and characters with which the real persons/players attempt to interact. To record such real video footage, a modified video camera handled by the camera operator, not only records the video footage, but also has a display on which some of the VR elements (e.g. setting components, environmental enhancements, objects, devices, characters, etc.) of the augmented VR video game or sport can be displayed (as they are generated in real time) along with the real elements. To the camera operator, therefore, it appears that the modified video camera is recording both real and VR video footage. In this manner, the camera operator is better able to set up camera shots and angles during game play that will show, not only the real persons/players (and any real objects or elements), but also some of the VR elements.

Additionally, in order to make the video games, and the video shows based thereon, even more interesting to the players, as well as to the viewing audience, many of the features described herein also involve various devices and/or techniques for making it appear that the players have superhuman capabilities or that any of the players or objects are magical or able to violate the laws of physics. For example, the players may appear to fly without proper visible support or run extraordinarily fast or lift objects which, if they were real, would weigh several tons.

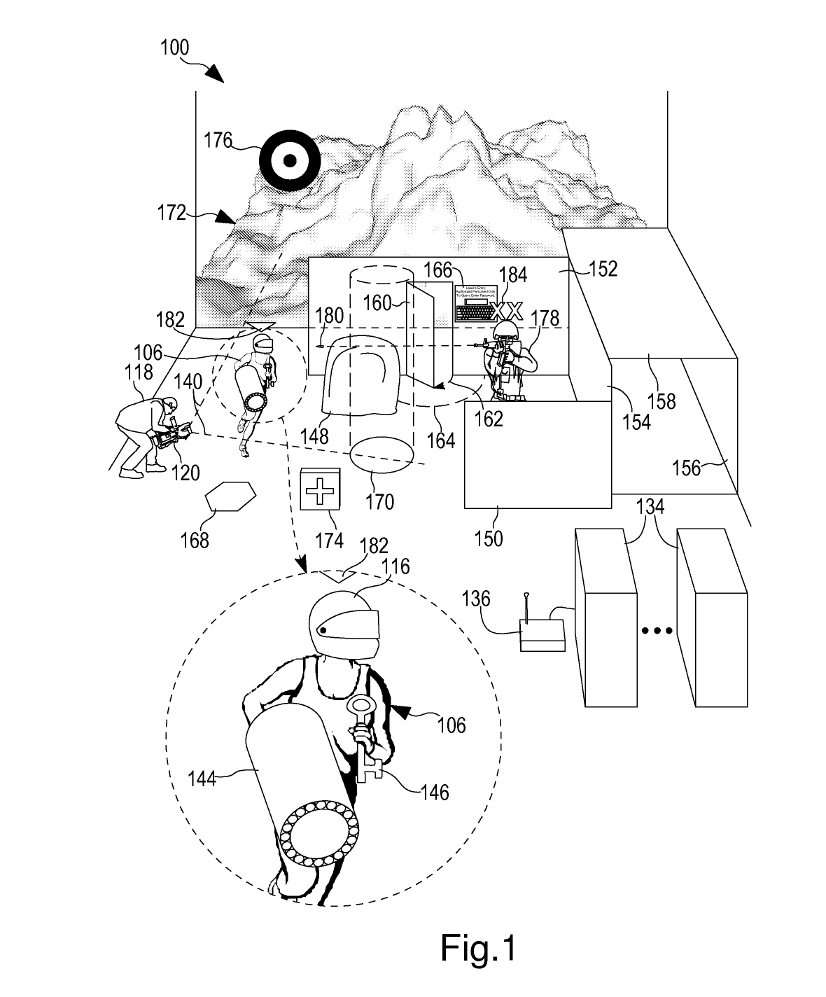

A video show according to various embodiments of the present invention, or made according to various embodiments of the present invention, generally includes one or more video segments showing a real/VR environment 100 formed by combining recorded video of a real setting or environment 102 with computer generated video of a VR setting or environment 104, as shown in FIGS. 1, 2, 3 and 4. (Alternatively, some or all of the video segments of the video show may present only the VR setting or environment 104.) Within the combined real/VR environment 100, one or more real persons, or players, 106 (FIGS. 1-3) play or perform or participate in a VR game or sport. The resulting video show is recorded in a tangible medium for distribution and presentation. In this (or like) manner, the video show is provided to a viewing audience similar, in some embodiments, to the manner in which a television event is broadcast or transmitted to a television-viewing audience or an Internet video is transferred to a user's computer.

In some embodiments, the recorded video of the real setting or environment 102 generally includes video image portions based on real elements 106-112. The generated video of the VR setting or environment 104 includes video image portions of VR elements or objects 114. The various video image portions are combined, according to a variety of embodiments, to form hybrid real/VR video segments for the video show. The hybrid real/VR video segments, thus, show the combined real/VR environment 100 (FIG. 1) with the real persons/players 106 interacting, or attempting to interact, with some of the VR elements 114 and optionally with some of the real elements 108-112 and/or one or more other real persons/players 106 while playing or participating in the game or sport. Alternatively, some of the real elements 106-112 may correspond to some of the VR elements 114, so that each corresponding VR element 114 replaces or obscures (partially or completely) the corresponding real element 106-112 in some or all of the video segments of the video show.

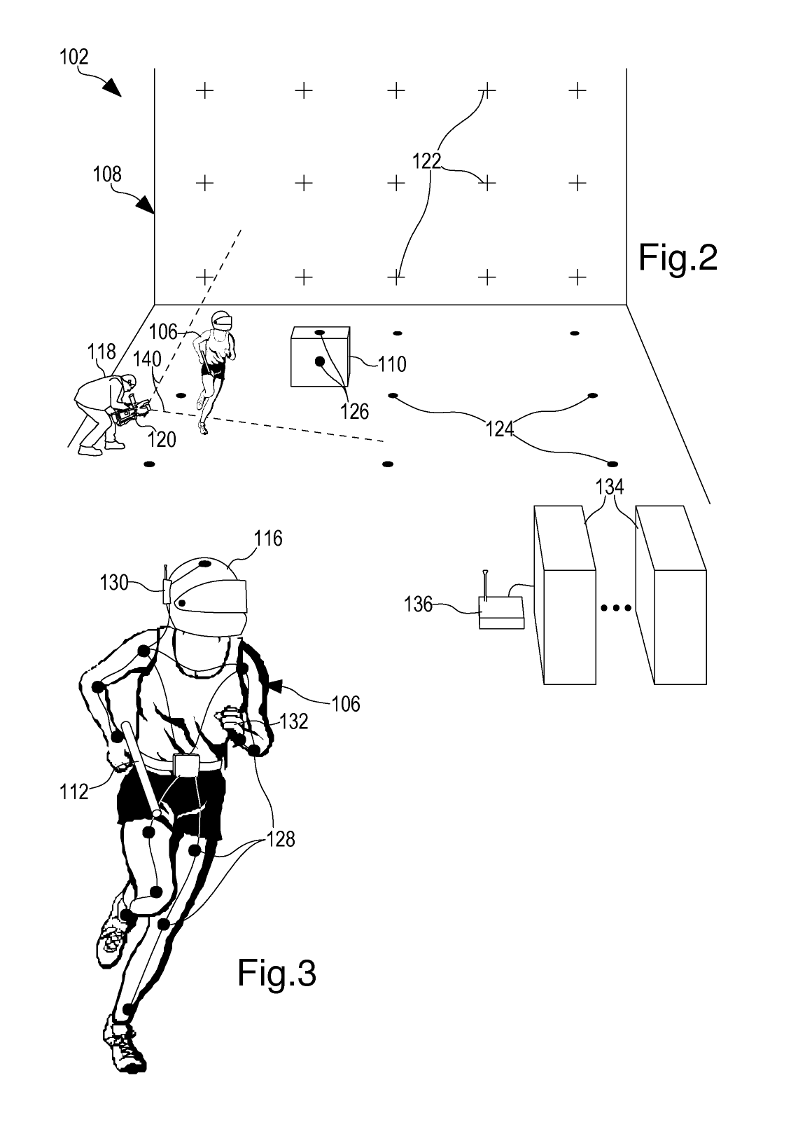

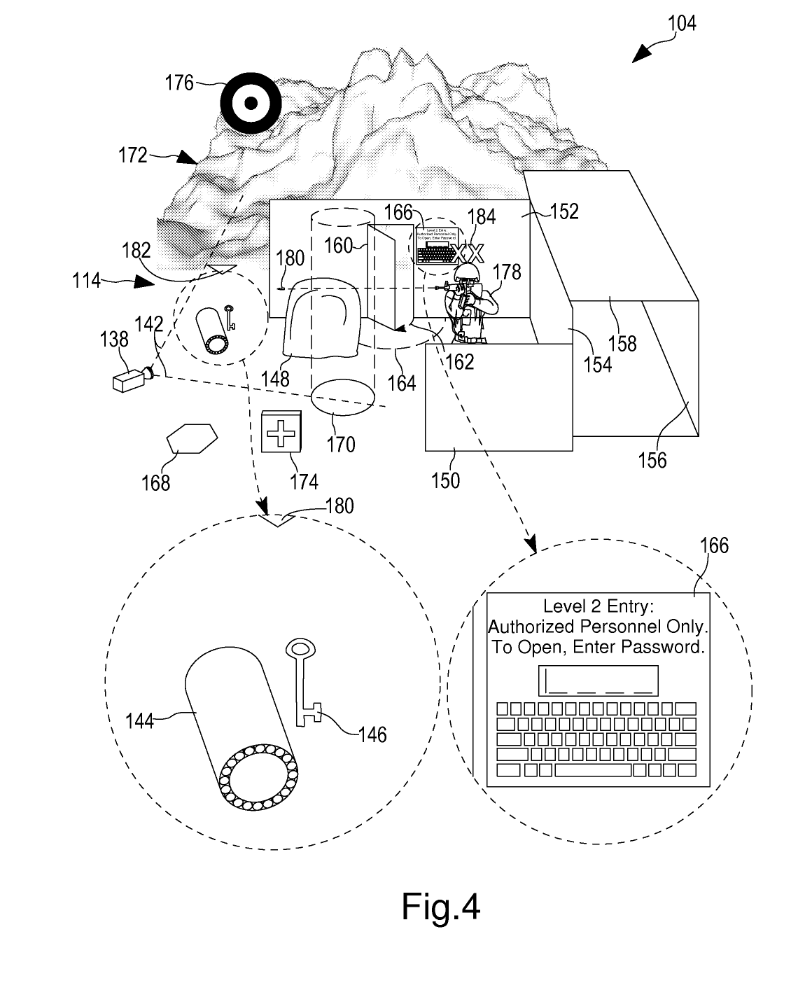

The real elements generally include one or more of the real person/player 106, a real setting, stage, arena, space or environment 108, set components 110 and props 112, among other possible real objects. See FIGS. 2 and 3 and further descriptions below. The VR elements 114 generally include set components, props, targets, obstacles, vehicles, other VR objects, etc. See FIGS. 1 and 4 and further descriptions below.

In accordance with various embodiments, the real person/player 106 sees some or all of the real elements 108-112 and some or all of the VR elements 114 through a head mounted display 116. By being able to see some or all of the VR elements 114, the real person/player 106 can interact with some of the VR elements 114 in real time while participating in the game or sport.

Additionally, in certain embodiments, a camera operator 118 also sees some or all of the real elements 108-112 and the VR elements 114 through a display screen of a camera 120. Thus, the camera operator 118 is able to best set up camera angles, or camera shots, to record the real (and sometimes the VR) action and elements 106-112 of the game or sport in real time. In this manner, according to various embodiments of the present invention, the VR game or sport is made into a spectator program, similar to televised sporting events, TV game shows or reality television programs, but with VR components for the viewing pleasure of the audience.

Unlike a conventional video game in which the players merely operate a controller while watching the video game action on a display screen (e.g. a TV or computer display), the real persons/players 106 are generally inserted into the action of the game, which is done for the enjoyment of the spectators or audience, as well as for the enjoyment of the real persons/players 106. Additionally, unlike a conventional motion picture “green-screen” scene in which actors perform choreographed movements while being recorded in front of a green screen and computer generated objects are later added to the recorded video, the real persons/players 106 can see the computer generated VR elements 114 through the head mounted displays 116 while interacting with some of the VR elements 114 in real time without pre-scripted choreography of their actions.

In some embodiments, the real camera 120 (FIGS. 1 and 2), manipulated by the camera operator 118, generally records video data and/or captures motion/location data of some of the real elements 106-112. Also, various conventional motion capture devices and orientation/location/motion sensors, markers or tags (e.g. 122, 124, 126, 128, 130; FIGS. 2 and 3) placed within the real space 108 and/or on the real person/player 106 and/or on some of the real objects (e.g. 110 and 112) generate orientation, location and motion data related to the orientation/location/motion of some of the real elements (e.g. 106, 110 and 112) within the real space 108 during game play. Similar sensors (not shown) on the camera 120 generate data related to the orientation, motion and/or location of the camera 120, as described below. The camera 120 also generates data representative of its camera settings (e.g. focus, zoom, etc.). Additionally, various control devices (e.g. the prop 112 and a glove 132; FIG. 3), typically operated by the real person/player 106, generate data representative or indicative of actions made by the real person/player 106.

One or more computers 134 (FIGS. 1 and 2), or other appropriate electronic hardware elements, receive the various types of data via one or more wired or wireless communication devices (e.g. 136). With this data, the computers 134 generate a three-dimensional (3-D) representation of the desired VR elements 114 (FIG. 4) in such a manner that the VR elements 114 correspond to, and can be superimposed onto (including completely and/or partially obscuring), recorded video images of many of the real elements (e.g. 106, 108, 110 and/or 112; FIGS. 2 and 3). Also, as any of the real elements 106, 110 and/or 112 move or deform in the real space 108, the computers 134 change any corresponding VR elements 114 in order to make the corresponding VR elements 114 appear to move or deform accordingly. The computers 134, thus, generate a hybrid real/VR video of action that occurs within the combined real/VR environment 100 (FIG. 1). With some optional variations that may be appropriate for each type of viewer, the hybrid real/VR video is viewed by the real person/player 106 (through the head mounted display 116 in order to play or participate in the game or sport), the camera operator 118 (through the camera 120 or a separate display screen in order to set up camera shots and angles in real time) and the viewing audience (through a television, computer screen or other display device in order to be a spectator of the game or sport).

A video (preferably 3D, but 2D is an option) of the VR elements 114 combined (in some embodiments) with recorded video of the real elements 106-112 is generated by one or more of the computers 134 from the point of view of the real person/player 106. This video is transmitted from the computers 134 via the communication devices 136 to the head mounted display 116 worn by the real person/player 106. The real person/player 106, thus, sees the VR elements 114 from the point of view of the real person/player 106 through the head mounted display 116 superimposed or overlaid onto (whether completely or partially obscuring) some or all of the real elements (e.g. 108, 110 and/or 112) and/or of the real setting or environment 102. Generally, the real person/player 106 sees the VR elements 114 so that the real person/player 106 can interact with some of the real elements (e.g. 108, 110 and/or 112) and/or of the VR elements 114 in real time in order to participate in the VR game or sport.

Furthermore, a video of the VR elements 114 is generated by one or more of the computers 134 from the point of view of the camera 120 (FIGS. 1 and 2) as if there were a corresponding VR camera 138 (FIG. 4) within the environment of the VR elements 114. (The real camera 120 and the VR camera 138, thus, generally have a real viewing field 140 and a VR viewing field 142, respectively, that are approximately the same.) This generated video is combined with recorded video of the real elements 106-112, taken by the real camera 120 in order to create the hybrid real/VR video segments of whatever real and VR action takes place in the combined real/VR environment 100 for the video show.

The video show (having, or made with the use of, any of the features described herein) is generally recorded in a non-transitory tangible medium (e.g. within the computers 134 or other appropriate hardware) for eventual distribution and presentation to the audience.

Additionally, the camera 120, or camera operator 118, generally receives (from the computers 134 via the communication devices 136) the hybrid real/VR video of the combination of the recorded real elements and the generated VR elements as seen from the point of view of the camera 120. The hybrid real/VR video is presented on a display screen viewed by the camera operator 118, so that the camera operator 118 can set up camera angles and camera shots in real time during game play or action.

In some embodiments, the video show (or some segments thereof) includes only VR elements. Therefore, for these embodiments, the video may be generated from the point of view of the VR camera 138. But the VR camera 138 doesn't necessarily need to correspond to a real camera (e.g. 120). Instead, the generated video may appear to be recorded by the VR camera 138 as if it were being virtually manipulated by a VR camera operator.

Additionally, according to various embodiments, the real elements 106-112 and/or any of the VR elements 114 seen in the video presented to the real persons/players 106 and the camera operator 118 may have different appearances to the real persons/players 106 and/or the camera operator 118, depending on the needs of the camera operator 118 to set up camera shots and the requirements/rules/restrictions for the real persons/players 106 to play or participate in the game or sport. Furthermore, different embodiments may call for presenting different subsets of the real elements 106-112 and/or of the VR elements 114 to different real persons/players 106 (e.g. real persons/players 106 on different teams) in different manners. In an example, in some embodiments, the real persons/players 106 on the same team may be able to see each other, or location indicators (e.g. virtual information icons/indicators) thereof, regardless of whatever real elements 106-112 and/or VR elements 114 may be interposed between them; whereas, the real persons/players 106 on opposing teams may be fully or partially obscured from each other by any interposing real elements 106-112 and/or VR elements 114.

The real elements 106-112 and the VR elements 114 shown in FIGS. 1-4 illustrate examples, as described below, of a variety of different types of real and VR elements that can be used in the combined real/VR environment 100. Examples, other than those specifically described below, of types of real and VR elements can also be used in the combined real/VR environment 100. It is understood, therefore, that the present invention is not limited to the specific types of real and VR elements explicitly described herein, but that other types of real and VR elements may also be used in the combined real/VR environment 100 and be within the scope of the present invention. Additionally, the present invention is not limited to the number, size, shape or configuration of the real and VR elements shown or described herein. Instead, the exact types, numbers, etc. of the real and VR elements that may be used in any combined real/VR environment 100 within the scope of the present invention are theoretically unlimited, while practically limited only by the requirements or desires or imaginations of whoever is making a video show or VR game within the scope of the present invention.

For simplicity of illustration, only one real person/player 106 is shown in the example of FIGS. 1-4. According to various embodiments, however, any number of real persons/players 106, whether participating as individuals or as team members, may be used. Additionally, any number of teams of real persons/players 106 may be used. Thus, the real persons/players 106 may act in cooperation or competition with each other, depending on the circumstances or rules of the VR game or sport. Furthermore, wherever appropriate, whenever the description herein refers to only one real person/player 106, it is understood that multiple real persons/players 106 may be included in some embodiments.

The real person/player 106 is shown carrying the prop 112 and wearing the glove 132 in the example of FIGS. 1-4. These devices 112 and 132, as described below, enable a variety of actions that can be made by the real person/player 106 to interact with some of the VR elements 114. It is understood, however, that the invention is not limited to a situation in which the real person/player 106 uses only the prop 112 and/or the glove 132. Instead, other devices or means for interacting with any of the VR elements 114 by the real person/player 106 are also within the scope of various embodiments of the present invention.

The prop 112 in this embodiment is generally a control device, such as a computer mouse, joystick, computer gun, motion-sensitive baton, input stylus, pointing device, buttons, switches, other user interface devices, etc. Optionally, the control device prop 112 has one or more buttons, levers, switches, triggers, etc. (A wide variety of such devices are currently available.)

The real person/player 106 can manipulate and/or operate the control device prop 112 to perform a variety of actions to participate in the VR game or sport. For example, in some embodiments, orientation/location/motion data is generated for the control device prop 112, so the control device prop 112 can be aimed like a gun, crossbow, laser, etc. or wielded like a club, sword, ax, whip, etc. The computer 134 generally receives this data and calculates the movement, location, orientation or aim of the control device prop 112 within the combined real/VR environment 100 or with respect to the real person/player 106 or to a target, particularly if the target is one of the VR elements 114.

If the control device prop 112 has any buttons, levers, joysticks, switches, triggers, etc., then when the real person/player 106 activates any such sub-components of the control device prop 112, relevant data is sent to the computer 134. The computer 134, therefore, may generate a response, such as firing a VR projectile, a VR laser beam, a VR arrow, etc. as if it is fired from the control device prop 112. The computer 134 may also generate a result, such as an appearance of hitting a VR target, with consequent destruction, movement, activation, etc. thereof.

Additionally, in spite of the described examples, such responses and results due to actions by the real person/player 106 related to the control device prop 112 are not limited to those related to weaponry. Instead, activation of a button, lever, joystick, switch, trigger, etc. on the control device prop 112 may result in the computer 134 generating any appropriate effect in any VR elements, such as opening a VR door/window/portal, activating a 2D or 3D VR display or message and turning on a VR vehicle or robotic device, among many other desirable or interesting VR effects.

Additionally, in spite of the described examples, such responses and results due to actions by the real person/player 106 related to the control device prop 112 are not limited to those related to the VR elements 114. Instead, activation of a button, lever, joystick, switch, trigger, etc. on the control device prop 112 may result in an effect involving one or more of the real elements 106-112.

Additionally, in some embodiments, given the orientation/location/motion data for the control device prop 112, the computer 134 may calculate or detect any virtual collision of the control device prop 112 with any of the VR elements 114. Algorithms for such collision detection are conventionally available and enable the control device prop 112 to be used as a club, sword, light saber, ax, whip, pointing device, cutting device, activating device, stylus, etc. Thus, the real person/player 106 can use the control device prop 112 to appear to directly (virtually) “contact” or “penetrate” any one or more of the VR elements 114. And the computer 134 generates the consequent result of such action, e.g. shattering, moving, activating, capturing, etc. the contacted or penetrated VR element 114. Furthermore, according to some embodiments, the control device prop 112 may be virtually enhanced by some of the VR elements 114, as described below.

The glove 132 is generally part of a hand motion capture system in this and some other embodiments. Such hand motion capture systems are conventionally available and are capable of capturing relatively fine movements of part or all of the hand of the wearer and transmitting the data to the computers 134 for processing. The glove 132, therefore, enables the real person/player 106 to use the hand, including the fingers, to interact with any of the VR elements 114. For example, with the glove 132, the real person/player 106 can grasp, catch, throw, activate, push, poke, etc. an appropriate one or more of the VR elements 114. Additionally, since the VR elements 114 do not have a real mass, the real person/player 106 can appear to have superhuman strength by lifting a VR object made to look very heavy. Furthermore, according to some embodiments, the glove 132 may be virtually enhanced by some of the VR elements 114, as described below and (in some embodiments) similar to the manner in which the control device prop 112 and the other real elements 106-110 can be enhanced.

The real set component 110 in FIG. 2 is shown as a simple cube or box. Of course, the present invention is not limited to embodiments that use such a real set component 110, but applies to other embodiments using other real set components (e.g. furniture, decks, walls, railings, stairs, ladders, trees, bushes, statues, boulders, scaffoldings or any other real object or structure that can be used in the physical set, stage, arena or other real space 108) and to other embodiments that do not use any real set components. Additionally, according to different embodiments, the real set component 110 may be used as an obstacle that the real person/player 106 must go around or avoid, as a target that the real person/player 106 attacks, as a platform that the real person/player 106 can climb or stand on, or as any appropriate object used for any appropriate purpose, depending on the requirements of the game/sport or the imagination of the designers of the game/sport. In various embodiments, orientation/location/motion sensors, markers or tags 126 attached to the real set component 110 (and optionally in cooperation with camera-generated data) generate orientation, location and/or motion data regarding the real set component 110 and transmit the data to the computers 134. Furthermore, according to some embodiments, the real set component 110 may be virtually enhanced by some of the VR elements 114, as described below.

The real setting, stage, arena or space 108 (FIGS. 1 and 2) may be any appropriate or available area or volume within which the VR game or sport can be played or staged. As described below, the space 108 may be any appropriate size, may be indoors or outdoors and/or may have any appropriate topology or terrain, depending on the VR game or sport.

The various motion capture devices and orientation/location/motion sensors, markers or tags (e.g. 122, 124, 126, 128, 130; FIGS. 2 and 3) may be any of one or more such devices that are currently available or may be developed, sometimes in conjunction with a camera (e.g. 120). The example devices, sensors, markers and tags 122, 124, 126, 128 and/or 130 illustrate a non-exhaustive variety of such devices that may be used. For example, some of these devices are passive and are used with another device, such as a camera, which generates orientation/location/motion data for real elements (e.g. 106, 110 and/or 112) within a real space (e.g. 108). In another example, some of these devices are active and generate the orientation/location/motion data either alone or in combination with other devices.

According to various embodiments, the orientation/location/motion data is transmitted to computers (e.g. 134) to enable the computers 134 to gather and process such data regarding any of the real elements (e.g. 106-112) during game play. The computers (e.g. 134) can, thus, determine the orientation, location and/or motion (and sometimes deformation, breakage, splitting, combining and/or other real changes) of the real elements 106, 110 and/or 112 within the real space 108, and “map” the real objects onto a VR space (within the VR setting or environment 104) in order to further determine how any of the real elements 106-112 and the VR elements 114 correspond to and interact with each other, some examples of which are described herein.

In some embodiments, the video show includes real video portions of the real person/player 106 (wearing the head mounted display 116 through which the real person/player 106 sees the VR elements/objects 114 with which the real person/player 106 attempts to interact during the game play) combined with generated VR video portions of the VR elements/objects 114 (as the real person/player 106 interacts with the VR elements/objects 114).

Additionally, in some embodiments, with the orientation/location/motion data for the real person/player 106, the computers 134 may generate a VR person/player corresponding to and superimposed or mapped onto the real person/player 106, while the real person/player 106 attempts to interact with the VR elements/objects 114. Therefore, some embodiments of the video show may involve combining generated VR video of the VR person/player (from the captured motion of the real person/player 106) with generated VR video of the VR elements/objects 114. For some embodiments, therefore, when the video show is described herein as having both real and VR video portions, it is understood to include embodiments that have only VR video portions

In various embodiments, the computers 134 may present the real elements 106-112 and the VR elements 114 to the real persons/players 106 and/or the camera operator 118 through the head mounted display 116 and/or the camera 120, respectively, in such a manner as to completely or partially obscure any of the real elements 106-112 and/or any of the other VR elements 114 that appear to be behind other ones of the real elements 106-112 and/or the VR elements 114 in the foreground. Additionally, depending on the visual imagery it is desired for the real persons/players 106, the camera operator 118 and/or the viewing audience to see, some of the real elements 106-112 and/or the VR elements 114 may or may not be viewable by the real persons/players 106, the camera operator 118 or the viewing audience through other ones of the VR elements 114.

In a typical conventional video game, the game characters controlled by the players cannot pass through walls or “solid” objects within the game. However, in some embodiments of the present invention, since the real persons/players 106 are moving around in the real setting or environment 102, they may occasionally appear to virtually pass through or collide with some of the VR elements 114 unhindered if there are no corresponding real elements in the way. However, the rules or requirements of playing or participating in the game or sport may prohibit passing through or colliding with some or all of the VR elements 114. Therefore, depending on the embodiment, when the computers 134 detect that the real person/player 106 (or any portion of the body of the real person/player 106 or of a real or VR prop or costume carried or worn by the real person/player 106) has collided with or passed through any of the VR elements 114, a variety of different “penalty” responses may be generated by the computers 134. For instance, the real person/player 106 may be temporarily or permanently appear to be removed from the game and/or may be required to leave the real setting or environment 102 for a period of time or for the remainder of the game or sport. Alternatively or in addition, some or all possible interactions that the real person/player 106 could ordinarily make with some or all of the VR elements 114 may be effectively “turned off,” or “reduced,” during the penalty time period, so the real person/player 106 can have no, or a lesser, affect on game play while under the penalty. In some embodiments, points may be taken away from the real person/player 106 (or the player's team). Additionally, in some types of games or sports, the real persons/players 106 have “health points” and/or “ability points,” which can be reduced as a penalty.

In another example embodiment, the penalty response includes a VR representation of the body of the real person/player 106 (viewable by the real person/player 106, the camera operator 118 and/or the viewing audience) that is left standing adjacent to the VR element 114 at the point where the real person/player 106 initially collided with or passed through the VR element 114. Alternatively, a VR representation of the body of the real person/player 106 may be animated to appear to pass out and fall down next to the VR element 114. In another alternative, a VR icon or marker may indicate the location where the offending action occurred. In addition to or instead of any other penalties, the real person/player 106 may simply be required to take the time go to the VR representation of the body of the real person/player 106 or to the VR icon/marker and continue game-play at that point. Alternatively, the real person/player 106 may be required to go to a designated starting, or “spawning,” point at which to resume game-play. Loss of playing time or game progress may thus be part, or all, of the penalty.

In various embodiments, such penalties may be displayed in any appropriate manner to the viewing audience of the video show, as well as to the real person/player 106 and/or the camera operator 118. For example, some or all VR enhancements or augmentations (e.g. as described below) associated with the offending real person/player 106 may be “turned off” and/or an alternative VR enhancement or augmentation may be superimposed onto or near the real person/player 106 as a visual indicator that the real person/player 106 (or the player's team) has been penalized. E.g., a VR penalty flag/card or penalty time counter may be superimposed above the real person/player 106 or a VR enclosure may be superimposed surrounding and virtually isolating the real person/player 106 during the penalty period. Additional penalty situations are described below.

The VR elements 114, according to various embodiments, may include VR props/tools 144 and 146 (FIGS. 1 and 4), VR set components 148-176, VR enemies/people/characters 178, VR projectiles 180 and VR information icons/indicators 182 and 184, among other items. Some of the VR set components 148-176 may be nonfunctional VR setting enhancements included in the VR setting or environment 104 primarily for aesthetic purposes; while others of the VR set components 148-176 may serve a desired function, examples of which are described herein. Whether functional or nonfunctional, however, the VR elements 114 (e.g. 144-184) described herein are for illustrative purposes only. Therefore, it is understood that the present invention is not necessarily limited to the particular VR elements 114 (e.g. 144-184) described, but includes any other VR elements that can be generated in a VR setting or environment, whether or not the real person/player 106 can interact with them, as described for several of these examples.

The VR prop 144 is shown as a large hand-held cannon or Gatling gun. The VR gun prop 144 is an example of a VR element that overlays, enhances or augments a real element. In this case, the real element is the control device prop 112 (FIG. 3). In some embodiments of this example, orientation, location and/or motion sensors (not shown) are included in or on the control device prop 112. The data from the orientation, location and/or motion sensors is transmitted to the computers 134 (FIGS. 1 and 2). The computers 134 determine the orientation, location and/or motion of the control device prop 112 within the real setting or environment 102 and correspondingly within the VR setting or environment 104 and the combined real/VR environment 100. The computers 134 then “map”, overlay or superimpose the VR gun prop 144 onto the control device prop 112 in the video of the combined real/VR environment 100 generated by the computers 134. And as the control device prop 112 moves, the computers 134 make corresponding changes to the VR gun prop 144 in order to maintain the mapping, overlaying or superimposing of the VR gun prop 144 onto the control device prop 112.

Thus, the video seen by the audience and by the real person/player 106 (in the head mounted display 116, FIGS. 1 and 2) and by the camera operator 118 (in the display screen of the camera 120) shows the VR gun prop 144 mimicking the orientation, location and motion of the control device prop 112. In some embodiments, therefore, the real person/player 106 appears in the video show to be handling the VR gun prop 144. Additionally, when the real person/player 106 activates a button, lever, joystick, switch, trigger, etc. on the control device prop 112, any appropriate response may occur, such as appearing to fire a projectile or laser from the VR gun prop 144 or converting the VR gun prop 144 into a different VR prop element, among many other possible responses.

Furthermore, in some embodiments, collision detection algorithms may be employed to determine when the VR prop 144 virtually collides with any of the real elements 106-112 or any of the other VR elements 114. An appropriate response may then be generated by the computers 134. For example, the real person/player 106 may wield the VR prop 144 in such a manner that it virtually collides with another of the VR elements 114. The computers 134 may then generate a response to this VR collision, such as appearing to break, move, bend, deform, activate, disintegrate, etc. the other VR element 114. (Alternatively, the computers 134 may generate one or more penalties, such as those described above and below.) In some embodiments, game play may depend on such interaction between the VR elements 114, including the VR prop 144. Additionally, the generated response to the VR collision may affect the VR prop 144 instead of, or in addition to, the other VR element 114. For example, the real person/player 106 may appear to drop the VR prop 144 or the VR prop 144 may appear to break, move, bend, deform, activate, disintegrate, etc. in response to detecting a VR collision between the VR prop 144 and any of the other VR elements 114 or any of the real elements 106-112. Then the real person/player 106, in addition to or instead of any other penalties, may have to retrieve or fix the VR prop 144 or get a new VR prop 144 to overlay the control device prop 112.

It is understood that the invention is not limited to this particular example involving the control device prop 112 and the VR gun prop 144. Instead, any appropriate real element, whether handled by the real person/player 106 or not, may be overlaid, enhanced or augmented by any appropriate VR element/object in a variety of embodiments that include such real and VR elements. Furthermore, it is understood that non-weapon-related real and VR elements may be involved in any of these embodiments.

The VR prop 146 is shown as a large old-fashioned key. The VR key prop 146 is an example of a VR element that can appear to the audience, the real person/player 106 and the camera operator 118 to be wielded or manipulated by the real person/player 106 in a manner that depends on the orientation, location and/or motion of the real person/player 106 or a part of the real person/player 106. Being manipulated by the real person/player 106, the VR key prop 146 is also an example of a VR element that can be used by the real person/player 106 in conjunction with one or more of the other VR elements 114. For example, the VR key prop 146 can be used to activate or open another VR element 114 (e.g. a VR door, a VR keyboard/display interface, a VR elevator, a VR vehicle, a VR portal, etc.) when the real person/player 106 holds the VR key prop 146 near or passes it through (as determined by collision detection algorithms mentioned above) such other VR element.

The orientation, location and/or motion of the real person/player 106 or part of the real person/player 106 can be captured by any appropriate motion capture device or system, such as those described above, including the glove 132. In the illustrated example, the VR key prop 146 is handled by the real person/player 106 using the glove 132. Thus, the apparent orientation, location and/or motion of the VR key prop 146 within the video show depends on the orientation, location and/or motion of the hand wearing the glove 132. Additionally, the real person/player 106 can generally see the VR key prop 146 through the head mounted display 116, and the camera operator 118 can generally see the VR key prop 146 in the display screen of the camera 120. The real person/player 106, therefore, moves the hand wearing the glove 132 in order to grab, carry, throw or use the VR key prop 146 in participating in the VR game or sport.

It is understood, however, that the invention is not limited to this particular example involving the glove 132 and the VR key prop 146. Instead, various embodiments may include any appropriate VR elements/objects (whether animate or inanimate) which the real person/player 106 can appear to wield, hold or carry by using any appropriate motion capture device or system, such as those described above, including, but not limited to, the glove 132.

The VR set component 148 is shown as a rock or boulder. The VR set component 148 is an example of a VR element, or a type of VR setting enhancement, generated by the computers 134 to fully or partially obscure a real object as seen by the audience, the real persons/players 106 and/or the camera operator 118. In this case, the boulder VR set component 148 obscures the box real set component 110 (FIG. 2). In this manner, the box real set component 110 is augmented or enhanced with VR features that make it appear to be a boulder. Additionally, since the box real set component 110 may have the orientation/location/motion sensors, markers or tags 126, any movement of or change to the box real set component 110 may be detected, so the computers 134 may change the boulder VR set component 148 accordingly in order to maintain the appearance of the box 110 as the boulder 148.

In some embodiments, the video that the real person/player 106 sees through the head mounted display 116 presents the boulder VR set component 148 in such a manner that the real person/player 106 sees the boulder VR set component 148 and not the box real set component 110. In some embodiments, the video show also includes video image portions that present the boulder VR set component 148 fully obscuring the box real set component 110. Thus, either the real person/player 106 or the viewing audience or both see the combined real/VR environment 100 in which a real obstacle or other object is augmented or enhanced to appear as something different. Additionally, the camera operator 118 may or may not see the box real set component 110 augmented or enhanced to appear as the VR set component 148, but the camera operator 118 may have at least some indication that a real object is present, so the camera operator 118 can avoid running into it when getting into position within the real space 108 of the real setting or environment 102 to set up camera shots and angles.

This feature may be used for, among other reasons, aesthetic purposes to make the visual appeal of the game or sport more interesting, while keeping down production costs of the game or sport. For example, several simple boxes (e.g. 110) may be used as real obstacles (in the real setting or environment 102) that the real person/player 106 must go over or around when traversing what appears to be a boulder-strewn field (in the combined real/VR environment 100).

Additionally, this feature enables not only VR interaction with the VR set component 148, but also a corresponding real interaction with the real object 110, during game play. For example, if the real person/player 106 picks up, stands on or destroys the box real set component 110, the real person/player 106 appears to be picking up, standing on or destroying the boulder VR set component 148.

The VR set component 148, along with any of the other VR elements 114 placed within the combined real/VR environment 100 as described below, may also define a VR pathway. According to some embodiments, therefore, the real person/player 106 may have to follow or stay on the VR pathway in order to properly or most effectively participate in or play the VR game or sport.

It is understood, however, that the invention is not limited to this particular example involving the boulder VR set component 148 and the box real set component 110. Instead, different embodiments may include any appropriate real object fully or partially obscured by any appropriate VR object. Furthermore, other embodiments may include real objects that are not obscured by any VR object. Still other embodiments may not include any real objects.

In the illustrated embodiment of FIGS. 1-4, the VR set components 150-158 are shown as VR walls 150-156 and a VR roof/ceiling 158. Any number of such VR walls 150-156 and VR ceilings 158 may be used to enhance or augment the combined real/VR environment 100 to form a variety of VR spaces, rooms, passageways, houses, buildings, etc. (covered or uncovered) that the real persons/players 106 may have to navigate through when playing or participating in the game or sport. The VR walls 154 and 156 and the VR ceiling 158, for instance, form an example of a VR hallway, tunnel or cave. Alternatively, any of the VR walls 150-156 may simply serve to define separate game-playing areas within the combined real/VR environment 100.

Since the VR walls 150-156 and VR ceilings 158 may define the areas or passageways through which the real persons/players 106 may traverse, any of the penalties described herein may be assessed when any of the real persons/players 106 collides with or passes through any of the VR walls 150-156 or VR ceilings 158. However, according to different embodiments, collisions with the VR walls 150-156 and VR ceilings 158, as with any of the VR elements 114, may be part of the desired actions that the real persons/players 106 are expected to perform when participating in the game or sport. For instance, at some point(s) in the game play, the only way for the real person/player 106 to progress may be to break through one or more of the VR walls 150-156 and VR ceilings 158. To do so, the real person/player 106 may have to shoot the VR walls 150-156 or VR ceilings 158 with a VR weapon that fires a VR projectile or laser beam, blow up the VR walls 150-156 or VR ceilings 158 with a VR bomb, chop at the VR walls 150-156 or VR ceilings 158 with a VR prop (e.g. a VR axe, club or bat) or bodily run and crash through the VR walls 150-156 or VR ceilings 158. In an embodiment in which the real person/player 106 has to hit the VR walls 150-156 or VR ceilings 158 with the player's own brute force, the VR walls 150-156 or VR ceilings 158 may show little or no affect if the real person/player 106 hits the VR walls 150-156 or VR ceilings 158 insufficiently fast or hard, as detected by the computers 134. A penalty for the real person/player 106 hitting the VR walls 150-156 or VR ceilings 158 insufficiently fast or hard may, thus, be to have to return to hit the VR walls 150-156 or VR ceilings 158 again.

In various embodiments, the VR walls 150-156 and VR ceilings 158, as with any of the VR elements 114, may be presented to the audience, the real persons/players 106 (through the head mounted display 116) and/or the camera operator 118 (through the camera 120) in such a manner as to completely or partially obscure any of the real elements 106-112 and/or any of the other VR elements 114 that appear to be behind the VR walls 150-156 and VR ceilings 158. As an example, the intersection line between the floor and the back wall of the real space 108 is shown as a dashed line (FIG. 1) through the VR wall 152, but is not shown through the VR wall 154 or the VR ceiling 158, in order to illustrate different situations in which real objects (e.g. the floor and rear wall of the real space 108) may or may not be viewable to the audience, the real persons/players 106 and/or the camera operator 118 through different ones of the VR elements (e.g. 152, 154, 158). As another example, the VR wall 150 is shown to obscure a portion of the VR wall 154 in order to illustrate situations in which one VR element (or a portion thereof) may not be viewable to the audience, the real persons/players 106 and/or the camera operator 118 through another one of the VR elements. In other embodiments, some VR walls/ceilings (or portions thereof) may be transparent or translucent, thus appearing to be VR windows or VR sun lights, but still having any appropriate restrictions regarding collisions during game play.

It is understood that the present invention is not limited to embodiments using the VR walls 150-156 and VR ceilings 158 illustrated. Rather, various embodiments may use any number (including none), size, shape or configuration of VR walls and VR ceilings.

The VR set component 160 is shown as a VR door 160 set in the VR wall 152. Among other possible uses, such a VR door 160 is an example of a removable VR barrier between different areas within the combined real/VR environment 100 and which the real person/player 106 must “open” or “activate” or remove, or through which the real person/player 106 must pass, in order to progress through the game or sport.

The audience and the real person/player 106 (and optionally the camera operator 118) generally see the door as is appropriate (e.g. opaque, translucent, transparent, etc.) for the particular game or sport. As with any of the VR elements 114, however, depending on the embodiment, the camera operator 118 generally sees the VR door 160 as translucent or transparent, instead of opaque, so the camera operator 118 can set up camera shots and angles as needed in advance of when the real person/player 106 opens or activates or removes the VR door 160.

Depending on the embodiment, the VR door 160 can have one or more of a variety of features. For example, in some embodiments, the VR door 160 may be opened (e.g. in the direction of arrow 162) only when the real person/player 106 has the VR key prop 146 (or other real or VR element) or holds the VR key prop 146 with the glove 132 in a particular manner (e.g. touches/collides the VR key prop 146 to the VR door 160 or a VR icon/marker associated with the VR door 160, moves the VR key prop 146 in a particular pattern in front of the VR door 160, etc.). Alternatively or in combination with the above, the VR door 160 may open only when the real person/player 106 is within a specified VR distance from the VR door 160 (e.g. within VR arc space 164). In another alternative, which may be combined with any of the above, the real person/player 106 may open the VR door 160 only after the real person/player 106 has activated the VR door 160 by performing some other task in the game play. In yet another alternative (also combinable with any of the above), the real person/player 106 may simply knock the VR door 160 open by hitting it with the player's body or with another real or VR element. Other manners of activating or opening the VR door 160, not described herein, are within the scope of the present invention. Additionally, in order to “open”, instead of pivoting, as the VR door 160 appears to do in the direction of arrow 162 in FIGS. 1 and 4, the VR door 160 may appear to slide out of the way, disappear, etc. Other types of VR doors or removable VR barriers are also within the scope of the present invention.

The VR set component 166 is shown as a VR keyboard/display interface 166 (FIGS. 1 and 4) set in the VR wall 152. Among other possible uses, such a VR keyboard/display interface 166 is an example of a VR input and/or output device. In other words, depending on the embodiment, the real person/player 106 can receive information from, and/or input information into, the VR keyboard/display interface 166 during game play. For example, the VR keyboard/display interface 166 may appear as a VR computer display screen that provides hints, tips, maps, past achievements, progress data, reminders, etc. to the real person/player 106 for progressing in the game or sport. Additionally, the VR keyboard/display interface 166 may appear as a VR computer touch screen, or combination touch and display screen. Thus, the real person/player 106 may not only be able to receive information from the VR keyboard/display interface 166, but may also be able to input information thereto. In some embodiments, the VR keyboard/display interface 166 may also present a menu of options that the real person/player 106 can select from in order to obtain a variety of different types of information or perform a variety of different types of tasks that can be performed with a typical graphical user interface.

The computers 134, thus, not only generate the image of the VR keyboard/display interface 166 for the audience, the real person/player 106 and the camera operator 118 to see, but also (depending on the embodiment) detect keystrokes or button-pushes made by the real person/player 106. Collision detection algorithms, mentioned above, may be used to detect the keystrokes or button-pushes, since, according to some embodiments, the real person/player 106 inputs data/information (e.g. with the VR touch screen keyboard/keypad, as illustrated) using appropriate types of the control device prop 112 and/or the glove 132. In this manner, the computers 134 can detect the precise movements made by the real person/player 106 to determine which keys or buttons have been pressed.

In the illustrated example (see the enlarged portion of FIG. 4), the VR keyboard/display interface 166 displays a message to the real person/player 106 that reads, “Level 2 Entry: Authorized Personnel Only. To Open, Enter Password.” Also displayed is a VR touch screen keyboard with which the real person/player 106 can type, in this case, to enter a password, e.g. to unlock the VR door 160. And the typed password appears in a four-character input space above the VR touch screen keyboard. The VR keyboard/display interface 166, thus, illustrates another alternative example for opening the VR door 160, in addition to those described above. Other uses for any appropriate variations of the VR keyboard/display interface 166 as a VR input and/or output device are also within the scope of the present invention. For example, the VR keyboard/display interface 166 may alternatively involve a puzzle, which the real person/player 106 has to solve, e.g. by inputting a solution or manipulating puzzle components, in order to progress in the VR game or sport. Furthermore, the invention is not limited to embodiments that include such a VR keyboard/display interface 166.

The VR set components 168 and 170 are shown as a VR area 168 and a VR volume 170 (e.g. circles, hexagons, cylinders, clouds or other regular or irregular shapes or location markers) within the combined real/VR environment 100. The VR 2D or 3D spaces 168 and 170 are examples of VR areas and volumes, determined by the computers 134, that the real person/player 106 can enter or pass through, or cause another real element (e.g. 106, 110 and/or 112) or a VR element 114 to enter or pass through, to cause a predefined response to occur.

In one example, when the real person/player 106 steps into one of the VR spaces 168 and 170, the VR door 160 may be opened or some other feature in the game or sport may be activated or deactivated. In another example, e.g. with multiple real persons/players 106 and multiple VR spaces 168 and 170, it may be a requirement for all of the VR spaces 168 and 170 to be entered simultaneously in order to activate or deactivate a feature in the game or sport. Depending on the embodiment, entering one or more of the VR spaces 168 or 170 may be necessary in order for the real person/player 106 to progress through the game or sport. Alternatively, the real person/player 106 may acquire a new VR prop or bonus points that provide a required or optional benefit or assist in playing the game or sport.

On the other hand, an undesirable or negative response may occur when the real person/player 106 enters one of the VR spaces 168 or 170. In one example, the real person/player 106 loses points or the use of real or VR elements in the game play upon entering one of the VR spaces 168 or 170. In another example, the real person/player 106 “dies” upon entering one of the VR spaces 168 or 170. In some embodiments, therefore, either of the VR set components 168 and 170 may be a VR trap, hole or pit that the real person/player 106 can appear to virtually “fall” into.

In other words, the VR spaces 168 and 170 represent VR areas that the real person/player 106 may want either to enter or to avoid. Thus, the VR spaces 168 and 170 are, according to some embodiments, generic VR elements (2D areas and/or 3D volumes) that may be designed into the game or sport to help or hinder the real person/player 106 in the game play in any appropriate or desired manner. Also, the VR spaces 168 and 170 may be stationary or moving (periodic or continuous) within the combined real/VR environment 100 and/or temporary or permanent during game play.

Furthermore, the VR spaces 168 and 170 may be either visible or invisible to the audience and/or the real person/player 106, depending on the design of the game or sport. However, it is generally preferable, though not necessarily required, for the camera operator 118 to be able to see the VR spaces 168 and 170 in order to set up camera shots and angles during game play.

It is understood that the specific examples described for the VR spaces 168 and 170 are for illustrative purposes only, and do not limit the scope of the present invention. Additionally, various embodiments may have any number of the VR spaces 168 and 170, including none.

The VR set component 172 is shown as a VR landscape that appears to be outside the physical boundaries of the real space 108. In this particular case, the VR landscape set component 172 appears to be beyond the rear wall of the real space 108 and can also be seen through the VR door 160 in the VR wall 152 (which otherwise obscures the VR landscape set component 172) when the VR door 160 is open. The VR landscape set component 172 is an example of a VR element that enhances the aesthetic features of the game or sport with or without being used in the actual game play, as well as an example of a VR element that appears to extend beyond the physical boundaries of the real space or setting 108. As a result, the “world” in which the real person/player 106 participates in the game or sport appears to be much larger, more complex and more interesting than the real space 108 through which the real person/player 106 physically traverses during game play.

Since the VR set component 172 enhances the aesthetic features of the game or sport, the VR set component 172 may be visible to the audience. However, since the VR set component 172 is not necessarily used in the game play, it is optional for the VR set component 172 to be visible to the real person/player 106 and the camera operator 118. On the other hand, for embodiments in which it is intended that the real person/player 106 interact with the VR set component 172, the real person/player 106 and the camera operator 118 may be able to see the VR set component 172 through the head mounted display 116 and the camera 120, respectively. Such interaction, for example, may involve the real person/player 106 targeting any VR elements 114 that appear to be outside the physical boundaries of the real space 108 with appropriate VR weaponry or receiving information from such VR elements 114, among other possibilities.

Additionally, the VR set component 172 is not limited to the specific example illustrated, but may be of any subject, whether a natural scene (e.g. a mountain, a canyon, a forest, a desert, a solar system, etc.) or an artificial scene (e.g. a bridge, a cityscape, a space port, etc.) or a combination of many different types of scenery. The VR set component 172 may also simply be one or more VR objects of any appropriate types. Furthermore, the present invention is not limited to embodiments that include a VR set component 172, but also includes embodiments that do not include a VR set component 172.

The VR set component 174 is shown as a VR package disposed within the combined real/VR environment 100. In this particular example, the VR package 174 is a VR first aid package with a medical cross symbol on the surface thereof. The VR package 174 is an example of a VR item that the real person/player 106 may encounter at any appropriate location within the combined real/VR environment 100. By running into it or hitting it with a weapon or projectile (or other appropriate action), the real person/player 106 virtually “picks up” the VR package 174 in order to acquire VR things, such as health points (e.g. in the case of the VR first aid package), VR weapons, VR ammunition (ammo packs), upgrades, game-play tips/clues, or other VR items. The medical cross symbol is shown in dashed lines to indicate that it is optional, since the VR package 174 may be any type of VR item. Additionally, depending on the embodiment, the VR package 174 may or may not be visible to the audience, the real person/player 106 and/or the camera operator 118. Furthermore, the present invention is not limited to this particular example, but may include any types or numbers (including zero) or combinations of the VR package 174 in the combined real/VR environment 100.

The VR set component 176 is shown as a VR generic target, which can be disposed at any desired location within the combined real/VR environment 100, whether appearing to be located inside or outside of the real space 108. Any of the VR elements 114 may be used as a target for anything that the real person/player 106 is able to hit it with, so it is not necessary for the VR target 176 to look like a generic target, as it does in this example. The VR target 176 is, thus, simply a generic example of a VR item that can be targeted by the real person/player 106.

The real person/player 106 may shoot the VR target 176 with a VR projectile or VR beam weapon, hit it with a real or VR prop or interact with it in any other appropriate manner as desired by the designers of the game or sport. Upon hitting the VR target 176, as detected by collision algorithms (mentioned above) run by the computers 134, the response may be that the real person/player 106 receives points, that another feature in the game or sport is activated and/or any other response appropriate for the game or sport. Additionally, depending on the embodiment, the VR target 176 is generally visible to the audience, the real person/player 106 and the camera operator 118, but may or may not appear to be the same type of object to each. Furthermore, the present invention is not limited to this particular example, but may include any types or numbers (including zero) or combinations of the VR target 176 in the combined real/VR environment 100.

The VR enemy/person/character 178 is shown as a VR soldier using a VR weapon to fire the VR projectile 180 at the real person/player 106. The VR enemy/person/character 178 is, thus, an example of an animated VR element that actively fights against the real person/player 106 during game play. The VR enemy/person/character 178 may be a VR human, as illustrated, but may also be any other VR animal, monster, fictional creature, robot, machine, etc. that can fight or defend against the real person/player 106.

In some embodiments, the VR enemy/person/character 178 is animated by a real person (not shown) who is not physically within the real space 108. In this case, orientation/location/motion data for the real person is received by the computers 134. The computers 134 generate the VR enemy/person/character 178 from the orientation/location/motion data and place the VR enemy/person/character 178 within the combined real/VR environment 100 of the real person/player 106. The VR enemy/person/character 178 may, thus, be based on another real person/player 106 (optionally within a separate, but similar, other combined real/VR environment 100), who is an opponent of the first real person/player 106 within the game or sport. Alternatively, the VR enemy/person/character 178 may be animated by a real person who is not another real person/player 106 in the game, but is included as another type of VR obstacle to the real person/player 106. In another alternative, the VR enemy/person/character 178 is fully generated by the computers 134 without reference to motion-capture of a real person.

Additionally, in some embodiments in which the VR enemy/person/character 178 is generated from a real person (not shown), the movements and actions of any VR weapon wielded by the VR enemy/person/character 178 may be generated from an appropriate real device handled by the real person. For example, the real person may use a device similar to the control device prop 112 and/or the glove 132, for which orientation/location/motion data is also generated, in order to cause the VR weapon of the VR enemy/person/character 178 to appear to be animated.

The VR weapon may be a VR gun (as illustrated in FIGS. 1 and 4), a VR cannon, a VR bow or crossbow with VR arrows or bolts, a VR sword, a VR light saber, a VR club, etc. In an embodiment in which the VR weapon fires the VR projectile 180 (e.g. VR bullets, as illustrated, or a VR beam, or VR arrows or bolts, etc.), the collision detection algorithms, running on the computers 134, detect when the real person/player 106 has been “hit”, and an appropriate response is generated. Likewise, the real person/player 106 generally fights back (in some embodiments), so the computers 134 detect when the VR enemy/person/character 178 has been hit and generate an appropriate response thereto.

Additionally, depending on the embodiment, the VR enemy/person/character 178 and the VR projectile 180 are generally visible to the audience, the real person/player 106 and the camera operator 118, but may or may not appear the same to each. Furthermore, the present invention is not limited to this particular example, but may include any types or numbers (including zero) or combinations of the VR enemy/person/character 178 and the VR projectile 180 in the combined real/VR environment 100.

The VR information icons/indicators 182 and 184 are shown as a VR symbol (e.g. a triangle) and VR letters “XX”, respectively, disposed in the space over the heads of the real person/player 106 and the VR enemy/person/character 178. The VR information icons/indicators 182 and 184 are, thus, examples of VR elements that display information related to the real persons/players 106, the VR enemy/person/character 178 or any other real or VR element of interest. Any appropriate symbols, lettering, numbering, etc. may be used for the VR information icons/indicators 182 and 184 to convey any desired information. And each VR information icon/indicator 182 and 184 may be located relative to the relevant real person/player 106, VR enemy/person/character 178 or any other real or VR element of interest in any appropriate position, including, but not limited to, above the head of the real person/player 106 or the VR enemy/person/character 178, as illustrated.

For example, in some embodiments involving teams, all the real persons/players 106 on the same team generally have the same or similar (e.g. in color, shape, etc.) VR information icons/indicators 182 and 184, that are clearly different from the VR information icons/indicators 182 and 184 of the real persons/players 106 on another team, so that all team members can readily distinguish fellow teammates from opposing team real persons/players 106. In an alternative, each real person/player 106 may see certain types of information (e.g. health points, hit points, rankings, etc.) regarding fellow teammates, but different information (or no information) regarding opposing team real persons/players 106. In another alternative, the real persons/players 106 may send certain signals or specific desired information to their teammates by selecting the VR information icons/indicators 182 and 184 (e.g. using a selector switch mounted on their person or a prop, or with voice-activated commands, etc.).

In each case, the real persons/players 106 may be able to see some or all of the VR information icons/indicators 182 and 184, but for the camera operator 118, depending on the implementation, it may be an unnecessary distraction. Additionally, the audience may or may not be able to see the VR information icons/indicators 182 and 184, depending on the implementation. Furthermore, the present invention is not limited to these particular examples, but may include any types or numbers (including none) or combinations of the VR information icons/indicators 182 and 184 in the combined real/VR environment 100.

Several examples of the VR elements 114 and manners in which the real person/player 106 can interact with the VR elements 114, or pieces/portions/parts thereof, are described hereinabove and hereinafter. In addition to the previously and subsequently described forms of interaction, the real person/player 106 can interact with one or more of the VR elements 114 by battling it, overcoming it, cooperating with it, avoiding it, dodging it, activating it, receiving information from it, reading it, typing on it, pressing it, listening to it, talking to it, destroying it, traversing through it, entering it, standing on it, walking on it, running on it, going around it, climbing it, catching it, throwing it, moving it, attacking it, shooting it, riding it, flying on it, hiding from it and/or touching it. It is understood, however, that the present invention is not limited to these examples (or combinations of these examples) of the VR elements 114 and manners in which the real person/player 106 can interact with the VR elements 114 described herein.

In some embodiments, a physics engine may be used to determine deformation, breaking or movement of any of the VR elements or objects 114. Thus, any of the VR elements or objects 114 may change shape or appearance during the game play. For example, large VR structures may be made to appear to crumble realistically when hit by a VR cannonball or blasted by a VR bomb. The debris thus generated may then form additional VR elements or objects within the VR setting or environment 104.

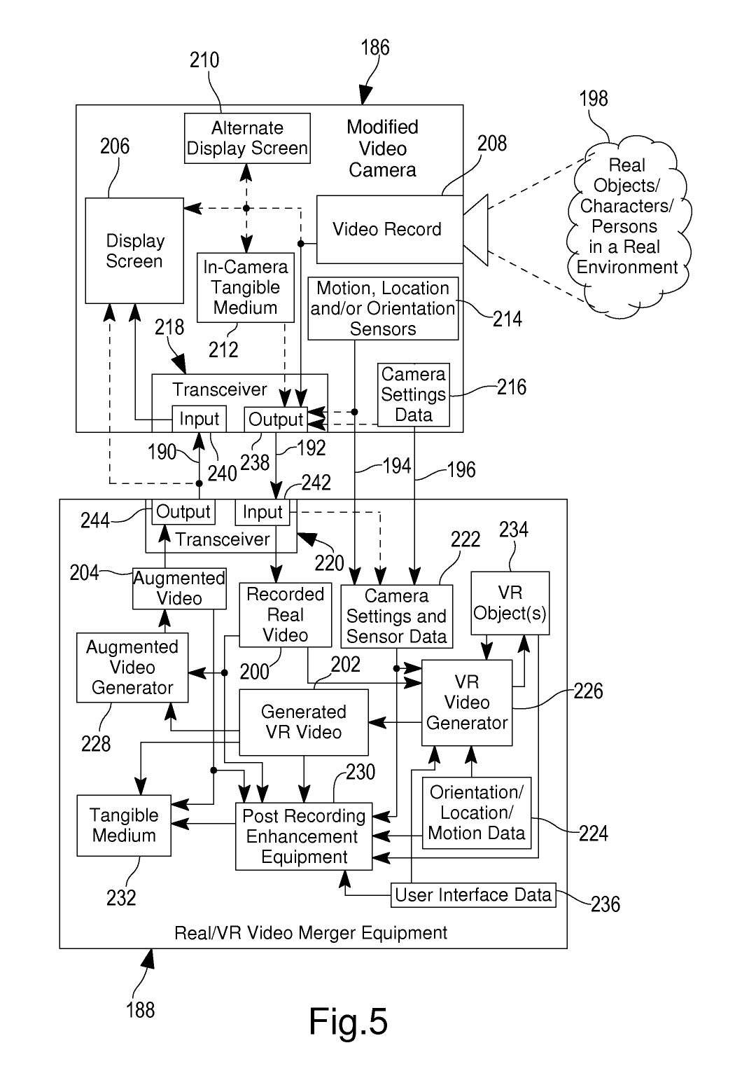

FIG. 5 illustrates some equipment that is generally used in the making of the video show according to some embodiments of the present invention. It is understood, however, that other embodiments may use different equipment or different combinations of equipment or different subcomponents of the equipment. The exact equipment shown is, thus, presented for illustrative purposes only and is not intended to limit the scope of the claims. Additionally, the number of each of the described and/or illustrated components of the equipment may depend on a variety of parameters, such as, but not limited to, the number of camera operators 118 (or cameras 120, FIGS. 1 and 2) and/or real persons/players 106 (or head mounted displays 116, FIGS. 1 and 3) involved in the game or sport.

The equipment in FIG. 5 generally includes a modified video camera 186 and a real/VR video merger equipment 188. The modified video camera 186 and the real/VR video merger equipment 188 are connected by one or more wired and/or wireless transmission lines (e.g. 190, 192, 194 and 196). The modified video camera 186 may represent the camera 120 and/or the head mounted display 116 shown in FIGS. 1, 2 and 3, depending on the features or the application. The real/VR video merger equipment 188 may represent one or more of the computers 134 shown in FIGS. 1 and 2 and/or other appropriate video processing equipment. The transmission lines 190, 192, 194 and 196 may represent data communication by any appropriate wired or wireless communication devices (e.g. the communication devices 136 shown in FIGS. 1 and 2 and/or any transmitters or transceivers attached to the camera 120 and/or the head mounted display 116).

According to this embodiment, the modified video camera 186 generally records 2-D or 3-D video of real objects, characters and/or persons in a real setting or environment 198 (see the description related to the real setting or environment 102 and the real space 108 above). This video (recorded real video 200) is generally transmitted in real time to the real/VR video merger equipment 188. The real/VR video merger equipment 188 generally merges the recorded real video 200 with generated VR video 202 (of the VR objects, characters and environment components described above) to form 2-D or 3-D augmented/merged/hybrid real/VR video (“augmented video”) 204. The augmented video 204 generally includes some or all of the real objects, characters and/or persons in the real setting or environment 198 overlaid or superimposed with some or all of the generated VR objects, characters and environment components as seen from the point of view of the modified video camera 186.

The augmented video 204 is transferred back to the modified video camera 186 and presented on a display screen 206, so the camera user, e.g. the camera operator 118 (in the case of the camera 120 of FIGS. 1 and 2) or the real person/player 106 (in the case of the head mounted display 116 of FIGS. 1 and 3), can see both the real and the VR elements of the augmented video 204 during the playing, performing or participating in the VR game or sport. For embodiments involving multiple camera operators 118 (or cameras 120) or real persons/players 106 (or head mounted displays 116), multiple versions of the augmented video 204 are generated, each from the point of view of one of the camera operators 118 (or cameras 120) and/or real persons/players 106 (or head mounted displays 116).

By being able to see both the real and the VR elements of the augmented video 204, the camera operator 118 can set up camera angles or camera shots in real time in a manner that may most likely provide the best recorded real video 200 of the real objects, characters and/or persons in the real setting or environment 198, so that the resulting video show eventually produced may be most likely to have the best combination of real and VR elements. For the real person/player 106, the ability to see both the real and the VR elements of the augmented video 204 enables the real person/player 106 to be able to interact with some of the real and VR elements where appropriate and to avoid any real or VR obstacles that the real person/player 106 might otherwise run into.

The modified video camera 186 generally includes the display screen 206, video record components 208, an optional alternate display screen 210, an optional in-camera tangible medium 212, one or more motion, location and/or orientation sensors (or markers or tags) 214, camera settings data 216 and a transceiver 218, among other physical and/or logical components or features not shown or described for simplicity. Additionally, the real/VR video merger equipment 188 generally includes the recorded real video 200, the generated VR video 202, the augmented video 204, a transceiver 220, camera settings and sensor data 222, orientation/location/motion data 224, a VR video generator 226, an augmented video generator 228, post recording enhancement equipment 230, a tangible medium 232, VR object(s) data 234 and user interface data 236 among other physical and/or logical components or features not shown or described for simplicity.

The motion, location and/or orientation sensors 214 are generally mounted on or within the modified video camera 186, either as built-in devices or as external devices permanently or temporarily attached to the modified video camera 186. The motion, location and/or orientation sensors 214, thus, generate orientation, location and motion data related to the orientation/location/motion of the modified video camera 186 within the real space 108 (FIG. 2) during game play, or video recording. In some embodiments, the modified video camera 186 may be specifically designed to include such features or functionality. In such cases, the modified video camera 186 may be further designed to transmit data generated by the motion, location and/or orientation sensors 214 through an output 238 of the transceiver 218, or through a separate interface, to any appropriate receiving device, such as the real/VR video merger equipment 188. In some alternative embodiments, on the other hand, the modified video camera 186 may not have been originally designed to include such features or functionality. For example, an ordinary unmodified prior art video camera may be converted into the modified video camera 186 by attaching the motion, location and/or orientation sensors 214 to it. In such cases, the motion, location and/or orientation sensors 214 may be devices that are attached (e.g. with glue, nuts and bolts, adhesive tape, etc.) either permanently or removably to the modified video camera 186 (e.g. on any available surface of, or within any available cavity in, the housing of the modified video camera 186). And in such cases, the data generated by the motion, location and/or orientation sensors 214 is generally transmitted through whatever interface(s) came with the motion, location and/or orientation sensors 214 to any appropriate receiving device, such as the real/VR video merger equipment 188.

The camera settings data 216 generally includes focus, zoom, exposure, aperture, shutter speed, file format, white balance and/or any other appropriate, available or desirable settings of the modified video camera 186. The camera settings data 216 is generally transmitted through the output 238 of the transceiver 218 or another available interface to any appropriate receiving device, such as the real/VR video merger equipment 188. With such data, the real/VR video merger equipment 188 can determine how to properly generate some of the VR images that form the variety of VR elements or objects 114 (FIG. 4), either in real time during game play or recording of the recorded real video 200 or in post production enhancing of the resulting video show. In the case in which the modified video camera 186 is the head mounted display 116 (FIGS. 1 and 3), however, these settings may not be adjustable, so it may not be necessary for the modified video camera 186 in this case to transmit the camera settings data 216 to the real/VR video merger equipment 188. Instead, the camera settings data 216 may simply be stored in, or programmed into, the real/VR video merger equipment 188, so the real/VR video merger equipment 188 can properly create the generated VR video 202 (and thus the augmented video 204) from the point of view of the real person/player 106 (FIGS. 1-3).

The display screen 206 is generally used to present to the user the augmented video 204 received (through an input 240 of the transceiver 218 or through any other appropriate interface) from the real/VR video merger equipment 188. The optional alternate display screen 210, on the other hand, is optionally used to present the recorded real video 200 (produced by the video record components 208) to the user, if needed. In the case of the camera 120 of FIGS. 1 and 2, for instance, the display screen 206 is generally used to present the augmented video 204 to the camera operator 118, so the camera operator 118 can see the augmented video 204. And the optional alternate display screen 210, if present, is generally used to present only the recorded real video 200 to the camera operator 118, so the camera operator 118 can see both the augmented video 204 and the recorded real video 200 if needed.

The display screen 206 and the optional alternate display screen 210 (if present) are generally mounted on the modified video camera 186, either as built-in devices or as external devices permanently or temporarily attached to the modified video camera 186. Thus, in some embodiments, the modified video camera 186 is specifically designed to include both the display screen 206 and the optional alternate display screen 210. In other embodiments, the modified video camera 186 is specifically designed to include only the display screen 206, as long as the modified video camera 186 has the capability to receive video, e.g. the augmented video 204, from an external source and present the received video on the display screen 206. In this case, it may be a further option for the modified video camera 186 to have the capability to switch between the received video and video from the video record components 208 to be presented on the display screen 206. In still other embodiments, the modified video camera 186 is specifically designed to include only one of the display screens 206 or 210, and the non-included display screen 206 or 210 is attached later (e.g. with glue, nuts and bolts, adhesive tape, etc.) either permanently or removably to the modified video camera 186. For example, an ordinary unmodified prior art video camera may be converted into the modified video camera 186 by attaching a second display screen to it to be used as either of the display screens 206 or 210. In this case, the original in-camera display screen may be used as the optional alternate display screen 210 (since the original in-camera display screen would presumably already be able to present the video recorded by the video record components 208, i.e. the recorded real video 200) and the attached display screen may be used as the display screen 206 (since the attached display screen could presumably accept video from any available source, e.g. the augmented video 204 from the real/VR video merger equipment 188).

The optional in-camera tangible medium 212 may be a removable or non-removable video storage medium, e.g. a hard drive, an optical disk, a flash memory, etc. (This option is particularly useful in, though not necessarily limited to, the case in which the modified video camera 186 is the camera 120 of FIGS. 1 and 2.) The optional in-camera tangible medium 212 may be used to store a copy (e.g. a “raw” copy or a backup copy) of the recorded real video 200 (produced by the video record components 208) if needed. The copy of the recorded real video 200 in the optional in-camera tangible medium 212 can later be either transferred to other audio/video or storage equipment (e.g. the real/VR video merger equipment 188) via the transceiver 218 or physically removed from the modified video camera 186 and inserted into another device for storage, copying, editing, etc.

In the real/VR video merger equipment 188, the orientation/location/motion data 224 generally includes orientation, location and motion data generated by the various motion capture devices and orientation/location/motion sensors, markers or tags (e.g. 122, 124, 126, 128, 130; FIGS. 2 and 3) placed within the real space 108 and/or on the real person/player 106 and/or on the real objects (e.g. 110 and 112). Additionally, the orientation/location/motion data 224 generally also includes any orientation/location/motion data of some of the real elements 106-112 captured by the real camera 120. Furthermore, the orientation/location/motion data 224 generally also includes any orientation/location/motion data from the control device prop 112 and/or the glove 132, or other devices for which orientation/location/motion data is also generated. The various sources of this data 224 transmit it to the real/VR video merger equipment 188 to be used in the creation of any part of the generated VR video 202 that depends on such data. This data 224 is, thus, updated as necessary. (Although the schematic block for the orientation/location/motion data 224 is shown in FIG. 5 without an arrow pointing into the block, it is understood that the orientation/location/motion data 224 is generally received through any appropriate transmission means.)

The VR object(s) data 234 generally includes data that defines the VR elements or objects 114 (FIG. 4), i.e. all elements within the VR setting or environment 104. The VR object(s) data 234 for many of the VR elements or objects 114 may be generated by graphic designers, artists or image capture software/hardware prior to game play or video recording. As any of the VR elements or objects 114 change during game play (e.g. destroyed, bent, broken, burnt, discolored or otherwise modified) the VR object(s) data 234 may be updated to reflect the changes.

The user interface data 236 generally includes data indicating actions made by the real person/player 106 using the control device prop 112 or other user interface device(s) that the real person/player 106 may carry, wear or encounter during game play. The user interface data 236, therefore, generally indicates button presses, switch activations, joystick movements, etc. made by the real person/player 106. (Although the schematic block for the user interface data 236 is shown in FIG. 5 without an arrow pointing into the block, it is understood that the user interface data 236 may be received through any appropriate transmission means.)

The camera settings and sensor data 222 is received from the modified video camera 186 through the input 242 of the transceiver 220 or other appropriate interface(s) (e.g. through transmission lines 194 and 196) from the camera settings data 216 and the motion, location and/or orientation sensors 214 of the modified video camera 186. This data 222 is, thus, updated as necessary.

The VR video generator 226 generally receives the recorded real video 200 (if needed), the camera settings and sensor data 222, the VR object(s) data 234, the user interface data 236 and the orientation/location/motion data 224. Based on this information, the VR video generator 226 creates the generated VR video 202, showing the action of the VR elements or objects 114 (FIG. 4), i.e. any of the elements within the VR setting or environment 104, from the point of view of the modified video camera 186. The VR video generator 226, thus, may include any appropriate physics engine(s), in some embodiments, in order to enhance the realism of the action involving the VR elements or objects 114. Therefore, any changes to any of the VR elements or objects 114 are generally determined within the VR video generator 226 during game play. Such changes generally result in updates to the VR object(s) data 234. The generated VR video 202 thus created may be provided to the augmented video generator 228, the tangible medium 232 (which may be any one or more removable or non-removable computer-readable storage devices) and optionally to the post recording enhancement equipment 230.

The augmented video generator 228 generally receives the recorded real video 200 and the generated VR video 202. The augmented video generator 228, thus, combines the recorded real video 200 and the generated VR video 202 to form the augmented video 204. The augmented video 204 is transmitted through an output 244 of the transceiver 220 to the modified video camera 186 for presentation on the display screen 206. The augmented video 204 may also be stored in the tangible medium 232 and optionally used in the post recording enhancement equipment 230.

The equipment illustrated in FIG. 5 and as described above generally enables the playing of the game or sport for the video show that is the subject of some embodiments of the present invention, since FIG. 5 and the description show and describe how the camera operator 118 and the real person(s)/player(s) 106 (FIGS. 1-3) can perform their activities during game play or recording. The production of the final video show, on the other hand, may be more involved in some embodiments. The video show, for instance, may include portions of the recorded real video 200, the generated VR video 202 and/or the augmented video 204. However, since the video show is intended for the entertainment of spectators or an audience, the video show may also have some enhanced aspects or additional content or additional viewing angles or a greater level of detail that it is not necessary for the camera operator 118 or the real person/player 106 to see during game play or recording. In fact, it may be acceptable in some embodiments for the camera operator 118 and/or the real person/player 106 to see only simple wire-frame images of the VR elements or objects (e.g. 114 in FIG. 4) in order to properly play the game or participate in the sport. Yet the video show may have fully rendered colorized and texturized images (with shadows where appropriate) for the VR elements or objects 114. Additionally, the VR elements or objects 114 seen in the video show may have some features (e.g. aesthetic, artistic or visual frills, embellishments, trimmings, minutiae or details, such as shadows, additional colors, additional polygons, additional surface features, fringe, banners, artwork or other enhancements or superficial augmentations) that are absent in the augmented video 204 seen by the camera operator 118 and/or the real person/player 106. In some embodiments, the level of detail in the augmented video 204 for the VR elements or objects 114 may depend on the processing power of the computers 134 (FIGS. 1 and 2) and/or the transmission speed/bandwidth of the transmission lines 190-196, in addition to the requirements for playing the game or sport.

If the video show is not presented live (in real time) to the audience, but is recorded for later distribution/presentation, then it can undergo almost any amount of post-production or post-game-play or post-recording enhancement for the audio/visual pleasure of the audience. If the video show is presented live to the audience, on the other hand, then the level of detail for the VR elements or objects 114 may depend simply on the real-time processing power of the computers 134 (FIGS. 1 and 2) and/or other video processing equipment. In either case, the post recording enhancement equipment 230 represents any appropriate computers or other video processing equipment that may or may not be involved in the creation of the augmented video 204, but are used in some embodiments to generate at least part of the video show, such as aesthetic, artistic or visual frills, embellishments, trimmings, minutiae, details or features of the VR elements or objects 114 that are either not necessary or not desirable to have in the augmented video 204 presented to the real person/player 106 and/or the camera operator 118.

The post recording enhancement equipment 230 generally receives the recorded real video 200, the generated VR video 202, the augmented video 204, the camera settings and sensor data 222, the orientation/location/motion data 224, the VR object(s) data 234 and the user interface data 236. With this information, the post recording enhancement equipment 230 adds the aesthetic, artistic or visual frills, embellishments, trimmings, minutiae, details or features to the VR elements or objects 114 or to any frame or segment of the video show. The product of the post recording enhancement equipment 230 is generally stored in the tangible medium 232 and used to form the final video show either for real-time distribution to the audience or in post-production editing.

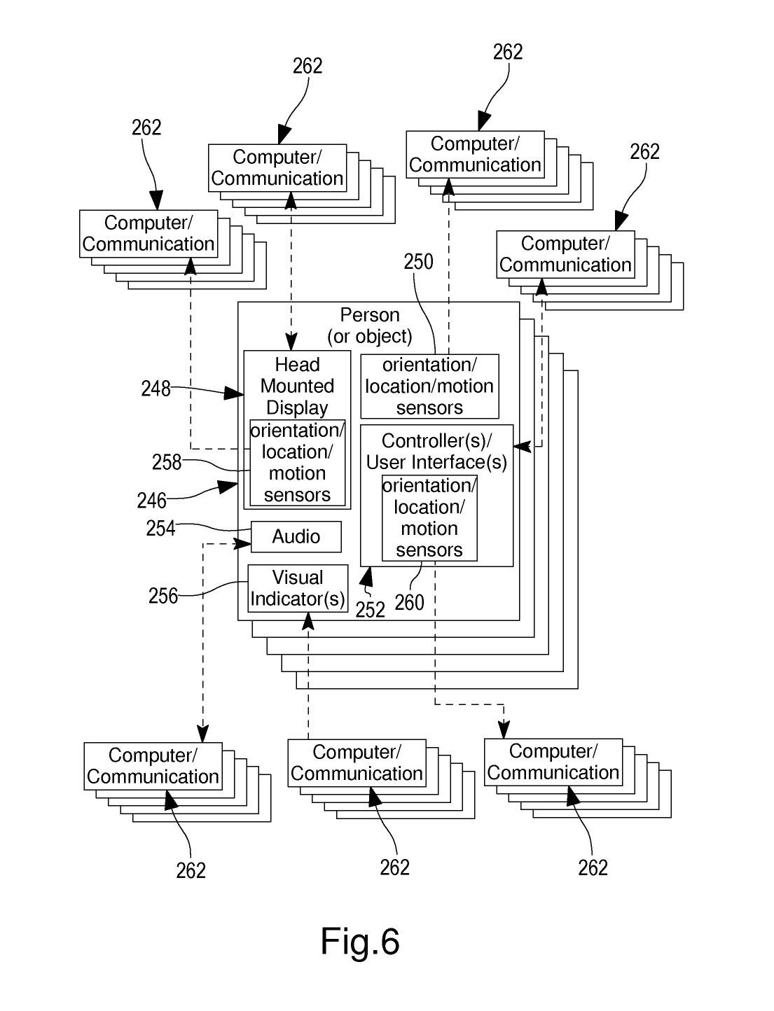

FIGS. 6, 7 and 8 illustrate some embodiments for arrangements between the real persons/players 106, the various real elements 108-112, the glove 132, the motion capture devices and orientation/location/motion sensors, markers or tags 122, 124, 126, 128 and 130, the computers 134 and potential associated subcomponents or peripheral devices. In some embodiments, as shown in FIG. 6, multiple persons (or objects) 246 are involved in the game or sport. Thus, each person 246 has a variety of devices associated therewith (or attached thereto), such as a head mounted display 248, orientation/location/motion sensors (or markers or tags) 250, one or more controller and/or user interface devices (e.g. the control device prop 112 of FIG. 3 and/or pointers, joysticks, buttons, switches, etc.) 252, audio devices 254 and visual indicators 256, among other possible accessories or peripheral devices. Also, the head mounted displays 248 and/or the controller/user-interface devices 252 may further have additional orientation/location/motion sensors (or markers or tags) 258 and 260, respectively, associated therewith (or attached thereto).

Examples of some, though not necessarily all, of the elements 246-260 have been described above with respect to FIGS. 1-3. For instance, the persons (or objects) 246 may include the real persons/players 106 (or the real elements 108-112). The head mounted displays 248 may be similar to the head mounted displays 116. The orientation/location/motion sensors (or markers or tags) 250, 258 and 260 may be similar to the various conventional motion capture devices and orientation/location/motion sensors, markers or tags 126, 128, 130. The controller/user-interface devices 252 may include the prop 112 and the glove 132. Additionally, the audio devices 254 may include microphones, head/ear phones, speakers, etc., particularly (but not exclusively) those types of audio devices suitable for being worn by a person. And the visual indicators 256 may include lights, LEDs, display screens, etc. that the persons 246 may carry or wear to indicate status, rank, team membership, etc.

Each device 248-260 communicates (preferably, but not necessarily, wirelessly) directly with computer and/or communication systems 262 for the receiving, transmitting, processing, manipulating, etc. of the various types of data generated by and/or used by the devices 248-260. The illustrated embodiment of FIG. 6 appears to indicate that each device 248-260 for each person 246 communicates with a separate one of the computer/communication systems 262. Such a configuration is possible, though it is understood that some of the computer/communication systems 262 may communicate with more than one of the various devices 248-260, thereby reducing the total number of computer/communication systems 262.

In general, the computer/communication systems 262 may transmit data received from the various devices 248-260 to the real/VR video merger equipment 188 (FIG. 5) to be stored and used as the orientation/location/motion data 224 (and as the recorded real video 200 in the case of the head mounted displays 248). The data transmission may be before or after any necessary or desired data processing or manipulation that is to be performed on the received data in order for the real/VR video merger equipment 188 to be able to use the data. Additionally, some of the computer/communication systems 262 that communicate with the various devices 248-260 may also be involved in some of the functions described above with respect to the real/VR video merger equipment 188.

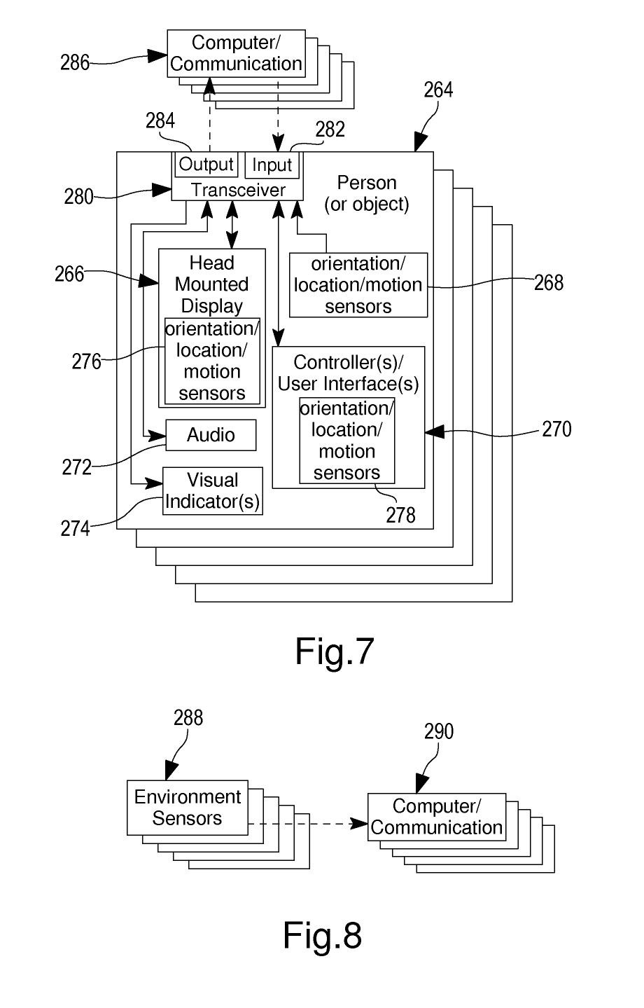

In some embodiments, as shown in FIG. 7, multiple persons (or objects) 264 are involved in the game or sport. Thus, as with the embodiment shown in FIG. 6, each person (or object) 264 has a variety of devices associated therewith (or attached thereto), such as a head mounted display 266, orientation/location/motion sensors (or markers or tags) 268, one or more controller and/or user interface devices (e.g. the control device prop 112 of FIG. 3 and/or pointers, joysticks, buttons, switches, etc.) 270, audio devices 272 and visual indicators 274, among other possible accessories or peripheral devices. Also, the head mounted displays 266 and/or the controller/user-interface devices 270 may further have additional orientation/location/motion sensors (or markers or tags) 276 and 278, respectively, associated therewith (or attached thereto). Examples of some, though not necessarily all, of the elements 264-278 (similar to the elements 246-260, respectively, in FIG. 6) have been described above with respect to FIGS. 1-3.

However, unlike in the embodiment shown in FIG. 6, each person (or object) 264 also has one or more transceiver 280 (preferably, but not necessarily, wireless) associated therewith (or attached thereto). And the transceivers 280 have input interfaces 282 and output interfaces 284 (or a combined I/O interface). Therefore, each device 266-278 shares the one or more transceiver 280 (associated with the person 264 with which the device 266-278 is also associated) in order to communicate with computer and/or communication systems 286 for the receiving, transmitting, processing, manipulating, etc. of the various types of data generated by and/or used by the devices 266-278. In this manner, the total number of simultaneous data transmissions during game play is generally fewer for the embodiment of FIG. 7 than it is for the embodiment of FIG. 6. In other respects, the computer/communication systems 286 are generally similar in form and function as the computer/communication systems 262 of FIG. 6.

Additionally, the illustrated embodiment of FIG. 7 appears to indicate that each device 266-278 for each person 264 communicates with the only one of the computer/communication systems 286, so that one of the computer/communication systems 286 always corresponds with one of the persons 264. Such a configuration is possible, though it is understood that some of the computer/communication systems 286 may communicate with the various devices 266-278 of more than one of the persons 264, thereby reducing the total number of computer/communication systems 286 needed. It is also understood that some of the computer/communication systems 286 may route the communications from some of the various devices 266-278 to multiple other computer/communication systems 286, thereby increasing the total number of computer/communication systems 286 needed to handle the data transmissions. It is further understood that some embodiments may combine features of the embodiments of FIGS. 6 and 7, so that some of the devices 266-278 share a transceiver 280 and others communicate directly with the computer/communication systems 262 or 286.

The embodiments of FIGS. 6 and 7 generally involve data transmissions for devices related to or associated with the real persons/players 106 (FIGS. 1-3), the various real elements 108-112, the glove 132 and the motion capture devices and orientation/location/motion sensors, markers or tags 126, 128 and 130. However, similar considerations apply to environmental sensors 288 and data communication with computer/communication systems 290, as shown in FIG. 8. Such environmental sensors 288 may generally include, but not be limited to, the motion capture devices and orientation/location/motion sensors, markers or tags 122 and 124 of FIG. 2 that are not directly related to or associated with any of the real elements 106-112 and 132, but with the real space 108. And the computer/communication systems 290 are generally similar to the computer/communication systems 262 or 286.

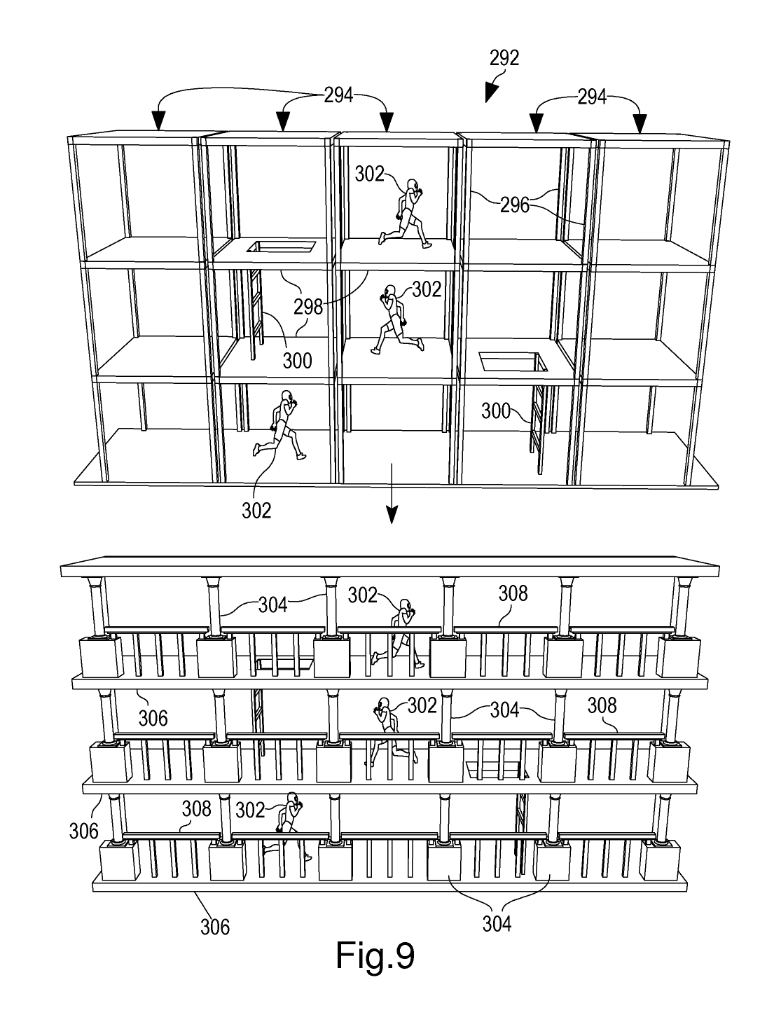

FIG. 9 illustrates embodiments in which VR environmental or setting enhancements are overlaid or superimposed onto real environment elements for visually pleasing aesthetic purposes primarily, but not exclusively, for the benefit of viewers of the video show. In the particular case shown, a real environment 292 includes one or more levels of a variety of set building materials, structures and devices (such as several levels of ordinary scaffolding 294 having vertical supports 296 and horizontal planking 298 with ladders 300, as shown, among many other types of building materials) that one or more persons/players 302 (e.g. the real persons/players 106, FIGS. 1-3) can move around, within, between or on. The augmented video generator 228 (FIG. 5) or the post recording enhancement equipment 230 may superimpose VR environmental enhancements (such as columns 304, flooring 306, railings 308, as shown, among many other types of architectural and artistic features) onto the real set structures (e.g. 294-300) to make the set appear to be any desired type of location, place or structure (e.g. a mansion, a castle, a dungeon, a spaceport, a moon base, an office building, a slum, a cave/tunnel system, a manufacturing plant, etc.).

In the particular case shown, the columns 304 and the flooring 306 are examples of VR environmental enhancements that correspond to, overlay and/or obscure examples of real environmental elements (the vertical supports 296 and the horizontal planking 298, respectively). The railings 308 are examples of additional features that do not necessarily correspond to any real environmental elements, but are included to complete the illusion that the persons/players 302 are actually at or in the desired location. In this manner, very simple real set construction materials, techniques and locations may be used to make the video show (thereby keeping production costs relatively low), while the viewing audience may see the game play action appear to take place in very detailed, elaborate or awesome VR or hybrid real/VR sets or locations.

Additionally, the persons/players 302 do not necessarily need to see the VR environmental or setting enhancements (e.g. 304-308) through their head mounted displays 116 (FIGS. 1 and 3) to play the game or participate in the sport. Instead, the persons/players 302 may primarily see the real environment elements (e.g. 294-300), so the persons/players 302 do not injure themselves due to mistakenly believing either that some of the real environmental elements (e.g. 294-300) are not present or that a VR environmental or setting enhancement is real. For example, the persons/players 302 may need to see and know exactly where the real environmental elements 294-300 are, so they don't run into them or so they can grab hold of one of the real environmental elements (e.g. rungs of the ladders 300). In another example, the persons/players 302 may need not to see the VR railings 308, so the persons/players 302 do not fall off an upper level of the scaffolding 294 after accidentally attempting to lean against one of the VR railings 308. On the other hand, the persons/players 302 may need to see some type of indicator of the railings 308 (e.g. a translucent image thereof), so the persons/players 302 know that they are prohibited from passing through the areas where the railings 308 are supposed to be.

On the other hand, the camera operators 118 (FIGS. 1 and 2) may be able to see the VR environmental or setting enhancements (e.g. 304-308) through the cameras 120 in order to set up the best camera angles or shots during game play. Otherwise, the persons/players 302 may accidentally be obscured by some of the VR environmental or setting enhancements (e.g. 304-308) in the final cut of the video show.

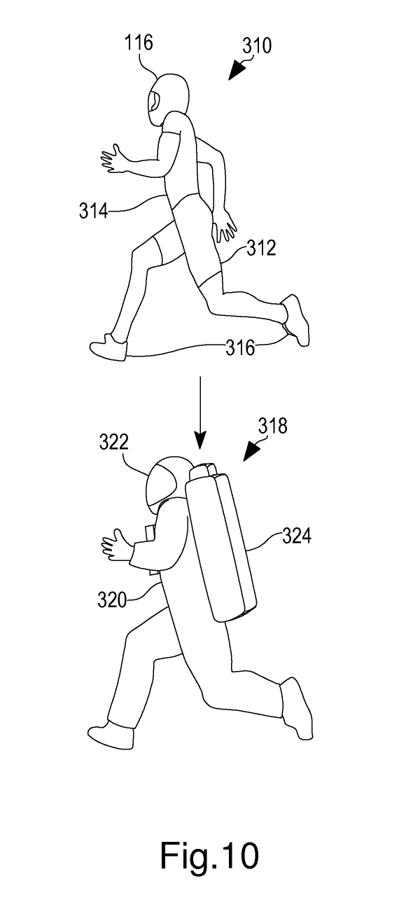

FIG. 10 illustrates embodiments in which VR player/body/costume enhancements are overlaid or superimposed onto a real person/player 310 (e.g. the real person/player 106, FIGS. 1-3) for visually pleasing aesthetic purposes primarily, but not exclusively, for the benefit of viewers of the video show. In the illustrated example, the real person/player 310 (wearing the head mounted display 116, a pair of running shorts 312, a T-shirt 314 and running shoes 316) is overlaid by an astronaut 318 (wearing a spacesuit 320, a helmet 322 and a life support backpack 324). Other examples of VR player/body/costume enhancements, whether obscuring the entire body of the real person/player 310 or only a portion thereof) will be readily apparent, such as a pirate costume, a knight's armor, a futuristic soldier's powered exoskeleton, a monster body, etc. In this manner, the real person/player 310 may wear motion capture equipment (not shown) or very simple cheap apparel in order to play the game or participate in the sport efficiently or in a necessary manner for proper recording of real video and/or motion capture data, while the viewing audience may see the desired type of character(s) in full costume.

The real person/player 310 may see (through the head mounted display 116) either the real bodies/clothing/equipment of other real persons/players 310 in the game or sport or some or all of the VR player/body/costume enhancements overlaid or superimposed onto the other players, depending on whatever works best for the game play. Additionally, the camera operator 118 (FIGS. 1 and 2) may see (through the camera 120) either the real bodies/clothing/equipment of the real persons/players 310 in the game or sport or some or all of the VR player/body/costume enhancements overlaid or superimposed onto the players, depending on whatever works best for the recording of the real video. Additionally, it is understood that many places in which this description calls for a real person/player, it is appropriate for a VR player/character (based on based on the real person/player) to be substituted by using embodiments in accordance with FIG. 10.

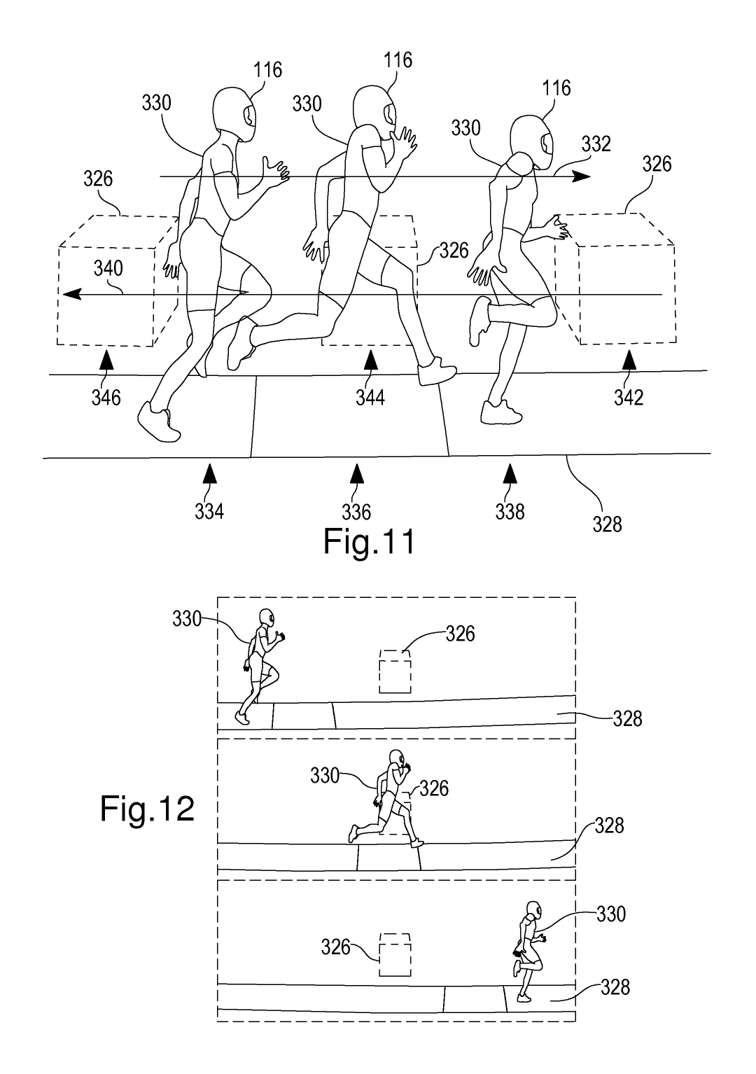

FIGS. 11 and 12 illustrate embodiments which include VR environmental or setting enhancements (represented by a VR box 326) and wherein the VR setting or environment appears to move relative to the real setting or environment (represented by a path 328) in response to an action by a real person/player 330 (e.g. the real person/player 106, FIGS. 1-3). In this case, as the real person/player 330 moves in one direction (arrow 332) from point 334 to point 336 and on to point 338 in the real setting or environment, the VR setting or environment (e.g. the VR box 326) appears to move in the opposite direction (arrow 340) from point 342 to point 344 and on to point 346 relative to the real setting or environment. (FIG. 11 shows this sequence combined in a single image using the path 328 as a reference, while FIG. 12 shows this sequence separated into different frames using the VR box 326 as a reference.) In the video show, however, the real person/player 330 (or a VR player based on the real person/player 330) appears to be moving relative to the VR setting or environment (e.g. the VR box 326) at a different speed than the real person/player 330 is actually moving relative to the real setting or environment. In the illustrated case, since the real person/player 330 and the VR box 326 are moving in opposite directions, the apparent speed of the real person/player 330 (or the VR player based on the real person/player 330) is greater than the actual speed of the real person/player 330 in the real setting or environment. The viewing audience, therefore, sees the real person/player 330 (or the VR player based on the real person/player 330) moving faster or farther than the real person/player 330 is actually moving, and may even see the real person/player 330 (or the VR player based on the real person/player 330) moving faster or farther than is humanly possible. In this manner, the game play appears to take place at an enhanced speed, thereby adding to the thrill or excitement of the game or sport.

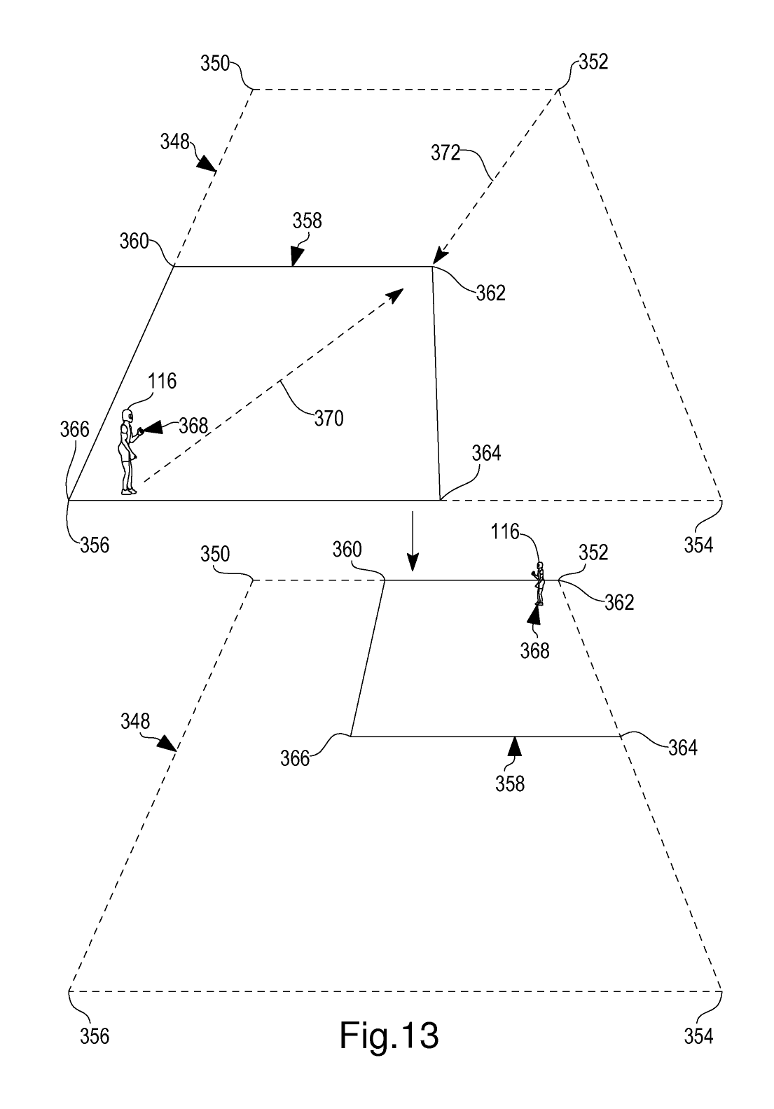

FIG. 13 illustrates embodiments in which a VR setting or environment 348 (defined, in this case, by corners 350, 352, 354 and 356) is of a different size than a real setting or environment 358 (defined, in this case, by corners 360, 362, 364 and 366). As a real person/player 368 (e.g. the real person/player 106, FIGS. 1-3) moves (arrow 370) through the real setting or environment 358, e.g. from near the corner 366 to near the corner 362, the VR setting or environment 348 appears to move (arrow 372) in generally the opposite direction by a proportional amount, so that the real person/player 368 (or a VR player based on the real person/player 368) appears to move through the VR setting or environment 348 from near the corner 356 to near the corner 352. (In the upper “before” portion of the drawing in FIG. 13, the corners 356 and 366 appear to overlap each other. And in the lower “after” portion of the drawing, the corners 352 and 362 appear to overlap each other.) In this manner, the VR setting or environment 348 is not limited in size by the real setting or environment 358. Additionally, such embodiments are particularly useful in combination with embodiments described with reference to FIGS. 11 and 12, since moving faster or farther in the VR setting or environment 348 than in the real setting or environment 358 may require that the VR setting or environment 348 be larger than the real setting or environment 358.

For the embodiments of FIGS. 11, 12 and 13, since the real person/player 330 or 368 (or a VR player based on the real person/player 330 or 368) appears to move faster in the VR setting or environment 348 than in the real setting or environment 358, the movement of the legs of the real person/player 330 or 368 (or the VR player based on the real person/player 330 or 368) may appear to be awkwardly unrelated to the apparent movement of the real person/player 330 or 368 (or the VR player based on the real person/player 330 or 368) through the VR setting or environment 348. It may therefore be desirable in some embodiments in which real video of the real person/player 330 or 368 is used to make the video show, for VR legs to be superimposed onto and totally obscure the real legs of the real person/player 330 or 368. In this case, the VR legs can be made to appear to move at a speed that is appropriate for the apparent speed of the real person/player 330 or 368 through the VR setting or environment 348. Alternatively, it may be desirable in some embodiments in which only generated VR video of the VR player based on the real person/player 330 or 368 is used to make the video show, for the legs of the VR player not to be based on the real person/player 330 or 368, but to be computer generated to appear to move at a speed that is appropriate for the apparent speed of the VR player through the VR setting or environment 348. And in some embodiments, the arms and shoulders of the VR player may also be made to appear to move in coordination with the VR legs in order to give the movement of the VR player greater realism.

For the embodiments of FIGS. 11, 12 and 13, the real person/player 330 or 368 and the camera operator 118 (FIGS. 1 and 2) generally see (through the head mounted display 116 and the camera 120, respectively) the VR setting or environment (e.g. 348 in FIG. 13 or the VR box 326 in FIGS. 11 and 12) moving in the opposite direction of the movement of the real person/player 330 or 368 relative to the real setting or environment (e.g. 358 in FIG. 13 or the path 328 in FIGS. 11 and 12). However, if more than one real person/player 330 or 368 is moving in the same real setting or environment (e.g. 358 or the path 328), it may not be possible or practical for the camera operator 118 to be able to see the VR setting or environment (e.g. 348 or the VR box 326), since there might have to be more than one representation of the VR setting or environment (e.g. 348 or the VR box 326), i.e. one for each of the real persons/players 330 or 368. When multiple real persons/players 330 or 368 are in the same real setting or environment (e.g. 358 or the path 328), however, each real person/player 330 or 368 should be able to see every other real person/player 330 or 368 through the head mounted display 116, so they don't run into each other. But each real person/player 330 or 368 should also be able to see a VR representation of every other real person/player 330 or 368 in their relative position within the VR setting or environment (e.g. 348 or the VR box 326) as it should appear from the point of view of the real person/player 330 or 368, so that each real person/player 330 or 368 can properly interact with every other real person/player 330 or 368 (via their VR representation) in the game or sport, if the game play or design requires that they should be able to see and interact with each other.

Furthermore, in a case in which a segment of the video show is based on the point of view of the real camera 120 (FIGS. 1 and 2), the viewing audience may see the VR setting or environment (e.g. 348 in FIG. 13 or the VR box 326 in FIGS. 11 and 12) moving relative to the real person/player 330 or 368 or to the real setting or environment (e.g. 358 in FIG. 13 or the path 328 in FIGS. 11 and 12). Alternatively, in a case in which a segment of the video show is based on the point of view of a VR camera virtually placed within the VR setting or environment, the viewing audience may see either a VR representation of the real person/player 330 or 368 move relative to the VR setting or environment (e.g. 358 or the path 328) or the VR setting or environment (e.g. 358 or the path 328) move relative to the VR representation of the real person/player 330 or 368 (or both move).

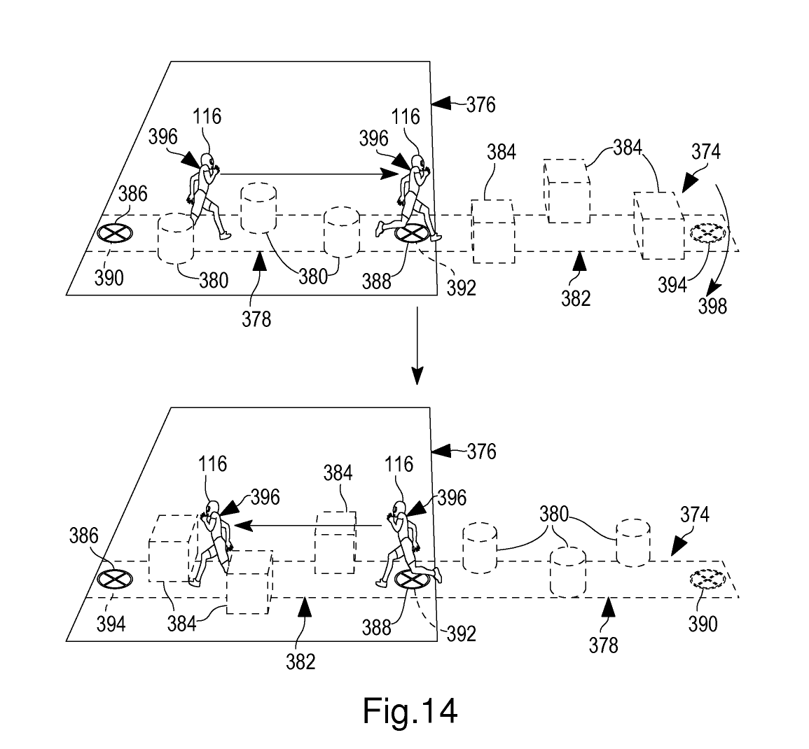

FIG. 14 illustrates embodiments in which a VR setting or environment 374 (defined, in this case, by dashed lines) is of a different size or shape than a real setting or environment 376. In this case, in a first state (upper portion of the drawing in FIG. 14), a first portion 378 of the VR setting or environment 374 (having VR objects, such as VR cylinders 380, therein) appears to be within (or correspond to a portion of) the real setting or environment 376, and a second portion 382 of the VR setting or environment 374 (having VR objects, such as VR boxes 384, therein) appears to be outside the real setting or environment 376. In this state, first and second areas 386 and 388 (indicated by solid reference lines) of the real setting or environment 376 correspond with and overlap first and second areas 390 and 392 (indicated by dashed reference lines), respectively, of the VR setting or environment 374, while a third area 394 of the VR setting or environment 374 is outside the real setting or environment 376.

A real person/player 396 (e.g. the real person/player 106, FIGS. 1-3) can move through the real setting or environment 376 and appear to be moving correspondingly through the first portion 378 of the VR setting or environment 374. When the real person/player 396 enters the second area 388 of the real setting or environment 376, the VR setting or environment 374 may be rotated (e.g. arrow 398) about the corresponding second area 392 of the VR setting or environment 374, so that the third area 394 (indicated by a dashed reference line) appears to enter into the real setting or environment 376. Additionally, any type of trigger event may initiate the rotation of the VR setting or environment 374, such as the real person/player 396 entering the second area 388/392, the real person/player 396 activating a real switch/button (e.g. on a prop, such as the control device prop 112 of FIG. 3) or activating a VR switch/button, another person (not shown) making the activation, etc. Upon leaving the second area 388/392, the real person/player 396 can move through the real setting or environment 376 and appear to be moving correspondingly through the second portion 382 of the VR setting or environment 374.

In the illustrated embodiment, the VR setting or environment 374 appears to rotate 180 degrees (clockwise from above) about the second area 392 until reaching a second state (lower portion of the drawing in FIG. 14), in which the second portion 382 of the VR setting or environment 374 (with the boxes 384, therein) appears to be within (or correspond to the portion of) the real setting or environment 376. In this state, since the first and second areas 390 and 392 of the VR setting or environment 374 are shown to be about the same distance apart as are the second and third areas 392 and 394, the third area 394 of the VR setting or environment 374 corresponds with and overlaps the first area 386 of the real setting or environment 374, and the first area 390 of the VR setting or environment 374 is outside the real setting or environment 374. (In other embodiments, the VR setting or environment 374 appears to rotate some other number of degrees clockwise or counterclockwise.)

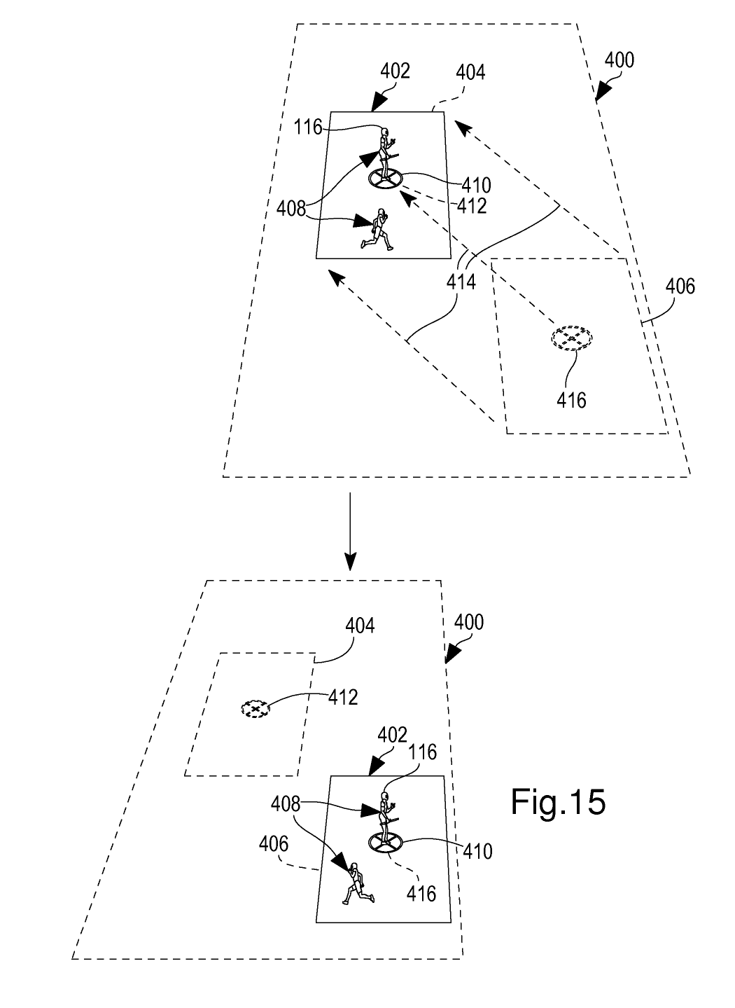

FIG. 15 illustrates additional embodiments in which a VR setting or environment 400 (defined, in this case, by dashed lines) is of a different size than a real setting or environment 402. In this case, in a first state (upper portion of the drawing in FIG. 15), a first portion 404 (indicated by a dashed reference line in the upper portion of the drawing) of the VR setting or environment 400 appears to correspond to the real setting or environment 402, and a second portion 406 of the VR setting or environment 400 appears to be outside the real setting or environment 402. In this case, one or more real persons/players 408 (e.g. the real person/player 106, FIGS. 1-3) can move around within the real setting or environment 402 and appear to move around in the first portion 404 of the VR setting or environment 400. However, upon the occurrence of a particular action, the second portion 406 of the VR setting or environment 400 appears to take the place of the first portion 404, as shown in a second state (lower portion of the drawing in FIG. 15). Then the real persons/players 408 can appear to move around in the second portion 406 while continuing to move around in the real setting or environment 402.

The action that causes the second portion 406 to appear to take the place of the first portion 404 may be any appropriate action, such as the real person/player 408 entering a specific area 410 of the real setting or environment 402 (which corresponds with a first VR area 412 of the first portion 404 of the VR setting or environment 400, as indicated by dashed reference lines in the upper portion of the drawing), the real person/player 408 triggering a switch/button/etc., another person (not shown) triggering a switch/button/etc., the accomplishment of a specific goal within the game or sport by one of the real persons/players 408 or a team thereof, etc.

Some embodiments may incorporate any number and arrangement of the portions (e.g. 404 and 406) of the VR setting or environment 400. And the VR setting or environment 400, and each portion (e.g. 404 and 406) thereof, may have almost any size. In this manner, the VR setting or environment 400 is not limited in size or shape by the real setting or environment 402. Additionally, the size or shape of the VR setting or environment 400 does not have to be proportional to that of the real setting or environment 402. Furthermore, the ability to have the VR setting or environment 400 larger than the real setting or environment 402 also enables the makers of the VR game or sport to use a smaller, more convenient and potentially cheaper real physical space for the game play than would otherwise be necessary.

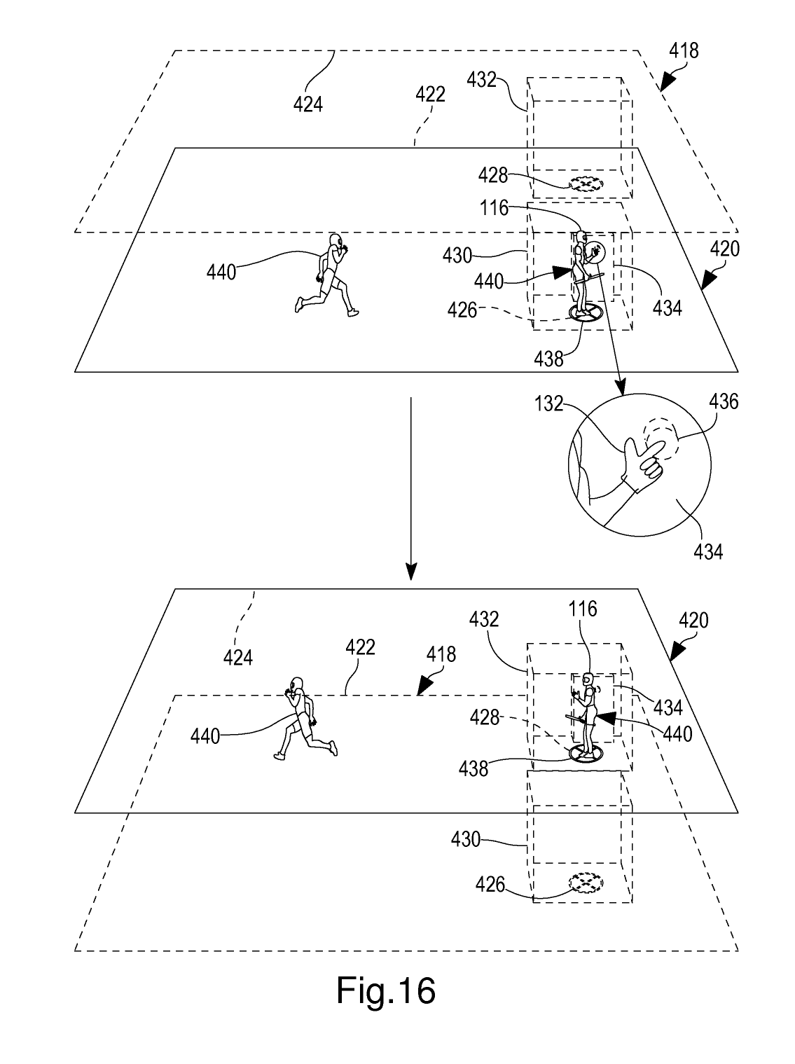

FIG. 16 illustrates additional embodiments in which a VR setting or environment 418 (defined, in this case, by dashed lines) is of a different size than a real setting or environment 420 or appears to move relative to the real setting or environment 420. In this case, the VR setting or environment 418 has first and second portions 422 and 424 vertically offset from each other, i.e. the first portion 422 (indicated by a dashed reference line in the upper portion of the drawing in FIG. 16) is virtually below the second portion 424 (indicated by a dashed reference line in the lower portion of the drawing in FIG. 16).

Additionally, FIG. 16 illustrates additional embodiments that incorporate VR environmental or setting enhancements. In particular, the illustrated embodiment includes first and second VR areas 426 and 428, first and second VR boxes (e.g. rooms, elevators, etc.) 430 and 432, a VR instrument panel/wall 434 and a VR button 436. The first VR area 426 corresponds with and overlaps a real area 438 of the real setting or environment 420 in the upper portion of the drawing in FIG. 16, and the second VR area 428 corresponds with and overlaps the real area 438 in the lower portion of the drawing in FIG. 16.

In a first state (upper portion of the drawing in FIG. 16), the first portion 422 of the VR setting or environment 418 appears to correspond to the real setting or environment 420, and the second portion 424 appears to be above the real setting or environment 420. In a second state (lower portion of the drawing in FIG. 16), the second portion 424 of the VR setting or environment 418 appears to correspond to the real setting or environment 420, and the first portion 422 appears to be below the real setting or environment 420. In the first state, therefore, one or more real persons/players 440 (e.g. the real person/player 106, FIGS. 1-3) can move around within the real setting or environment 420 and appear (or VR players based on the real persons/players 440 can appear) to be moving around in the first portion 422 of the VR setting or environment 418. Upon the occurrence of a particular action, the VR setting or environment 418 appears to shift vertically to the second state, so then the real persons/players 440 can move around within the real setting or environment 420 and appear (or the VR players based on the real persons/players 440 can appear) to be moving around in the second portion 424 of the VR setting or environment 418.

The action that triggers the vertical shift of the VR setting or environment 418 from one state to another may be any appropriate event caused by one or more of the real persons/players 440 or by another person (not shown) or by a programmed feature of the game or sport. For example, the vertical shift of the VR setting or environment 418 may occur when one or more of the real persons/players 440 enters the first VR area 426 or the first VR box 430. Alternatively, the vertical shift of the VR setting or environment 418 may occur when one or more of the real persons/players 440 push the VR button 436 (e.g. with the glove 132, see also FIG. 3) in the VR instrument panel/wall 434.

In the case of the VR boxes 430 and 432 being an elevator (or stairs, escalator, crane, forklift, or other apparatus that moves a person, or that a person uses to move, vertically), for example, the VR setting or environment 418 generally appears to vertically shift relatively slowly, or over a period of time, or the real persons/players 440 (or the VR players based on the real persons/players 440) who are within the first VR box/elevator 430 appear to move vertically until the change between the first and second states is complete and the real persons/players 440 (or the VR players based on the real persons/players 440) appear to be in the second VR box/elevator 432. On the other hand, in an example in which the VR areas 426 and 428 or the VR boxes 430 and 432 are teleportation devices, the VR setting or environment 418 appears to vertically shift or dissolve between states relatively quickly, and the real persons/players 440 (or the VR players based on the real persons/players 440) who are within the first VR areas/teleport-space 426 or the first VR box/teleport-pod 430 appear to be teleported almost instantaneously to the second VR areas/teleport-space 428 or the second VR box/teleport-pod 432. Other examples, for carrying out the change between the first and second states are also within the scope of the present invention.

For embodiments of FIGS. 14-16 having more than one of the real persons/players (e.g. 396, 408 and 440), it may be a requirement that when one of the real persons/players (e.g. 396, 408 and 440) changes location between first and second states, all of the other real persons/players (e.g. 396, 408 and 440) must make the same location change, so that all of the real persons/players (e.g. 396, 408 and 440) remain in the same portion (e.g. 378/404/422 or 382/406/424) of the VR setting or environment (e.g. 374, 400 and 418). Alternatively, it may be allowable for each of the real persons/players (e.g. 396, 408 and 440) to be in different portions (e.g. 378/404/422 or 382/406/424) of the VR setting or environment (e.g. 374, 400 and 418), depending on the requirements of the game or sport.

Additionally, for embodiments of FIGS. 14-16, the real person/player (e.g. 396, 408 and 440) may have to wait until the VR setting or environment (e.g. 374, 400 and 418) appears to stop rotating or moving before the real person/player (e.g. 396, 408 and 440) may continue to move around in the real setting or environment (e.g. 376, 402 and 420).

Furthermore, some embodiments of FIGS. 14-16 may incorporate any number and arrangement of the real areas (e.g. 386, 388, 410 and 438) of the real setting or environment (e.g. 376, 402 and 430) and any number and arrangement of the VR areas (e.g. 390, 392, 394, 412, 416, 426 and 428) and of the portions (e.g. 378, 382, 404, 406, 422 and 424) of the VR setting or environment (e.g. 374, 400 and 418). And the VR setting or environment (e.g. 374, 400 and 418), and each portion (e.g. 378, 382, 404, 406, 422 and 424) thereof, may have almost any size. In this manner, the VR setting or environment (e.g. 374, 400 and 418) is not limited in size or shape (horizontally or vertically) by the real setting or environment (e.g. 376, 402 and 430). Additionally, the size or shape of the VR setting or environment (e.g. 374, 400 and 418) does not have to be proportional to that of the real setting or environment (e.g. 376, 402 and 430). Furthermore, the ability to have the VR setting or environment (e.g. 374, 400 and 418) larger than the real setting or environment (e.g. 376, 402 and 430) also enables the makers of the VR game or sport to use a smaller, more convenient and potentially cheaper real physical space for the game play than would otherwise be necessary.

Also for the embodiments of FIGS. 14-16, the real person/player (e.g. 396, 408 and 440) and the camera operator 118 (FIGS. 1 and 2) generally see (through the head mounted display 116 and the camera 120, respectively) the VR setting or environment (e.g. 374, 400 and 418) moving or rotating (either instantaneously or over a period of time) in the appropriate direction relative to the real setting or environment (e.g. 376, 402 and 420). However, if more than one real person/player (e.g. 396, 408 and 440) is in the same real setting or environment (e.g. 376, 402 and 420), it may not be possible or practical for the camera operator 118 to be able to see the VR setting or environment (e.g. 374, 400 and 418), since there might have to be more than one representation of the VR setting or environment (e.g. 374, 400 and 418), i.e. one for each of the real persons/players (e.g. 396, 408 and 440). When multiple real persons/players (e.g. 396, 408 and 440) are in the same real setting or environment (e.g. 376, 402 and 420), however, each real person/player (e.g. 396, 408 and 440) should be able to see every other real person/player (e.g. 396, 408 and 440) through the head mounted display 116, so they don't run into each other. But each real person/player (e.g. 396, 408 and 440) should also be able to see a VR representation of every other real person/player (e.g. 396, 408 and 440) in their relative position within the VR setting or environment (e.g. 374, 400 and 418) as it should appear from the point of view of the real person/player (e.g. 396, 408 and 440), so that each real person/player (e.g. 396, 408 and 440) can properly interact with every other real person/player (e.g. 396, 408 and 440) (via their VR representation) in the game or sport, if the game play or design requires that they should be able to see and interact with each other.

Furthermore, for the embodiments of FIGS. 14-16, in a case in which a segment of the video show is based on the point of view of the real camera 120 (FIGS. 1 and 2), the viewing audience may see the VR setting or environment (e.g. 374, 400 and 418) rotate or move (either instantaneously or over a period of time) relative to the real person/player (e.g. 396, 408 and 440) or to a VR representation based on the real person/player (e.g. 396, 408 and 440) or to the real setting or environment (e.g. 376, 402 and 420). Alternatively, in a case in which a segment of the video show is based on the point of view of a VR camera virtually placed within the VR setting or environment (e.g. 374, 400 and 418), the viewing audience may see either a VR representation based on the real person/player (e.g. 396, 408 and 440) rotate or move relative to the VR setting or environment (e.g. 374, 400 and 418) or the VR setting or environment (e.g. 374, 400 and 418) rotate or move relative to the VR representation of the real person/player (e.g. 396, 408 and 440)(or both rotate or move). In a case involving multiple persons/players (e.g. 396, 408 and 440) in the same VR setting or environment (e.g. 374, 400 and 418), the viewing audience may see the VR representations of the real persons/players (e.g. 396, 408 and 440), instead of the actual real persons/players (e.g. 396, 408 and 440), since the real persons/players (e.g. 396, 408 and 440) may not all be within the same portion (e.g. 378, 382, 404, 406, 422 and 424) of the VR setting or environment (e.g. 374, 400 and 418).

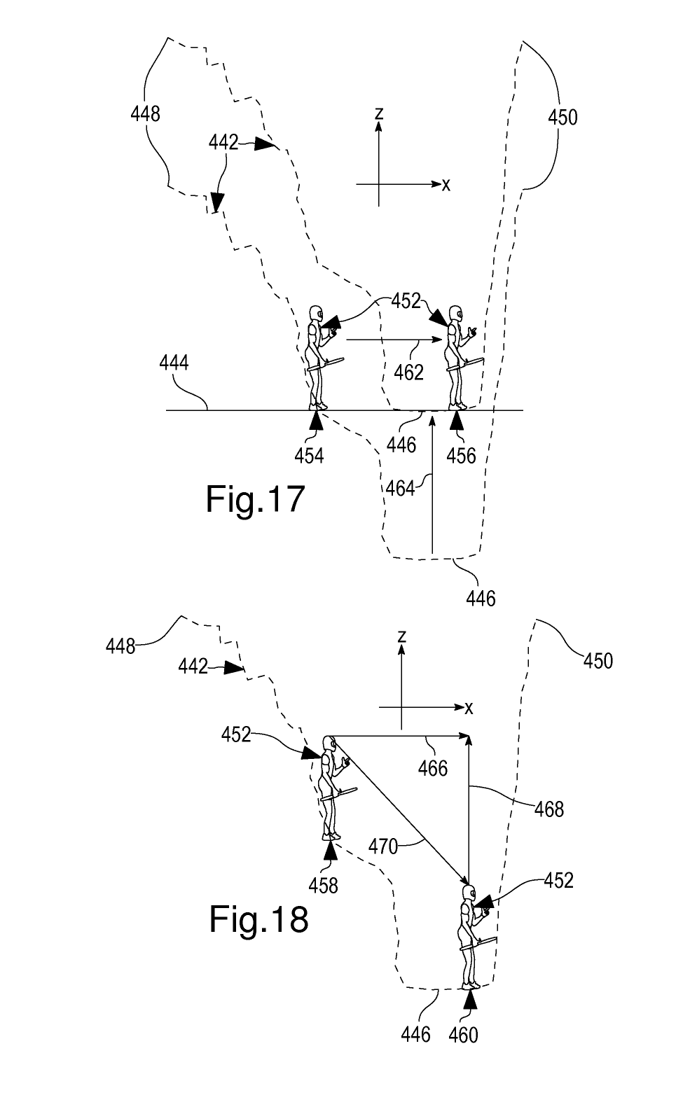

FIGS. 17, 18 and 19 illustrate additional embodiments in which a VR setting or environment 442 (defined, in this case, by dashed lines) is of a different size than a real setting or environment 444 or appears to move relative to the real setting or environment 444 or includes VR environmental or setting enhancements. In this case, the VR setting or environment 442 has vertical variations in the topography of the terrain, i.e. mountains, canyons, etc. In the illustrated embodiment, the VR setting or environment 442 simply has a low area 446 between two high points 448 and 450, with uneven sloping ground in between the low area 446 and each high point 448 and 450. More complicated terrains are also within the scope of the present invention.

Points within the VR setting or environment 442 generally correspond to points within the real setting or environment 444. However, as one or more real persons/players 452 (e.g. the real person/player 106, FIGS. 1-3) move around in the real setting or environment 444 (e.g. from a first real point 454 to a second real point 456, FIG. 17), the elevation of the VR setting or environment 442 changes in a manner similar to that of a person walking across a sloping ground (e.g. from a first VR point 458 to a second VR point 460, FIG. 18, which correspond to the first and second real points 454 and 456, respectively).

It is possible for the real setting or environment 444 to have a sloping or uneven topography and for the topography of the VR setting or environment 442 to match. However, environmental features or enhancements in accordance with embodiments illustrated in FIGS. 17-19 enable games and sports with a VR setting or environment (e.g. 442) having any topography to be played on a real setting or environment (e.g. 444) having any topography.

When the real person/player 452 moves (arrow 462, x-axis, FIG. 17) horizontally from the first real point 454 to the second real point 456, the VR setting or environment 442 appears to the real person/player 452 (through the head mounted display 116) to move (arrow 464, z-axis, FIG. 17) vertically a distance that corresponds to the elevational difference between the first and second VR points 458 and 460. In this manner, the VR setting or environment 442 almost always appears to the real person/player 452 to intersect (or coincide vertically, as well as horizontally, with) the real setting or environment 444 at a point that corresponds roughly to the location of the feet of the real person/player 452.

From the point of view of the viewing audience, as the real person/player 452 moves horizontally according to vector arrow 466 (FIG. 18), the VR setting or environment 442 moves vertically according to vector arrow 468, and the real person/player 452 (or a VR player based on the real person/player 452) appears to move at an angle according to vector arrow 470 (sum of the vector arrow 466 and a negative of the vector arrow 468). Alternatively, the VR setting or environment 442 appears to move opposite to vector arrow 470. In another alternative, the real person/player 452 (or a VR player based on the real person/player 452) and the VR setting or environment 442 may both appear to move according to any appropriately coordinated vectors.

From the point of view of the camera operator 118 (through the camera 120, FIGS. 1 and 2), since the camera 120 is generally pointed at the real person/player 452, and since the camera operator 118 is presumably at the same elevation as the real person/player 452, as the real person/player 452 moves horizontally according to vector arrow 466, the VR setting or environment 442 appears to move vertically according to vector arrow 468. However, it is possible for the camera 120 (and camera operator 118) to be mounted on a boom that can raise and lower the camera 120. In this case, the camera 120 can be moved vertically in a manner that corresponds with the virtual movement of the VR setting or environment 442, so the real person/player 452 appears to move vertically as well as horizontally. In other embodiments, the camera 120 can be moved both horizontally and vertically, so the real person/player 452 and the VR setting or environment 442 appear to move according to any appropriately coordinated vectors.

Depending on the manner in which the real person/player 452 stands with respect to the ground of the VR setting or environment 442, one foot may at times appear to be above the ground and/or the other foot may appear to be below the ground. Alternatively, embodiments in which VR player/body/costume enhancements are overlaid or superimposed onto the real person/player 452 (see the description above with respect to FIG. 10) may include VR alterations to the legs, feet and/or stance of the real person/player 452, so that the VR feet may appear to be on (or nearer to) the ground of the VR setting or environment 442.

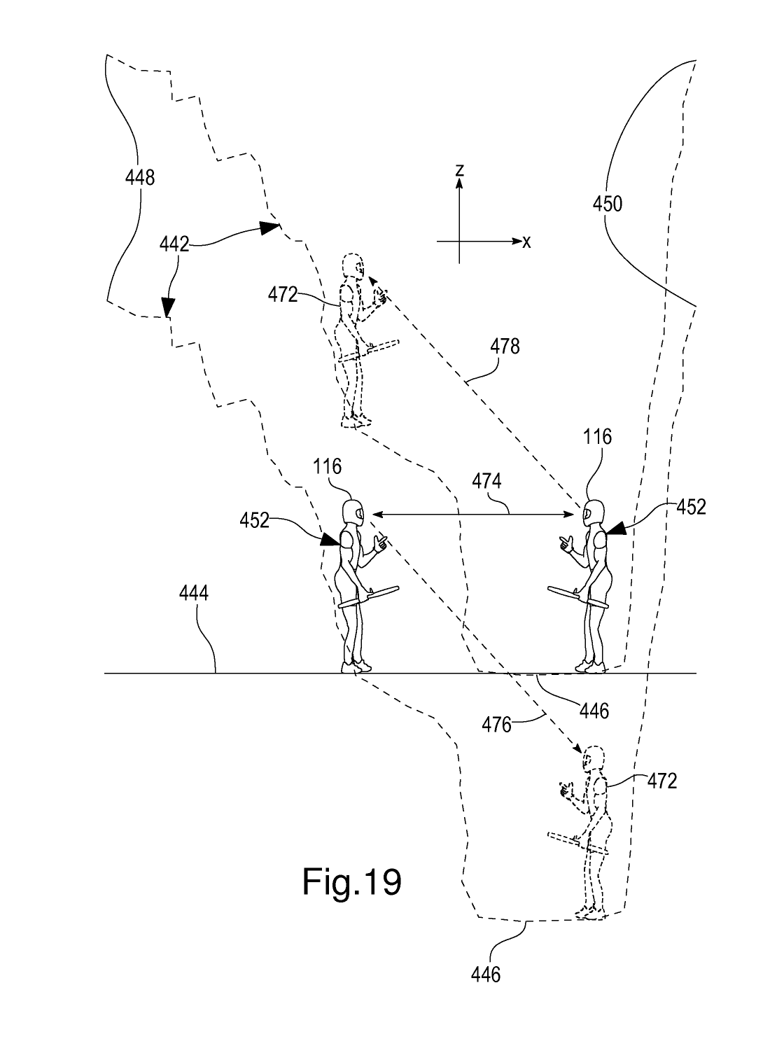

In an embodiment involving multiple real persons/players 452 participating in the same real setting or environment 444 (FIG. 19), the real persons/players 452 may be able to see each other, so they don't run into each other. However, in order for the real persons/players 452 to be able to interact with each other properly during the game play, the real persons/players 452 may see VR players 472 based on the other real persons/players 452 vertically offset from the other real persons/players 452 depending on the VR elevation each VR player 472 is supposed to be at. In this manner, for example, the two real persons/players 452 see each other along double-ended arrow 474, but the real person/player 452 on the left sees the VR player 472 based on the real person/player 452 on the right along arrow 476, and the real person/player 452 on the right sees the VR player 472 based on the real person/player 452 on the left along arrow 478 (vertically offset from arrow 476).

In an example enabled by embodiments as described with respect to FIGS. 17-19, a VR setting or environment includes at least one tunnel below a ground terrain, or at least one tunnel below another tunnel. In this case, the real persons/player 452 may traverse in a closed path within the real setting or environment that results in the real person/player 452 twice crossing a single real point in the real setting or environment, but appearing to change elevation in the VR setting or environment between two apparently different VR points. The two VR points, thus, both correspond (in a top view) to the single real point, but are virtually vertically offset from each other (in an elevation view of the VR setting or environment). In this manner, the real person/player 452 (or a VR representation thereof) appears to traverse through two or more different overlapping levels of terrain/tunnels having almost any degree of complexity.

Therefore, various embodiments of FIGS. 17-19 may incorporate any level of complexity in terrain/tunnel topography for the VR setting or environment 442, so the VR setting or environment 442 may have almost any vertical size. And the real setting or environment 444 may have almost any real topography, enabling almost any available real space to be used for the game or sport, regardless of the VR topography of the VR setting or environment 442. In this manner, the VR setting or environment 442 is not limited in vertical size or shape by the real setting or environment 444. Additionally, the ability to have the VR setting or environment 442 larger or more complex than the real setting or environment 444 also enables the makers of the VR game or sport to use a smaller, more convenient and potentially cheaper real physical space for the game play than would otherwise be necessary.

It is understood that some embodiments of the present invention may not use the features described with respect to FIGS. 11-19. And other embodiments may use only one of these features. Still other embodiments, however, may use any combination of two or more of the features described and shown with respect to FIGS. 11-19. In this manner, the game or sport may involve a variety of desired effects with respect to the size, shape and terrain of the VR setting or environment and to the movement of the real persons/players (and/or VR players based thereon), while still enabling the game or sport to take place in a relatively simple and cheap real setting or environment.

In some embodiments involving one or more of the features described with respect to FIGS. 11-19, movement of the real person/player causes the VR setting or environment to appear to the camera operator 118 to move relative to the camera 120 or to the real setting or environment in addition to causing the VR setting or environment to appear to the real person/player to move relative to the real setting or environment. For example, it is frequently desirable for the camera operator 118 and camera 120 (FIGS. 1 and 2) to move along with the real person/player in order to record the real person/player for the video show. Also, the VR relative positions of the camera 120 and the real person/player within the VR setting or environment remain the same (or proportionally the same) as the real relative positions thereof are in the real environment. Thus, when the real person/player moves, and the VR setting or environment appears to the real person/player to move relative to the real setting or environment according to one or more of the embodiments described with respect to FIGS. 11-19, then the VR setting or environment appears to the camera operator 118 to move relative to the real setting or environment in a similar manner. Movement of the camera 120, on the other hand, without movement of the real person/player, does not cause the VR setting or environment to appear to the camera operator 118 to move relative to the real setting or environment. (Additionally, movement of the camera 120 by the camera operator 118 does not affect the appearance of the VR setting or environment to the real person/player.) The viewers of the video show simply see the real person/player (or a VR player based thereon) move through the VR setting or environment with enhancements in accordance with one or more of the features described with respect to FIGS. 11-19.

In other embodiments involving one or more of the features described with respect to FIGS. 11-19, it is desirable for the camera operator 118 to use the camera 120 (FIGS. 1 and 2) to appear to record the VR player (based on the real person/player), rather than the real person/player, for the video show. In this case, the camera operator 118 handles the real camera 120 as if handling the VR camera 138 (FIG. 4) to record the VR player and the VR setting or environment. In this case, it is an option for movement of the real person/player not to cause the VR setting or environment to appear to the camera operator 118 to move relative to the real setting or environment. In some embodiments, however, in order to keep up with the VR player, movement of the camera 120 may result in the same type of movement of the VR environment (as seen through the display of the camera 120) as results from movement of the real person/player (as seen through the head mounted display 116) in accordance with one or more of the features described with respect to FIGS. 11-19.

In some embodiments, some of the real persons/players may see the VR setting or environment move according to one or more of the features described with respect to FIGS. 11-19, while others of the real persons/players see the VR setting or environment move more, less or not at all. Similarly, some of the real persons/players may see the VR setting or environment as being of a different size than as seen by others of the real persons/players. This variation on these features allows different VR players (based on the real person/players) to be able to move at different speeds and/or to be of different VR sizes within the same VR setting or environment. For example, some of the real persons/players may be VR giants to whom the VR setting or environment and the other VR players (based on the other real persons/players) appear to be smaller than they appear to the other real persons/players. Also, some of the real persons/players may appear to become larger or smaller by causing the VR setting or environment to change size relative to the real setting or environment or to the real person/player during game play. Alternatively (or in addition), some of the VR players (based on one or more of the real persons/players) may appear to move much faster within the VR setting or environment than do other VR players (based on other real persons/players).

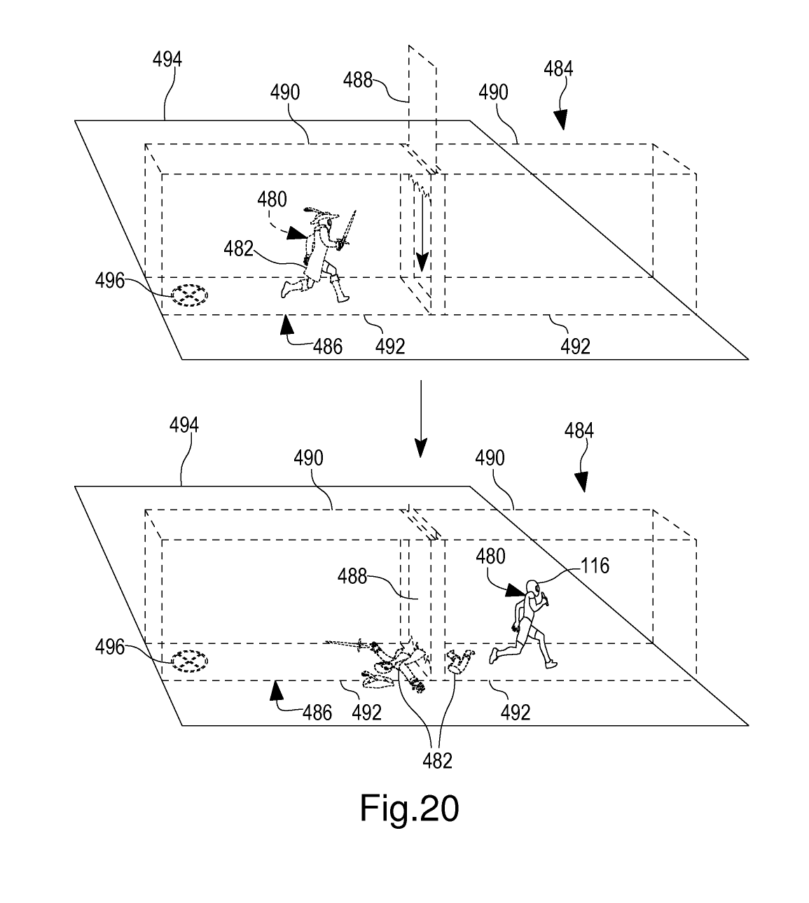

FIG. 20 illustrates an example of what can happen in some embodiments in which a real person/player 480 (e.g. the real person/player 106, FIGS. 1-3) is virtually killed, wounded or incapacitated during game play. The upper portion of the drawing in FIG. 20 shows a body or costume of a VR player 482 overlaid or superimposed onto the real person/player 480 (indicated by a dashed reference line) as the real person/player 480 plays or participates in the game or sport before the virtual killing, wounding or incapacitating of the real person/player 480. The lower portion of the drawing in FIG. 20 shows the body or costume of the VR player 482 and the real person/player 480 a moment after the virtual killing, wounding or incapacitating of the real person/player 480.

In the particular example shown, the real person/player 480 plays or participates in the game or sport within a VR setting or environment 484. Additionally, the movement of the real person/player 480 is restricted within the VR setting or environment 484 to a VR hallway 486. However, a VR guillotine blade 488 periodically drops down from a VR ceiling 490 of the VR hallway 486 and goes back up a moment later. To pass safely through the VR hallway 486, the real person/player 480 (or the body or costume of the VR player 482) must not virtually collide with or intersect the VR guillotine blade 488, as determined by collision detection algorithms. If the VR guillotine blade 488 collides with the real person/player 480 (or the body or costume of the VR player 482) as the real person/player 480 attempts to pass it, then the real person/player 480 is considered virtually killed. (Other methods or devices for virtually killing, wounding or incapacitating the real person/player 480 are also within the scope of the present invention and apply to variations on this embodiment. The particular illustrated example is shown for illustrative purposes only.)

In this particular example, the virtual killing of the real person/player 480 by the VR guillotine blade 488 results in the body or costume of the VR player 482 being split in half and dropped to a VR floor 492 of the VR hallway 486, even though the real person/player 480 may continue moving beyond the VR guillotine blade 488 within a real setting or environment 494. In other words, the body or costume of the VR player 482 is disconnected or removed or separated from the real person/player 480 due to the virtual killing of the real person/player 480, and the body or costume of the VR player 482 may be left behind or may fall down as a corpse in an appropriate manner.

The real person/player 480 is, thus, out of the game or sport (temporarily or permanently) or may have to suffer some other sort of setback or penalty before continuing to play or participate in the game or sport. Such penalties may include, but not be limited to, loss of points, loss of audio or visual contact with other members of a team, loss of game-play progress, loss of time, etc.

In addition to any other appropriate penalty in this embodiment, the real person/player 480 may have to reacquire the body or costume of the VR player 482 (or obtain a new one) in some manner. For example, the real person/player 480 may return to the location of the body or costume of the VR player 482 (or a piece thereof) and appear to reacquire the same body (with any appropriate or necessary repairs). Alternatively, the real person/player 480 may have to go to a particular location (sometimes referred to as a spawning, re-spawning, entry or reentry point, e.g. an area 496) and appear to acquire a new body. In either case, the real person/player 480 may lose valuable game-playing time by having to reacquire the body or costume of the VR player 482. Additionally, the point (e.g. the area 496) to which the real person/player 480 may have to go in order to acquire the new (or reacquire the old) body or costume of the VR player 482 may be at an earlier point in the game or sport, so the real person/player 480 may lose any progress made between that point and the point at which the real person/player 480 was virtually killed. In other words, in some embodiments, the real person/player 480 may have to repeat some portion of the game play up to the point of virtual killing.

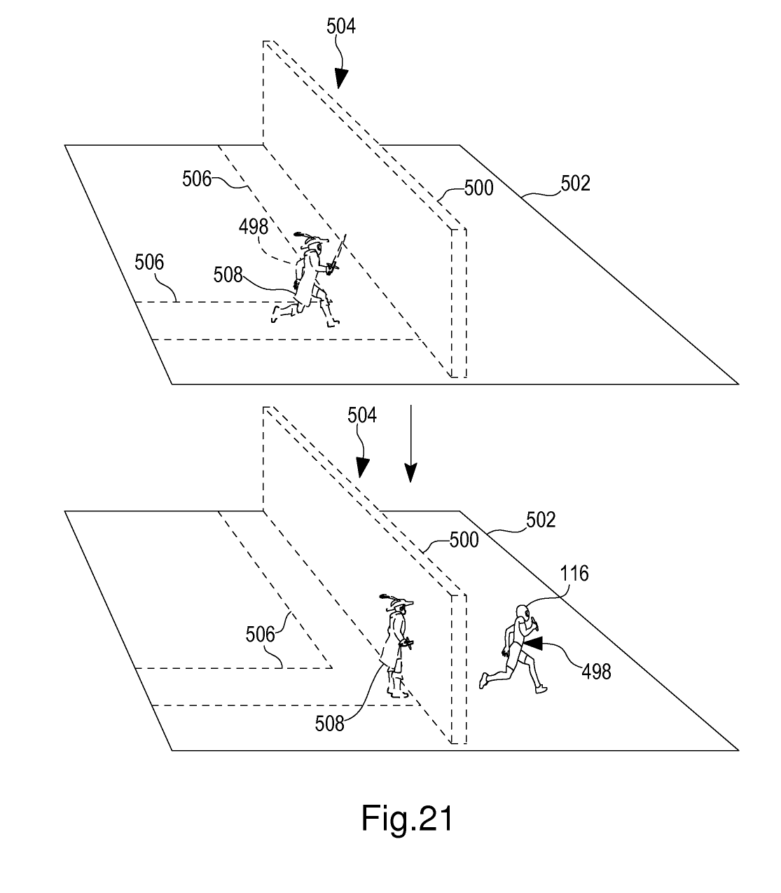

FIG. 21 illustrates what can happen in some embodiments in which a real person/player 498 (e.g. the real person/player 106, FIGS. 1-3) steps out of bounds, collides with or passes through a VR object (e.g. a VR wall 500) or enters a forbidden area (e.g. in violation of the rules of the game or sport). The particular illustrated embodiment shows a real setting or environment 502 and a corresponding VR setting or environment 504. The VR setting or environment 504, in this example, includes the VR wall 500 and a VR path 506. Other configurations of real and/or VR setting or environment components in which it is possible for the real person/player 498 to step out of bounds, collide with or pass through a VR object (e.g. a VR wall 500) or enter a forbidden area are also within the scope of the present invention and apply to variations on this embodiment. The particular illustrated example is shown for illustrative purposes only.

For the illustrated example, the upper portion of the drawing in FIG. 21 shows a body or costume of a VR player 508 overlaid or superimposed onto the real person/player 498 (indicated by a dashed reference line) as the real person/player 498 plays or participates in the game or sport before the real person/player 498 attempts (accidentally or purposefully) to pass through the VR wall 500. At this point, the real person/player 498 is following the VR path 506, so the real person/player 498 should turn left to continue following the VR path 506 before running into the VR wall 500.

The lower portion of the drawing in FIG. 21 shows the body or costume of the VR player 508 and the real person/player 498 a moment after the real person/player 498 has (accidentally or purposefully) passed through the VR wall 500, in violation of the proper way to play or participate in the game or sport. In this case, the body or costume of the VR player 508 did not pass through the VR wall 500 with the real person/player 498. In other words, the real person/player 498 apparently shed the body or costume of the VR player 508 and left it standing on the opposite side of the VR wall 500. (As alternatives, the body or costume of the VR player 508 could appear to bounce off the VR wall 500, stumble around, fall down, die and/or disappear.) As a consequence of this violation of the proper way to play or participate in the game or sport, in some variations of this embodiment, the real person/player 498 may have to reacquire the body or costume of the VR player 508 in a manner similar to that described with reference to FIG. 20. (Other penalties may also apply.)

In accordance with the embodiments of FIGS. 20 and 21, the real person/player 480 or 498 generally sees (through the head mounted display 116) or hears (e.g. through the audio devices 254 or 272, FIGS. 6 and 7) something to indicate the virtual killing or virtual shedding of the body or costume of the VR player 482 or 508. For example, the real person/player 480 or 498 may see a warning symbol or hear a warning sound. Alternatively, part (or all) of the VR environment 484 or 504 may disappear or change appearance. In another alternative, however, no indicator of the virtual killing or virtual shedding is provided to the real person/player 480 or 498, who is simply left to discover the problem in due course.

Depending on the design of the game or sport, the viewing audience may see only the body or costume of the VR player 482 or 508 or both the real person/player 480 or 498 and the body or costume of the VR player 482 or 508. If the viewing audience cannot see the real person/player 480 or 498, then the reacquiring of the body or costume of the VR player 482 or 508 by the real person/player 480 or 498 may appear to the viewing audience to be a magical reanimation or reappearance of the VR player 482 or 508.

The camera operator 118 (through the camera 120, FIGS. 1 and 2) generally sees both the real person/player 480 or 498 and the body or costume of the VR player 482 or 508. If it is not expected that the viewing audience will be able to see the real person/player 480 or 498 in some segments of the video show, however, then it may be optional for the camera operator 118 to be able to see the real person/player 480 or 498.

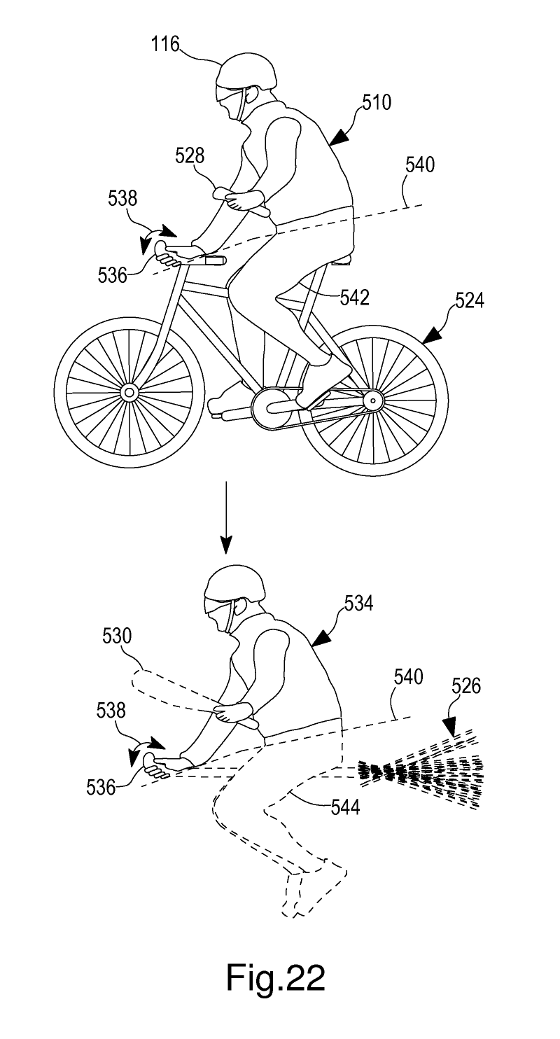

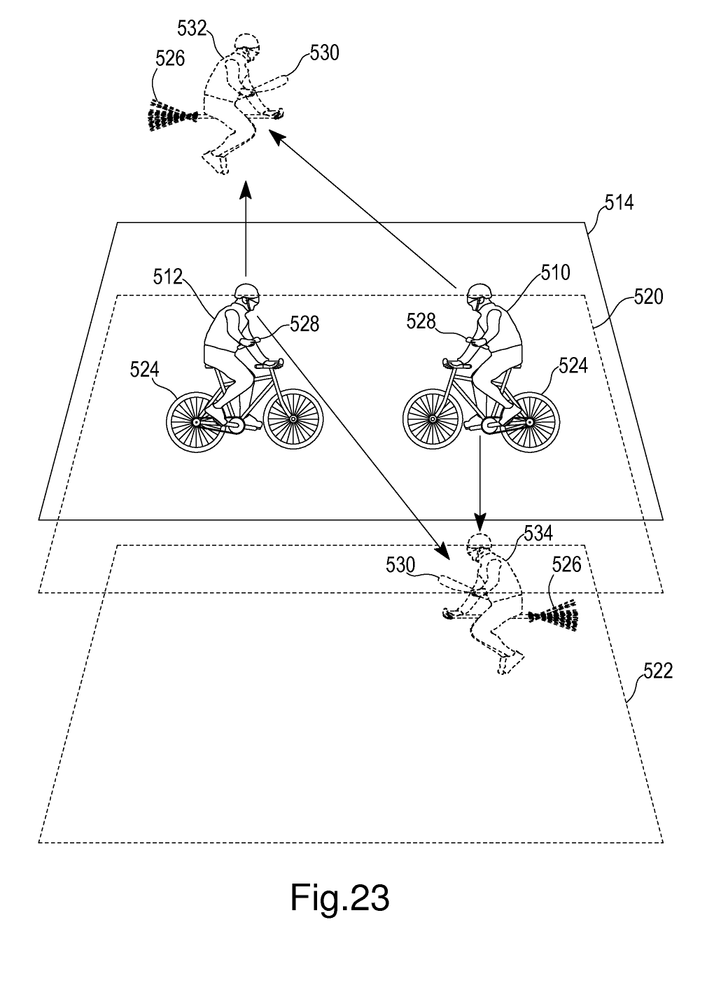

FIGS. 22-25 illustrate examples of embodiments in which one or more real persons/players 510 and 512 move through a real setting or environment 514, 516 or 518 (FIGS. 23-25) with the aid of a real mechanical device that is completely or partially obscured by a VR device (overlaid or superimposed onto the real mechanical device or a portion thereof) that the real persons/players 510 and 512 appear to use to move through a VR setting or environment 520 or 522. (These examples also illustrate other features, as described.) In the illustrated example, the real mechanical device used by each real person/player 510 or 512 is a real bicycle 524, and the VR device is a VR flying broomstick 526. In this example, each real person/player 510 or 512 uses one hand to control the real bicycle 524 and the other hand to play or participate in the game or sport, e.g. by wielding a real handheld prop 528 (or such as, or similar to, the control device prop 112, FIG. 3) that is overlaid or superimposed by a VR club or bat 530 (or VR props/tools 144 and 146, FIGS. 1 and 4).

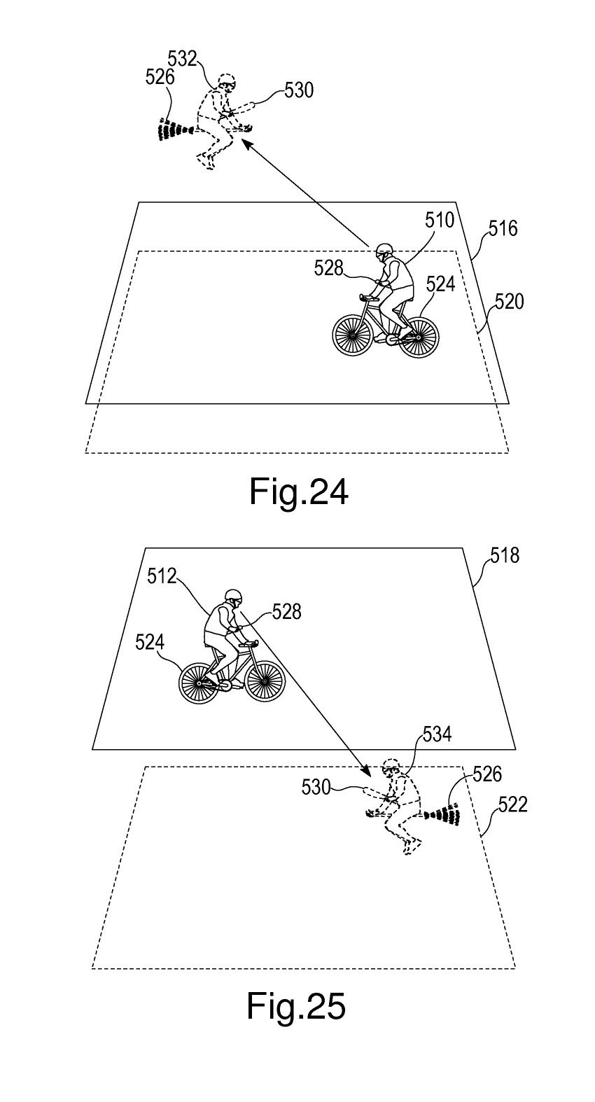

In the example of FIG. 23, the real persons/players 510 and 512 are within the same real setting or environment 514. In the example of FIGS. 24 and 25, however, the real persons/players 510 and 512 are within different real settings or environments 516 and 518, respectively. The VR setting or environment 520 is seen by the real person/player 510 in each of the examples (FIGS. 23, 24 and 25). The VR setting or environment 522, on the other hand, is seen by the real person/player 512 in each of the examples. Additionally, a VR player 532 is based on the real person/player 512 and is seen by the real person/player 510 at an appropriate location within the VR setting or environment 520 in each of the examples. And a VR player 534 is based on the real person/player 510 and is seen by the real person/player 512 at an appropriate location within the VR setting or environment 522 in each of the examples.

In the example of FIG. 23, therefore, the real person/player 510 sees the VR setting or environment 520 slightly below the real setting or environment 514, the VR player 532 above the real setting or environment 514 and the real person/player 512 and the real setting or environment 514 at the real level. The real person/player 512, on the other hand, sees the VR setting or environment 522 considerably below the real setting or environment 514, the VR player 534 slightly above the VR setting or environment 522 but below the real setting or environment 514 and the real person/player 510 and the real setting or environment 514 at the real level.

In the example of FIGS. 24 and 25, the real person/player 510 (FIG. 24) again sees the VR setting or environment 520 slightly below the real setting or environment 516 and the VR player 532 above the real setting or environment 516, but it is optional for the real person/player 510 to be able to see the real person/player 512 and/or the real setting or environment 516, since there is no risk of running into anyone or anything. Additionally, the real person/player 512 (FIG. 25) again sees the VR setting or environment 522 considerably below the real setting or environment 518 and the VR player 534 slightly above the VR setting or environment 522 but below the real setting or environment 518, but it is optional for the real person/player 512 to be able to see the real person/player 510 and the real setting or environment 518.

According to various embodiments, just the two, or more than just the two, real persons/players 510 and 512 participate in or play the game or sport. In some of these embodiments, all of the real persons/players 510 and 512 (e.g. one or more real persons/players 510 and one or more real persons/players 512) are within the same real setting or environment 514, thereby risking the possibility of running into each other. In other embodiments, multiple real persons/players 510 (e.g. as a team or other subgroup) are together within the real setting or environment 516, and multiple real persons/players 512 (e.g. as another team or other subgroup) are together within the real setting or environment 518, so each real person/player 510 or 512 has a risk of running into those real persons/players 510 and 512 who are within the same real setting or environment 516 or 518, but has no risk of running into the other real persons/players 510 and 512 (e.g. opposing team members). In still other embodiments, every real person/player (e.g. multiple real persons/players 510 and multiple real persons/players 512) is within a different real setting or environment 516 or 518, so there is no risk of any of them running into each other. Further variations on these embodiments are also possible.

Apparent horizontal movement of the VR players 532 and 534 within the VR settings or environments 520 and 522 depends on the direction and speed in which the real persons/players 510 and 512 moves the real bicycle 524 through the respective real setting or environment 514, 516 or 518. Optionally, the apparent horizontal movement of the VR players 532 and 534 may also depend on incorporation of any of the features described above with respect to FIGS. 11-19.

Apparent vertical movement of the VR players 532 and 534 within the VR settings or environments 520 and 522 may be achieved in any appropriate manner. For example, a handlebar 536 (or a portion thereof or a lever, joystick, controller, etc. mounted on the handlebar 536 in FIG. 22) of the real bicycle 524 may be tilted back and forth (e.g. along double-ended arrow 538) by the hand controlling the real bicycle 524 to cause the VR flying broomstick 526 to appear to go up and down, as desired, in the air relative to the VR settings or environments 520 and 522. For embodiments in which there is no readily available real object (such as the handlebar 536) that can be used to control apparent vertical movement, the real persons/players 510 and 512 may carry or wear a prop or device (such as the control device prop 112 or the glove 132, FIG. 3) that can generate control signals in any appropriate manner to indicate desired vertical movement.

It is understood that the present invention is not necessarily limited to the specific embodiment illustrated by FIGS. 22-25. Instead, the real bicycle 524, the VR flying broomstick 526, the real handheld prop 528 and the VR club or bat 530 are shown for illustrative purposes only. Other types of real mechanical devices include, but are not limited to, skates, a scooter, a motorcycle, a unicycle, a skateboard, a wheelchair, a boat, an automobile, a cart, a Segway™ and any other appropriate device (powered or unpowered) with which the real persons/players 510 and 512 can ride or otherwise move. Additionally, other types of VR devices include, but are not limited to, a flying broomstick, a magic flying carpet, a spaceship, an airplane, a car, a truck, a tank, a military assault vehicle, a ship, a rocket, an animal (real or imaginary, and with or without wings), a robot, etc. Furthermore, other means or devices (besides the real handheld prop 528 and/or the VR club or bat 530) for playing or participating in the game or sport depend on the particular game or sport.

In addition to obscuring the real bicycle 524 with the VR flying broomstick 526, in some variations of this embodiment, the VR player 534 or 532 may be overlaid or superimposed over the real person/player 510 or 512, respectively. In some embodiments, however, only the top portion of the VR player 534 or 532 (e.g. above a bent dashed dividing line 540, seen only in FIG. 22) may be based on the real person/player 510 or 512. On the other hand, since real legs 542 (FIG. 22) of the real person/player 510 or 512 frequently move in order to propel the real bicycle 524, the bottom portion of the VR player 534 or 532 (e.g. below the bent dashed dividing line 540) may be based on an appropriate form for riding the VR flying broomstick 526, e.g. VR legs 544 should generally not move as much as the real legs 542, in this case. Furthermore, according to some embodiments, the part of the handlebar 536 grasped by the hand of the real person/player 510 or 512 (e.g. above the dashed dividing line 540) may appear to be part of the VR flying broomstick 526.

In alternative embodiments, the top portion (e.g. above the dashed dividing line 540, FIG. 22) of the real person/player 510 or 512 is not overlaid or obscured by the VR player 534 or 532, respectively. Instead, the viewing audience sees most (if not all) of the real recorded video of the top portion of the real person/player 510 or 512. Still, the bottom portion (e.g. below the dashed dividing line 540) of the real person/player 510 or 512 is generally obscured by the bottom portion of the VR player 534 or 532 (e.g. below the dashed dividing line 540), which is generally based on an appropriate form for riding the VR flying broomstick 526.

On the other hand, in alternative embodiments involving multiple real persons/players 510 and 512 in the same real setting or environment 514 (FIG. 23), but who are intended to appear to fly (each potentially at a different elevation) in the VR settings or environments 520 and 522, it may not be possible for any real portion of the real persons/players 510 and 512 to be visible to the viewing audience, due to the nature of making the real recorded video. In this case, each entire real person/player 510 or 512 is generally completely obscured by the VR player 534 or 532, respectively, particularly if multiple VR players 534 and 532 appear in the same camera shot.

In each alternative embodiment, it may appear to the viewing audience that the real person/player 510 or 512 (or the VR player 534 or 532, respectively) is using the VR device (e.g. the VR flying broomstick 526), instead of the real mechanical device (e.g. the real bicycle 524), to move around. To create this appearance in some embodiments, an entire VR body or costume (or only some VR body or costume parts) may be generated for the VR player 534 or 532 to virtually replace the real person/player 510 or 512 (or only the corresponding body parts of the real person/player 510 or 512) in any appropriate manner, as mentioned above.

The real person/player 510 or 512 generally sees (through the head mounted display 116, see also FIGS. 1 and 3) at least the VR setting or environment 520 or 522, with apparent vertical and/or horizontal movement thereof in accordance with manipulation of the handlebar 536 (or a lever, joystick, controller, etc. mounted on the handlebar 536) and movement of the real bicycle 524 along with any of the features described with reference to FIGS. 11-19. Whether or not the real person/player 510 or 512 can see the real setting or environment 514, 516 or 518 may depend on the nature of the game or sport or the presence of any real obstacles within the real setting or environment 514, 516 or 518 that the real person/player 510 or 512 may need to avoid hitting or to use to play or participate in the game or sport.

Additionally, in an embodiment involving multiple real persons/players 510 and 512 in the same real setting or environment 514, as shown in FIG. 23, each real person/player 510 or 512 is generally able to see the other real persons/players 510 or 512 and the real mechanical devices (e.g. the real bicycles 524) used or operated by the other real persons/players 510 or 512 in order to properly avoid running into each other. Also, whether the multiple real persons/players 510 and 512 are in the same real setting or environment 514 (FIG. 23) or in different real settings or environments 516 and 518 (FIGS. 24 and 25), each real person/player 510 or 512 is generally able to see the appropriate VR setting or environment 520 or 522 and the other VR players 534 or 532 in their appropriate horizontal and vertical VR positions within the VR setting or environment 520 or 522 in order to properly play or participate in the game or sport.

The camera operator 118 (through the camera 120, FIGS. 1 and 2) generally sees the real person/player 510 or 512, the VR player 534 or 532, the real setting or environment 514, 516 or 518 and the VR setting or environment 520 or 522. If it is not expected that the viewing audience will be able to see any portion of the real person/player 510 or 512 in some segments of the video show, however, then it may be optional for the camera operator 118 to be able to see the real person/player 510 or 512 and/or the real setting or environment 514, 516, 518. Additionally, the subjects visible to the camera operator 118 may further depend on the incorporation of any of the features described above with respect to FIGS. 11-19. Furthermore, the camera operator 118 may have a real device that enables the camera operator 118 to appear to change the apparent elevation of the camera 120 (as if it is the VR camera 138, FIG. 4) in order to set up camera angles and shots as desired during game play.

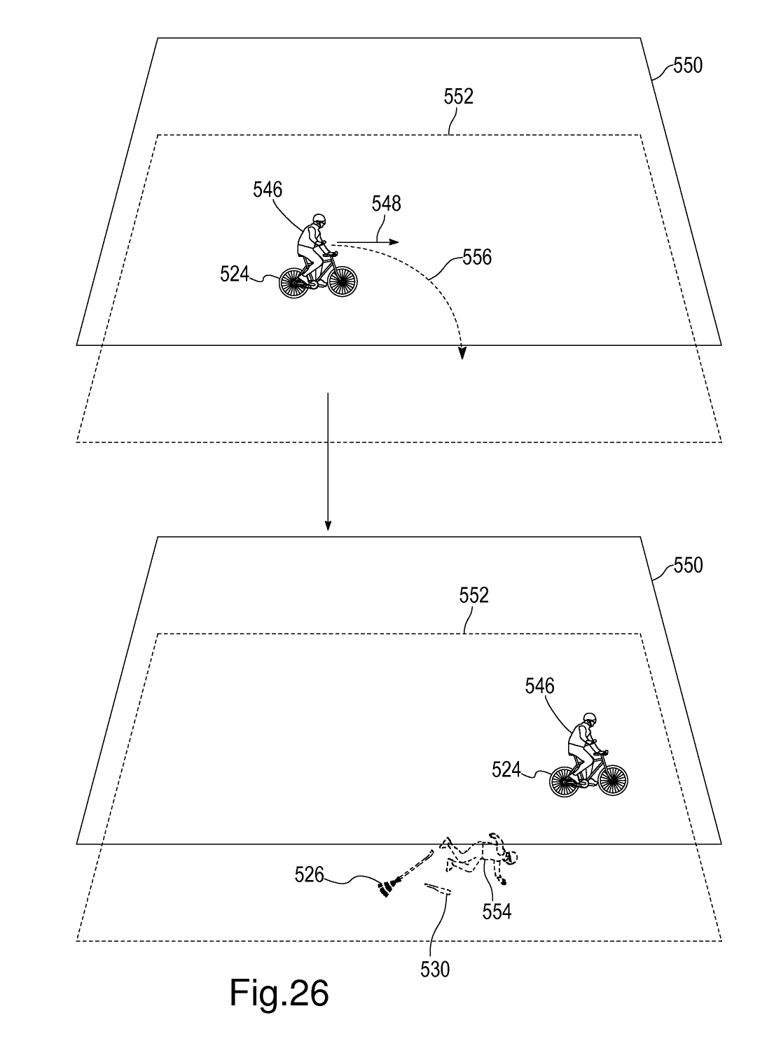

FIG. 26 illustrates some features of embodiments having some similarities to embodiments described with reference to FIGS. 20 and 21, but which are more easily described in the context of the embodiments of FIGS. 22-25. In the example shown, a real person/player 546 moves (e.g. direction of arrow 548) within a real setting or environment 550 with the aid of a real mechanical device (e.g. the real bicycle 524), as described with respect to FIGS. 22-25. The real person/player 546 (or a VR player based on the real person/player 546 or a hybrid combination of portions of the real person/player 546 and a VR player) appears to move within a VR setting or environment 552, in this example, by riding a VR device (e.g. the VR flying broomstick 526 overlaid or superimposed onto the real bicycle 524 or a portion thereof), as described with respect to FIGS. 22-25. The real person/player 546, thus, generally sees (as in the upper portion of FIG. 26) the VR setting or environment 552 vertically offset below the real setting or environment 550 depending on the height to which the real person/player 546 (or a VR player based on the real person/player 546) has supposedly flown within the VR setting or environment 552. (In the upper portion of FIG. 26, the real person/player 546 is shown without a superimposed VR player.)

In such an example, when an event occurs to the real person/player 546 (e.g. the real person/player 546 is virtually killed, wounded or incapacitated or commits a foul, goes out of bounds or perpetrates some other infraction of game rules) during game play, in some embodiments, a VR body 554 (e.g. of a VR player based on the real person/player 546) may appear to fall out of the air (e.g. direction of arrow 556). The VR body 554, thus, generally lands on the ground of the VR setting or environment 552 (as in the lower portion of FIG. 26). This result may be in addition to other penalties the real person/player 546 must suffer before continuing to play or participate in the game or sport, as described above with reference to FIGS. 20 and 21. For instance, the real person/player 546 may have to “reacquire” the VR body 554 by moving to the location corresponding to the place where the VR body 554 landed. Additionally, the real person/player 546 may have to pick up the VR flying broomstick 526 and/or any props (e.g. the VR club or bat 530, as shown, or other VR props/tools 144 and 146, FIGS. 1 and 4). Furthermore, when the VR body 554 appears to fall to the ground of the VR setting or environment 552, a VR ghost player (not specifically shown, but based on and corresponding to the real person/player 546 or a portion thereof) may optionally appear (to the viewing audience, the camera operator 118 and/or other real persons/players 546) to continue to correspond to the real person/player 546 (e.g. in the place of the VR player that was based on the real person/player 546 before the event occurred) while the real person/player 546 attempts to move (e.g. appearing to fly as a ghost) to the VR body 554.

It is understood that the embodiment of FIG. 26 is not necessarily limited to examples in which the real person/player 546 appears to fly or moves with the aid of a real mechanical device that is superimposed by a VR device as shown. Rather, this embodiment may be used with any other appropriate features or embodiments described herein depending on the design of the game or sport and the manner in which it is to be played. Thus, the particular illustrated example is shown for illustrative purposes only. Additionally, it is understood that the present invention is not limited to embodiments that incorporate the features described with reference to FIG. 26.

In some alternative embodiments regarding FIGS. 22-26, two real persons/players can be used to form a single VR player, instead of using part of the real person/player 510, 512 or 546 (e.g the upper half) to form a corresponding part of the VR player or body 532, 534 or 554 and a computer generated image to form another part of the VR player or body 532, 534 or 554. For example, the upper part of the VR player's body (torso, shoulders, arms, head) may be based on a first real person/player (not shown), and the lower part of the VR player's body (hips, legs, feet) may be based on a second real person/player (not shown). Thus, the two real persons/players have to cooperate to achieve specific goals (to play or participate) in the game or sport. It may be advantageous, in some embodiments, to have the two real persons/players be able to communicate with each other. Other embodiments, however, may be more entertaining if the two real persons/players can't communicate, except optionally perhaps by arm and/or hand gestures and head movements. In either case, according to some embodiments, the real person/player on whom the lower portion of the VR player is based is able to see (through the head mounted display 116) the movements of the other real person/player's arms and hands and may also receive some sort of indication (e.g. up, down, left and/or right arrows visible through the head mounted display 116) of the direction that the head (i.e. the head mounted display 116) of other real person/player is pointed. Still other embodiments may use more than two real persons/players to form the VR player.

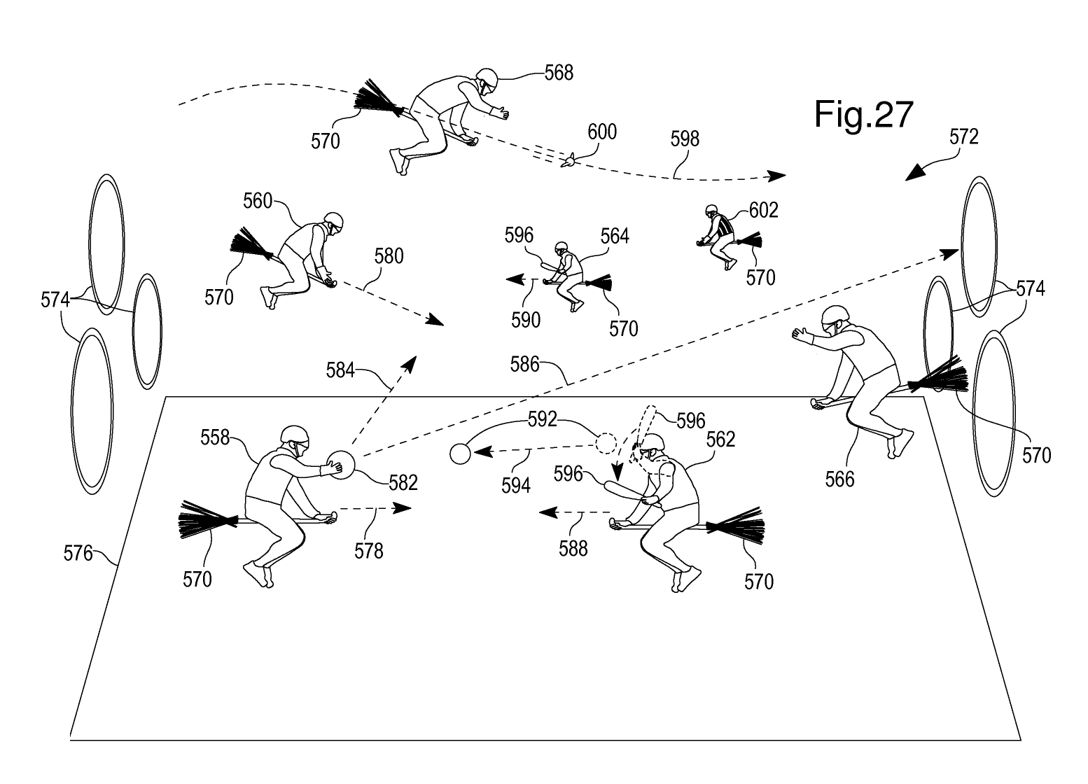

FIG. 27 illustrates an embodiment with features that enable the game or sport of Quidditch™ described in the “Harry Potter”™ book series. In this case, VR players 558-568 on two opposing teams (not specified) appear to use VR flying broomsticks 570 to fly within a VR “Quidditch pitch” (a VR setting or environment) 572 that includes multiple VR elevated ring-shaped goals 574 at opposite ends of a VR playing field 576 optionally surrounded by a VR stadium (not shown) containing VR fans (not shown).

The VR players 558-568 are generally based on real persons/players (not shown) moving within a real setting or environment (not shown), as described above. The action of flying on the VR flying broomsticks 570 and the appearance of the VR players 558-568 may be enabled as generally described above with reference to FIGS. 22-26. Additional movement within the VR Quidditch pitch 572 optionally involves any one or more of the features described above with reference to FIGS. 11-19 to enhance the appearance of the movement of the VR players 558-568.

The VR goals 574 are examples of VR environmental or setting enhancements. Other VR environmental or setting enhancements (not shown) may include audience viewing stands, audience members and a scoreboard, among other potential options.

The real persons/players (not shown) on whom the VR players 558-568 are based may all be on the same real setting or environment (not shown) or disbursed among any appropriate or available number of multiple real settings or environments. In some embodiments, for example, the real persons/players on one team may be physically located within one real setting or environment, and the real persons/players on the opposing team may be physically located within another real setting or environment. In this case, it may not be necessary for either team to physically travel to the other team's facilities in order to compete against each other. Instead, both teams may use their own real setting or environment, thereby eliminating the cost and inconvenience of travel requirements that are ubiquitous for regular sporting events.

Additionally, several real cameras 120 (FIGS. 1 and 2) are generally set up in and around each of the real settings or environments to capture the real movements of the real persons/players in order to generate some of the VR action, as described above. The physical locations of the computers 134 (FIGS. 1 and 2), the real/VR video merger equipment 188 (FIG. 5) and/or the computer/communication systems 262, 286 or 290 (FIGS. 6-8) may not matter. However, if the game or sport uses multiple real settings or environments that are relatively far from each other (e.g. in different cities or different countries), then the communication speed and bandwidth must be adequate to transmit all of the data for the real/VR video merger equipment 188 to be able to generate and transmit the augmented video 204 in real time for each of the real persons/players, so they can properly and fairly play or participate in the game or sport.

The VR players 558 and 560 generally represent the Quidditch players known as “Chasers”. Thus, the VR players 558 and 560 appear to fly around (e.g. direction of arrows 578 and 580, respectively) within the VR pitch 572 while chasing, catching and throwing a VR ball 582 known as a “Quaffle”. The VR players 558 and 560 generally are able to pass (e.g. direction of arrow 584) the VR ball 582 to each other, can intercept passes made by opposing team members and optionally can wrest the VR ball 582 directly out of the grasp of other VR Chasers (not shown). The VR players 558 and 560 score points by throwing (e.g. direction of arrow 586) the VR ball 582 through the VR goals 574 at one end of the VR pitch 572.

In order to appear to handle the VR ball 582, in various embodiments, the real persons/players (on whom the VR players 558 and 560 are based) may wear the glove 132 (FIG. 3) or handle a prop, device or controller (such as a variation of the control device prop 112, FIG. 3) with their free hand (i.e. the hand not used to appear to handle the VR flying broomstick 570). In some embodiments with the glove 132, the action of flexing the fingers and thumb by the real person/player may indicate when the VR player 558 or 560 has caught or released the VR ball 582. In some embodiments with a variation of the control device prop 112, on the other hand, the action of pressing a trigger or switch on the control device prop 112 by the real person/player may indicate when the VR player 558 or 560 has caught or released the VR ball 582. In still other embodiments with either the glove 132 or a variation of the control device prop 112, the action of virtually colliding the glove 132 or the control device prop 112 with the VR ball 582 may result in catching the VR ball 582, and an appropriate movement of the glove 132 or the control device prop 112 may indicate when the VR ball 582 is thrown or released. Other techniques for appearing to catch, hold, release and throw the VR ball 582 may also be used.

Since the VR players 558 and 560 on opposing teams may attempt to battle or struggle with each other for control of the VR ball 582, the real persons/players (on whom the VR players 558 and 560 are based) on opposing teams may not be on the same real setting or environment in some embodiments. Otherwise, real physical collisions may occur between some of the real persons/players, resulting in injury to some of them. Such occurrences may be particularly dangerous if the real persons/players use a real mechanical device (e.g. the real bicycle 524, FIGS. 22-26, or other appropriate device) to aid in creating the appearance of using the VR flying broomstick 526.

The VR players 562 and 564 generally represent the Quidditch players known as “Beaters”. Thus, the VR players 562 and 564 appear to fly around (e.g. direction of arrows 588 and 590, respectively) within the VR pitch 572 while chasing and hitting one or more VR balls 592 known as “Bludgers”. The VR players 562 and 564 appear to hit (e.g. direction of arrow 594) the VR ball 592 at the VR players 558-568 on the opposing team in order to disrupt the game play by the opposing VR players 558-568 (e.g. including, but not limited to, knocking the opposing VR players 558-568 off their VR flying broomsticks 570 or knocking the VR Quaffle ball 582 out of their grasp, causing the opposing VR players 558-568 to have to go out of their way to avoid the VR ball 592). Optionally, the VR players 562 and 564 may also accidentally appear to hit the VR ball 592 at other VR players 558-568 on their own team.

In order to appear to hit the VR ball 592, the VR players 562 and 564 may appear to wield a VR bat or club 596 with their free hand (i.e. the hand not used to appear to handle the VR flying broomstick 570). Apparent control of the VR bat or club 596 may be enabled by use of either the glove 132 or a variation of the control device prop 112 (FIG. 3) by the free hand of the real persons/players (on whom the VR players 562 and 564 are based). Swinging of the free hand (with the glove 132) or the control device prop 112 generally determines the movement of the VR bat or club 596 in such embodiments. In some alternative embodiments, the control device prop 112 is shaped like the VR bat or club 596, so it may not always be necessary to generate a VR device to create the appearance of the bat or club 596. Instead, real video (from the cameras 120, FIGS. 1 and 2) of the control device prop 112 may be used (at least sometimes) in place of the computer generated VR bat or club 596. Other techniques for appearing to hit the VR ball 592 may also be used.

Since the VR players 562 and 564 may attempt to swing the VR bat or club 596, which may be based on the control device prop 112 (FIG. 3), towards the VR players 588-568 on the opposing team when attempting to hit the VR ball 592, the real persons/players (on whom the VR players 562 and 564 are based) may not be on the same real setting or environment as the opposing VR players 588-568 in some embodiments. Otherwise, the real persons/players (on whom the VR players 562 and 564 are based) may accidentally hit the other real persons/players with the control device prop 112, potentially resulting in injury to some of them.

The VR player 566 generally represents the Quidditch players known as “Keepers”. Thus, the VR player 566 appears to fly side-to-side and up and down (e.g. almost hovering with short, but rapid, vertical and horizontal movements) in front of the VR goals 574 in order to guard the VR goals 574 against scoring by the VR players (Chasers) 558 and 560 with the VR ball (Quaffle) 582. Like the VR players 558 and 560, therefore, the VR player 566 generally appears able to catch, throw and hit the VR ball 582.

In order to appear to handle the VR ball 582, therefore, in some embodiments, the real person/player (on whom the VR player 566 is based) may wear the glove 132 (FIG. 3) or handle a prop, device or controller (such as a variation of the control device prop 112, FIG. 3) with a free hand (i.e. the hand not used to appear to handle the VR flying broomstick 570). The VR player 566 may use the glove 132 or the control device prop 112 in much the same way as the VR players 558 and 560. However, since the task of the VR player 566 is simply to prevent the VR ball 582 from going through any of the VR goals 574 that the VR player 566 is guarding, the VR player 566 doesn't necessarily have to be able to appear to catch the VR ball 582. Instead, it is acceptable in some embodiments for the VR ball 582 to appear simply to be deflected off of any part of the body, costume or equipment (including the VR flying broomstick 570) of the VR player 566. Also, some embodiments may incorporate any appropriate combination of catching and deflecting of the VR ball 582.

Since the VR goals 574 are the targets for each team's VR players (Chasers) 558 and 560, it is very likely that the VR players 558 and 560 will come very close to the VR goals 574 and, thus, the opposing team's VR player 566. In some embodiments, at least the real person/player on whom the VR player 566 is based may not be on the same real setting or environment as the opposing team's real persons/players on whom the VR players 558 and 560 are based. Otherwise, injury-resulting collisions between these real persons/players may be very likely.

The VR player 568 generally represents the Quidditch players known as “Seekers”. Thus, the VR player 568 appears to fly around (e.g. along the path of curving arrow 598) within the VR pitch 572 while chasing and trying to catch a fast small winged VR ball 600 known as a “Golden Snitch”. The VR player 568 scores points and ends the game by catching the VR ball 600.

In order to appear to catch the VR ball 600, in various embodiments, the real person/player (on whom the VR player 568 is based) may wear the glove 132 (FIG. 3) or handle a prop, device or controller (such as a variation of the control device prop 112, FIG. 3) with a free hand (i.e. the hand not used to appear to handle the VR flying broomstick 570). In some embodiments with the glove 132, the action of flexing the fingers and thumb by the real person/player when the VR ball 600 is located at the palm of the VR free hand of the VR player 568 may indicate when the VR player 568 has caught the VR ball 600. In some alternative embodiments with either the glove 132 or a variation of the control device prop 112, on the other hand, a VR collision between the VR ball 600 and either the glove 132 or the control device prop 112 (or a VR hand or device based on the glove 132 or the control device prop 112) may indicate when the VR player 568 has caught the VR ball 600. Other techniques for appearing to catch and hold the VR ball 600 may also be used.

Since the primary or sole focus of the VR player 568 is on the VR ball 600, in some embodiments, the real person/player (on whom the VR player 568 is based) may not be on the same real setting or environment as any of the other real persons/players (on whom the other VR players 558-566 are based), regardless of which team they are on.

In addition to the interactions between the VR balls 582, 592 and 600 and the VR players 558-568 and VR equipment described above, in some embodiments, the VR balls 582, 592 and 600 may not be able to pass through the VR flying broomsticks 570, the VR goals 574 and all parts of the VR players 558-568 and their uniforms/costumes/clothing and other VR equipment. Instead, the VR balls 582, 592 and 600 may appear to bounce off of such VR items/objects/persons.

Apparent movement of the VR players 558-568 within the VR Quidditch pitch 572 may be enabled by the features described above with reference to FIGS. 22-26 with optional enhancements according to any combination of the features described above with respect to FIGS. 11-19. The VR players 558-564 and 568, for instance, typically have to appear to fly quickly throughout the length, width and height of the VR Quidditch pitch 572, quickly changing direction and speed as needed. Therefore, if a real mechanical device is used to aid the real persons/players (on whom the VR players 558-564 and 568 are based) to move through the real setting or environment (not shown), as described above with reference to FIGS. 22-26, then real mechanical devices that are easily maneuvered, accelerated and decelerated and capable of adequate speed may be used in some embodiments. Additionally, for embodiments in which slower real mechanical devices are selected, e.g. for their greater apparent maneuverability, the enhancements according to any combination of the features described above with respect to FIGS. 11-19 may be incorporated in order to increase the apparent speed of any one or more of the VR players 558-568.

The VR player (Seeker) 568, in particular, is typically expected to appear to fly very fast in order to catch the VR ball 600. Therefore, in addition to, or instead of, using a relatively fast real mechanical device, some embodiments may also incorporate any one or more of the features described above with respect to FIGS. 11-19 in such a manner that the speed of the VR player 568 is more greatly enhanced than that of the other VR players 558-566.

The VR player (Keeper) 566, on the other hand, is typically not expected to appear to fly forwards or backwards very fast or far, but to appear to fly rapidly side-to-side, changing direction very quickly. Therefore, in some embodiments, the VR player 566 may be on foot or may use a real mechanical device (such as skates) that is specifically selected for such quick direction changing capabilities.

Additionally, if real persons/players of unequal ability are playing or competing together, then some embodiments may incorporate the features described above with respect to FIGS. 11-19 in such a manner as to “handicap” the better real persons/players or help the worse real persons/players in order to equalize, or normalize, their abilities. In particular, the real setting or environment (e.g. 358, FIG. 13) in which the worse real person/player participates may be smaller than the real setting or environment in which the better real person/player participates, while the VR setting or environment (e.g. 348 of FIG. 13, or 572 of FIG. 27) is the same apparent size for both real persons/players. In this manner, the speed of the worse real person/player is more greatly enhanced than that of the better real person/player.

When a VR player 558-568 commits a foul, or flies out of bounds, or collides with another VR player 558-568 (or their uniform/costume or equipment), or enters an off-limits area (e.g. the space immediately surrounding the VR goals 574 may be off-limits to all VR players 558-564 and 568, except the VR player 566), or is hit with the VR ball (Bludger) 592, then an appropriate penalty may be assessed against the offending VR player 558-568. For example, a body of the VR player 558-568 may appear to fall to the ground, as described above with reference to FIG. 26. Alternatively, the body of the VR player 558-568 may simply appear to be stopped momentarily in midair at or near the location of the offense. In another alternative, the body of the VR player 558-568 may appear to be quickly or instantaneously transported to a penalty box (not shown) outside of the VR Quidditch pitch 572. Thus, in some embodiments, the real person/player may see that he or she has been virtually separated from the body of the VR player 558-568 and may have to move to that part of the real setting or environment (not shown) that corresponds to the location in the VR Quidditch pitch 572 where the body of the VR player 558-568 is in order to reacquire the body of the VR player 558-568, similar to the features described above with respect to FIGS. 20 and 21. Other appropriate penalties, such as, but not limited to, those described above, may also be assessed.

In some embodiments, a VR referee or umpire 602 may appear to move around within the VR Quidditch pitch 572 in order to keep a close watch on the game play in real time. In order not to interfere with the game play, however, some embodiments may place the real person/player (on whom the VR referee or umpire 602 is based) in a real setting or environment (not shown) separate from all of the VR players 558-568. The VR players 558-568 may optionally be allowed to appear to fly directly through the VR referee or umpire 602, instead of having to go around, so that game play is not interrupted. In some alternatives, the VR referee or umpire 602 may be partially transparent or completely invisible to the real persons/players (on whom the VR players 558-568 are based), so they are not distracted during game play. Additionally, in some alternatives, the VR referee or umpire 602 may be fully visible, partially transparent or completely invisible to the audience, depending on what option looks best for the audience's enjoyment. In some such alternative embodiments, the VR referee or umpire 602 may suddenly become fully visible upon calling a foul or penalty. Furthermore, in order to make it easier for the VR referee or umpire 602 to appear to keep up with the VR players 558-568 during game play, in some embodiments, the movement of the VR referee or umpire 602 may be more greatly enhanced by any one or more of the features described above with respect to FIGS. 11-19 than are the movements of any of the VR players 558-568. Also, in some embodiments, the VR referee or umpire 602 appears to have the ability to grab and/or to move any of the VR players 558-568 from almost any location to any appropriate location within the VR Quidditch pitch 572, e.g. as a penalty for an offense committed by any of the VR players 558-568.

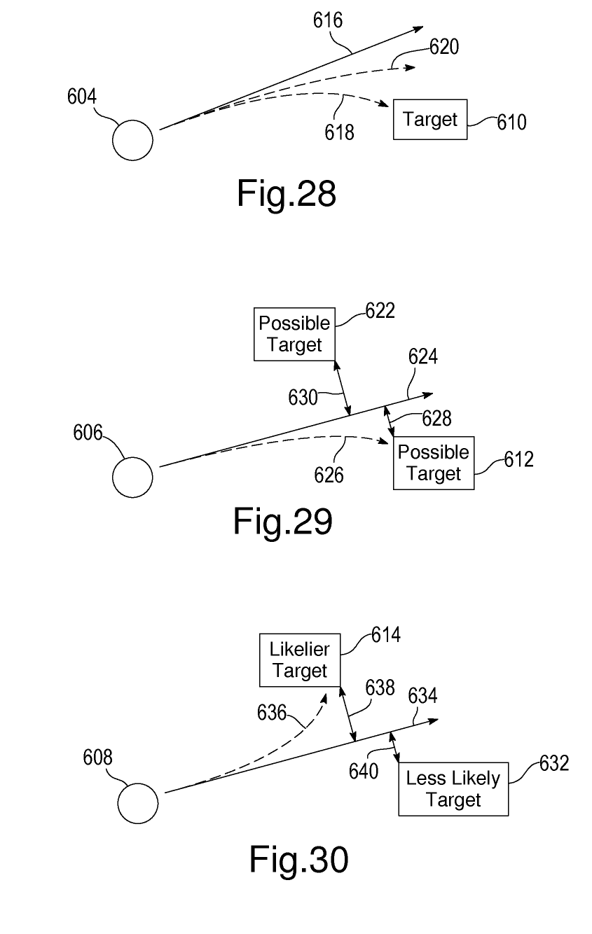

In order to make the game or sport easier to play, according to some embodiments, the VR balls 582 and/or 592 may appear to be “attracted” to certain targets, characters or objects, as described with reference to FIGS. 28, 29 and 30. In FIGS. 28, 29 and 30, a VR ball or element 604, 606 or 608, respectively, is thrown or hit toward a (real or VR) target or element 610, 612 or 614, respectively, with results that depend on the situation, as described.

For example, if any of the features described above with reference to FIGS. 11-19 and/or FIGS. 22-26 are used to make the VR players 558-568 appear to move very fast in order to enhance the excitement of the game or sport, then the game or sport may be too difficult for some people to play. Therefore, according to some embodiments (regardless of whether any of the features described above with reference to FIGS. 11-19 and/or FIGS. 22-26 are used), when the VR ball 604 (e.g. the VR ball/Quaffle 582) is thrown (e.g. by one of the VR players/Chasers 558 or 560) at the target 610 (e.g. a fellow teammate VR player 558 or 560 or one of the VR goals 574), an original trajectory (along arrow 616, as calculated, e.g. by the computers 134, FIGS. 1 and 2) of the VR ball 604 may be altered to curve (e.g. along arrow 618) the flight of the VR ball 604 toward the target 610. In this manner, the fellow teammate VR player 558 or 560 is more likely to be able to appear to catch the VR ball 604, or the VR ball 604 is more likely to appear to go through one of the VR goals 574. (A similar example may be made with respect to the VR ball/Bludger 592 when it is hit by one of the VR players/Beaters 562 or 564 towards an opposing team VR player 558-568.)

In some embodiments, the alteration of the trajectory of the VR ball 604 may be done so that it appears to be attracted (e.g. as if by gravity or magnetism) to the target 610. The degree to which the trajectory of the VR ball 604 is curved (e.g. the strength with which the target 610 appears to attract the VR ball 604) may be preset (in accordance with the design and rules of the game or sport) within the apparatus (e.g. the computers 134, FIGS. 1 and 2) that calculates the trajectories. Thus, the VR ball 604 may curve more (e.g. along arrow 618) or less (e.g. along arrow 620) toward the target 610 as desired, according to the embodiment.

Additionally, in some embodiments, the VR ball 604 may curve less when hit harder (or faster) than when it is hit softer (or slower); thereby giving the appearance that the VR ball 604 has mass and momentum. Furthermore, in some embodiments, the degree to which the trajectory of the VR ball 604 is curved (e.g. the strength with which the target 610 appears to attract the VR ball 604) may be set differently depending on who threw or hit the VR ball 604. In this manner, better players may be handicapped, and worse players may be helped, by having the VR ball 604 curve less toward the target 610 when thrown or hit by the better players than when thrown or hit by the worse players. Also, in some embodiments, a player may be penalized for rules violations by reducing (temporarily or for the remainder of the game or event) the degree to which the trajectory of the VR ball 604 is curved toward the target 610 (or the strength with which the target 610 appears to attract the VR ball 604).

FIG. 29 illustrates some embodiments in which there is more than one possible target (e.g. 612 and 622) for the VR ball 606 to curve towards. In this case, depending on the desires of the game designers or on the rules of the game or sport, the original trajectory (e.g. along arrow 624) of the VR ball 606 is calculated. Then the VR ball 606 may be made to appear to curve or be attracted toward (e.g. along arrow 626) whichever of the multiple possible targets (e.g. 612 and 622) to which it would have passed closest along that original trajectory (arrow 624), i.e. the VR ball 606, in this example, is made to appear to curve toward the target 612 because the distance 628 (from the trajectory arrow 624 to the possible target 612) is shorter than the distance 630 (from the trajectory arrow 624 to the possible target 622).

In other embodiments, the original trajectory of the VR ball 606 may be calculated along with the original distances of the VR ball 606 to all of the possible targets (e.g. 612 and 622). The trajectory of the VR ball 606 may then be curved while continually updating the curvature of the trajectory based on repeated recalculations of the distances between the VR ball 606 and all possible targets (e.g. 612 and 622), taking into account changes in the positions, not only of the VR ball 606, but also of the possible targets (e.g. 612 and 622), where appropriate. In this manner, the VR ball 606 may appear to be influenced by the gravitational or magnetic attraction of all of the possible targets (e.g. 612 and 622) as it traverses through the VR setting or environment (e.g. the VR Quidditch pitch 572, FIG. 27) in real time.

FIG. 30 illustrates some embodiments in which there is not only more than one possible target (e.g. 614 and 632) for the VR ball 608 to curve towards, but one of the possible targets (e.g. 614) may be a “likelier” target than the other possible targets (e.g. 632). For example, one of the VR players/Chasers 558 or 560 (FIG. 27) is more likely to desire to throw the VR ball/Quaffle 582 to a teammate VR player/Chaser 558 or 560 or at one of the VR goals 574 than to throw the VR ball/Quaffle 582 to any opposing team VR player 558-568 or even to a fellow teammate VR player/Beater/Keeper/Seeker 562, 564, 566 or 568. Similarly, one of the VR players/Beaters 562 and 564 is more likely to desire to hit the VR ball/Bludger 592 at an opposing team VR player 558-568 than at a teammate. Therefore, in some embodiments, the apparatus (e.g. the computers 134, FIGS. 1 and 2) that calculates the trajectory (e.g. original trajectory arrow 634) of the VR ball 608 may cause the VR ball 608 to appear to curve (e.g. along arrow 636) toward the likelier target (e.g. 614) even if the less likely target (e.g. 632) is closer to the original trajectory (arrow 634) of the VR ball 608, i.e. even though distance 638 (between the arrow 634 and the likelier target 614) is longer than distance 640 (between the arrow 634 and the less likely target 632).

In other embodiments, the original trajectory of the VR ball 608 may be calculated along with the original distances of the VR ball 608 to all of the possible targets (e.g. 614 and 632), whether they are likely or unlikely to be the desired target. The trajectory of the VR ball 608 may then be curved while continually updating the curvature of the trajectory based on repeated recalculations of the distances between the VR ball 608 and all possible targets (e.g. 614 and 632), taking into account changes in the positions, not only of the VR ball 608, but also of the possible targets (e.g. 614 and 632), where appropriate. The curvature of the trajectory may also be calculated based on a relative attraction (and optionally repulsion) of the possible targets (e.g. 614 and 632) that depends on the likelihood of whether the possible targets (e.g. 614 and 632) are a desired target of the player who threw or hit the VR ball 608. In this manner, the VR ball 608 may appear to be influenced not only by the attraction (e.g. gravitational or magnetic) of the likely targets (e.g. 614), but also by a lesser attraction (or repulsive force) of the less likely targets (e.g. 632) as it traverses through the VR setting or environment (e.g. the VR Quidditch pitch 572, FIG. 27) in real time.

Additionally, in some embodiments, the feature described with reference to FIG. 30 may be combined with features described with reference to FIG. 29, so that the apparatus (e.g. the computers 134) that calculates the trajectory of the VR ball 608 may calculate the most likely target when more than one potentially likely target and one or more typically unlikely targets are all possible targets. Furthermore, in some embodiments, the features described with reference to FIGS. 28, 29 and 30 may be used in any appropriate combination or not at all.

It is understood that the features described with reference to FIGS. 22-30 are not limited to embodiments involving the game of Quidditch™. Instead, these features may be used in other embodiments involving other games or sports, whether based on conventional games or on games newly developed specifically to take advantage of any of the features described herein.

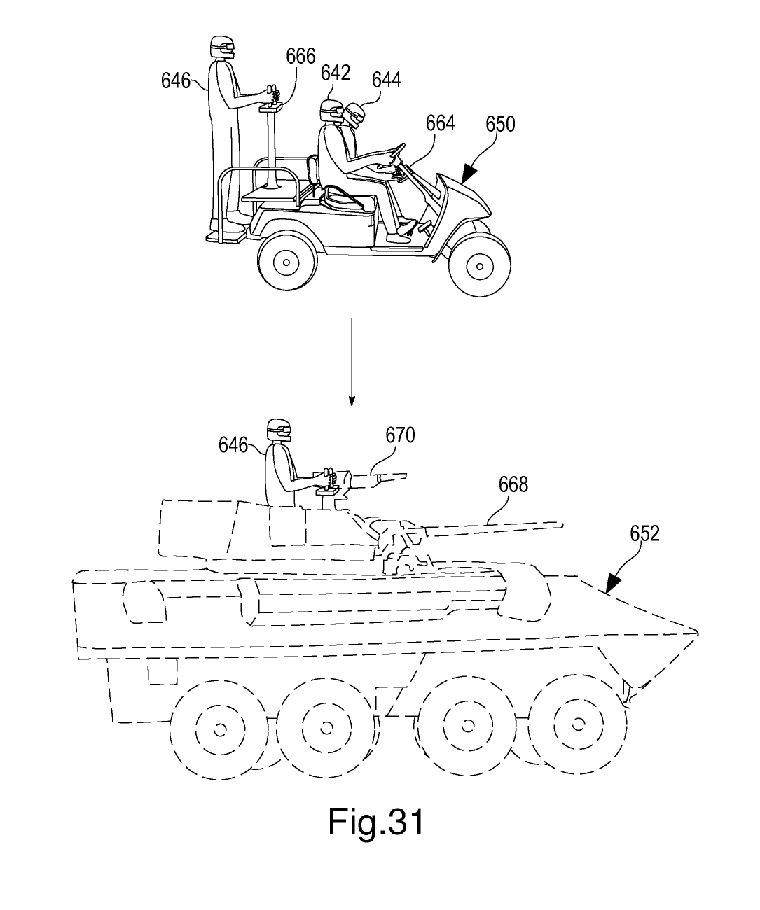

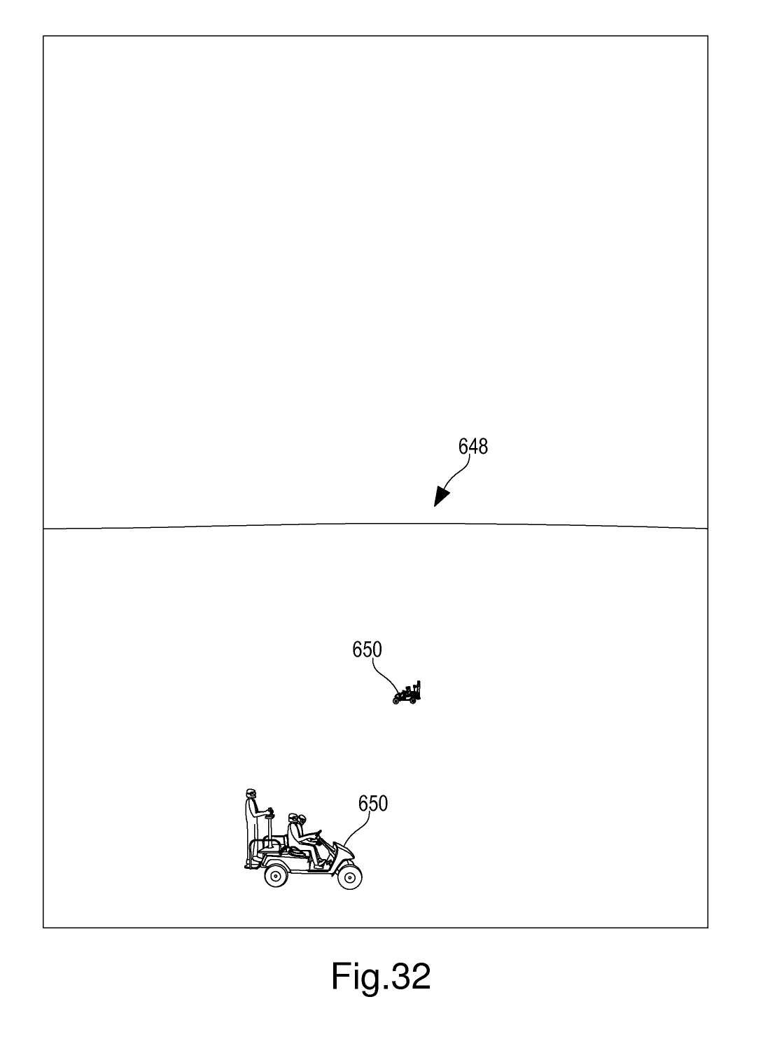

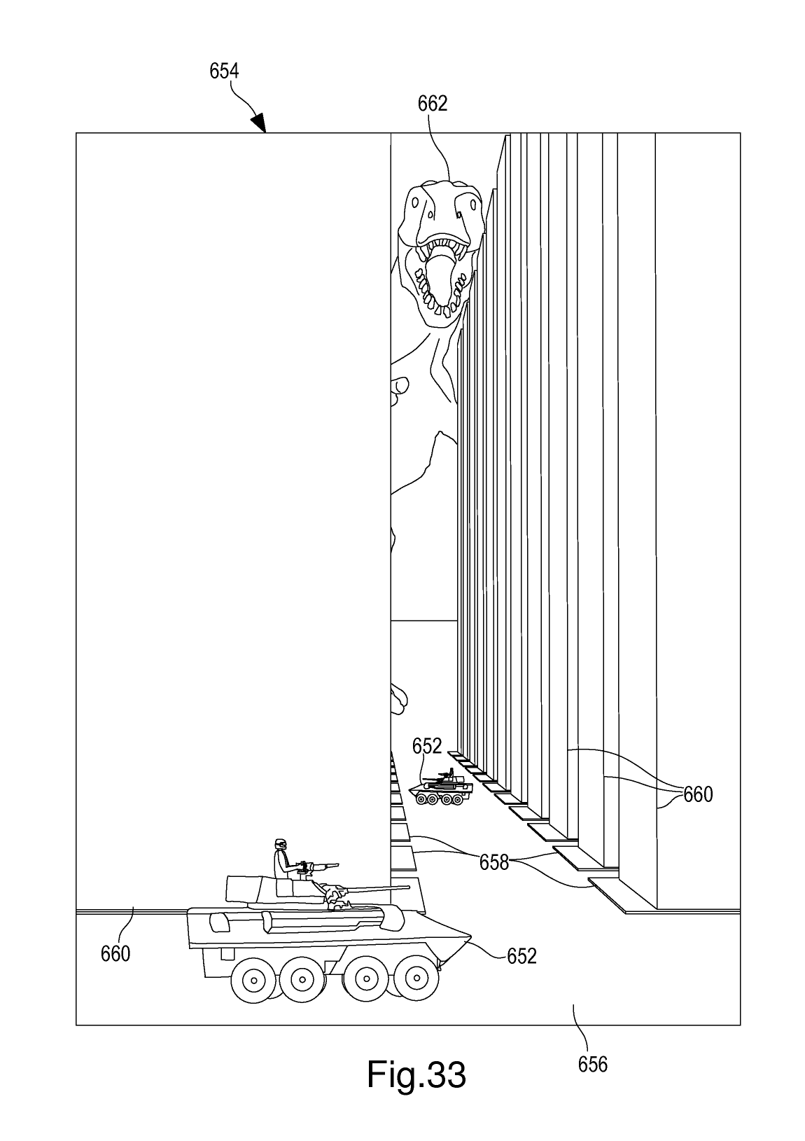

FIGS. 31, 32 and 33 illustrate additional embodiments in which one or more real persons/players (e.g. 642, 644 and 646) move through a real setting or environment (e.g. 648, FIG. 32) with the aid of a real mechanical device that is superimposed by and almost completely obscured by a VR device that the real persons/players 642, 644 and 646 appear to use to move through a VR setting or environment (e.g. 654, FIG. 33). (See additional description above with respect to FIGS. 22-26.) In this case, the real mechanical device is a real motorized cart 650 (FIGS. 31 and 32), and the VR device is a VR military assault vehicle 652 (FIGS. 31 and 33).

FIGS. 31, 32 and 33 also illustrate additional embodiments with examples of VR environmental or setting enhancements. In this case, the VR environmental or setting enhancements include objects that are commonly seen in a city, such as streets 656, sidewalks 658 and tall buildings 660, among other objects (not shown).

FIGS. 31, 32 and 33 further illustrate additional embodiments with an example of a VR enemy/person/character that can fight or defend against the real persons/players 642, 644 and 646. In this case, the VR enemy/person/character is a large VR monster 662, as illustrated, but may alternatively be any other VR human, animal, fictional creature, robot, machine, etc. of any appropriate or desired size, shape or number.

The first real person/player 642 is shown operating the real motorized cart 650 in order to drive around in the real setting or environment 648. The second real person/player 644 is shown looking at and operating a control panel or feedback device 664 mounted in front of the passenger seat of the real motorized cart 650. And the third real person/player 646 is shown operating a control device 666 mounted on the back of the real motorized cart 650.

The VR military assault vehicle 652 is superimposed onto and almost completely obscures the real motorized cart 650, and the VR setting or environment 654 is superimposed onto and almost completely obscures the real setting or environment 648. Thus, the first real person/player 642 appears to drive the VR military assault vehicle 652 around in the VR setting or environment 654. However, in some embodiments, the first real person/player 642 is not visible to the viewing audience, since the VR military assault vehicle 652 may completely obscure the first real person/player 642, as if the first real person/player 642 is inside the VR military assault vehicle 652. In other embodiments, the head of the first real person/player 642 may appear to the viewing audience to be protruding slightly above the main body of the VR military assault vehicle 652, as if the first real person/player 642 can see out of the VR military assault vehicle 652 in this manner.

In some embodiments, the second real person/player 644 operates the control panel or feedback device 664 in order to appear to operate a VR high-caliber rotatable cannon 668 mounted on top of the VR military assault vehicle 652 while the VR military assault vehicle 652 appears to move through the VR setting or environment 654. The control panel or feedback device 664, therefore, may have appropriate joysticks, switches or buttons that may be used to appear to rotate, aim and fire the VR cannon 668. In other embodiments, the control panel or feedback device 664 has a display that provides information, such as a simulated radar showing the location of enemies, allies and/or objects in the real setting or environment 648 (or in the VR setting or environment 654) relative to the VR military assault vehicle 652. Other information (such as fuel supply, ammo supply, health count, vehicle damage percent, hit/kill count, etc.) may also be provided as feedback through the control panel or feedback device 664 to the second real person/player 644. The second real person/player 644 may, thus, keep track of and share this information with the other real persons/players 642 and 646.

Additionally, in some embodiments, the second real person/player 644 is not visible to the viewing audience or other real persons/players (not shown), since the VR military assault vehicle 652 may completely obscure the second real person/player 644, as if the second real person/player 644 is inside the VR military assault vehicle 652. In other embodiments, the head of the second real person/player 644 may appear to the viewing audience to be protruding slightly above the main body of the VR military assault vehicle 652, as if the second real person/player 644 can see out of the VR military assault vehicle 652 in this manner. Furthermore, some embodiments may combine any number of the features described with reference to the control panel or feedback device 664 and/or with reference to the second real person/player 644 with any number of other features described or not described herein.

In some embodiments, the third real person/player 646 operates the control device 666 in order to appear to operate a VR tilt/swivel turret-mounted machine gun 670 on the top of the VR military assault vehicle 652 while the VR military assault vehicle 652 appears to move through the VR setting or environment 654. The control device 666, therefore, may have appropriate joysticks, switches or buttons that may be used to appear to rotate, aim and fire the VR machine gun 670. Additionally, the control device 666 may also be mounted on the real motorized cart 650 in a manner that allows it to be tilted, swiveled and rotated by the third real person/player 646. Furthermore, the third real person/player 646 also generally has sufficient room on the back of the real motorized cart 650 in which to move to properly tilt, swivel and rotate the control device 666.

Additionally, in some embodiments, the third real person/player 646 is visible to the viewing audience or other real persons/players (not shown), since the third real person/player 646 protrudes out of the VR military assault vehicle 652, as shown. In other embodiments, the third real person/player 646 may not be visible to the viewing audience, since the third real person/player 646 may be allowed to appear to hide down inside the main body of the VR military assault vehicle 652. Furthermore, some embodiments may combine any number of the features described with reference to the third real person/player 646 and/or the control device 666 with any number of other features described or not described herein.

In some embodiments, only one or two of the real persons/players (e.g. 642, 644 and 646) are included in the real motorized cart 650. Additionally, in some embodiments, multiple real motorized carts 650 may be used with different combinations of any number of the real persons/players (e.g. 642, 644 and 646). In still other embodiments, the real persons/players (e.g. 642, 644 and 646) may have additional or different duties, other than those described, to perform in the real motorized cart 650.

In some embodiments, only the first real person/player/driver 642 is in the real motorized cart 650, while the other real persons/players (e.g. 644 and/or 646) are at one or more separate, stationary apparatuses with whatever control or display devices they need to perform their tasks. The other real persons/players (e.g. 644 and/or 646) generally see (through the head mounted displays 116, FIGS. 1 and 3) the VR setting or environment 654 and the VR military assault vehicle 652 as if they were in their respective places in the VR military assault vehicle 652. The other real persons/players (e.g. 644 and/or 646) may communicate wirelessly with the first real person/player/driver 642 while playing or participating in the game or sport in order to coordinate their activities. This alternative may be used, for example, for safety purposes to prevent accidental injury to the other real persons/players (e.g. 644 and/or 646) due to the real motorized cart 650 being too unstable if too many real persons/players were to be in the real motorized cart 650. This alternative may also be used, in some embodiments, when a smaller real vehicle in which only one real person/player can fit is being used. Other reasons for using this alternative may also be apparent, depending on the situation.

Depending on the rules of the game or sport, in the illustrated embodiment of FIGS. 31-33, the real persons/players 642, 644 and 646 generally use the real motorized cart 650 to drive around the real setting or environment 648, while appearing to the viewing audience to be riding/driving the VR military assault vehicle 652 around in the VR setting or environment 654. Additionally, the viewing audience, the real persons/players 642, 644 and 646 (through the head mounted displays 116, FIGS. 1 and 3) and one or more of the camera operators 118 (FIGS. 1 and 2, through one or more of the real cameras 120) see the VR military assault vehicle 652, the VR setting or environment 654 and the VR monster 662.

In the illustrated embodiment of FIGS. 31-33, the real persons/players 642, 644 and 646 generally battle the VR monster 662 before it can destroy the city (i.e. the tall buildings 660 and any other objects, not shown), e.g. as if the real persons/players 642, 644 and 646 were in a Godzilla™ movie. Additionally, in some embodiments, the real persons/players 642, 644 and 646 may exit the VR military assault vehicle 652 to change to a different VR vehicle/device or to enter one of the buildings 660 (e.g. to rescue people, etc.) or to battle the VR monster 662 on foot.

It is understood, however, that the present invention is not limited to the particular embodiment shown in FIGS. 31-33. Instead, this particular embodiment is merely illustrative of many examples in which one or more real persons/players (or their VR representations) are placed in a VR world that may be similar in many ways to the real world, but which may also have many differences. There are many prior art video games, for example, that are played on a computer or video game console that involve characters who must pass through and perform tasks or quests in a wide variety of worlds. Many of the features described throughout this specification, not just the features described with reference to FIGS. 31-33, enable real persons/players to be placed in many such worlds in order to appear to actually play or participate in these worlds, sometimes for the benefit of a viewing audience. Some of the prior art video games (e.g. Halo™, World of Warcraft™, Team Fortress™, Left for Dead™, Final Fantasy™ and many others), for instance, can be adapted according to any one or more of the features described herein to enable real persons/players to be placed in such worlds, whether or not produced as a video show for the benefit of a viewing audience. Additionally, completely new video games or VR worlds may be developed to take advantage of any of the features or embodiments described herein, and a video show may optionally be produced in order to present the game to a viewing audience.

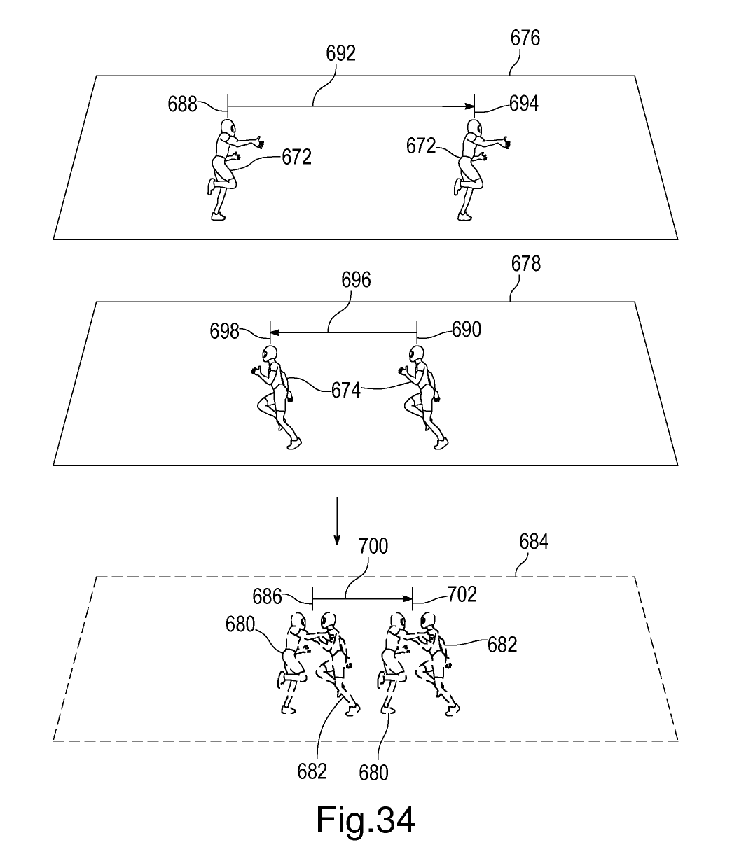

FIG. 34 illustrates embodiments in which multiple real persons/players 672 and 674 are on different real settings or environments 676 and 678, respectively, but appear to be multiple VR players 680 and 682, respectively, on the same VR setting or environment 684. Additionally, according to the rules of the game or sport in such embodiments, the VR players 680 and 682 are able to block or push against each other in order to prevent or hinder each other from moving within the VR setting or environment 684. For example, in a VR game or sport based on the conventional games of Rugby or American-style football, the VR players 680 and 682 would be expected to block and push, as well as tackle, each other. In the illustrated embodiment, since opposing team real persons/players 672 and 674 are on different real settings or environments 676 and 678, respectively, they don't actually touch each other, but their respective VR players 680 and 682 may potentially touch or collide with each other.

In this example, when the VR players 680 and 682 collide at point 686 in the VR setting or environment 684, the first real person/player 672 is at point 688 in the first real setting or environment 676, and the second real person/player 674 is at point 690 in the second real setting or environment 678. After the VR players 680 and 682 collide at point 686, the first real person/player 672 runs (right arrow 692) to point 694 in the first real setting or environment 676, and the second real person/player 674 runs (left arrow 696) to point 698 in the second real setting or environment 678. Since the first real person/player 672 ran further to the right than the second real person/player 674 ran to the left, the net difference between the two distances (distance from point 688 to point 694 and distance from point 690 to point 698) is applied to the VR players 680 and 682. Thus, the VR players 680 and 682 appear to move (right arrow 700) from point 686 to point 702 in the VR setting or environment 684. (The distance from point 688 to point 694 minus the distance from point 690 to point 698 equals the distance from point 686 to point 702.) In this manner, the VR player 680 based on the faster real person/player 672 is able to push back the VR player 682 based on the slower real person/player 674.

In some alternative embodiments, the distance that a VR player is able to push back an opposing team VR player may be “weighted” to give one of the VR players an advantage over the other VR player. For example, a better real person/player may be handicapped by having to run a further distance than a worse real person/player has to run just to be able to prevent the VR player based on the better real person/player from being pushed backward. Alternatively, the worse real person/player may be helped by applying the features described above with respect to FIGS. 11-13, i.e. the VR player may be made to appear to run faster/further than the real person/player (on whom the VR player is based) can actually run. In this manner, the abilities of the real persons/players may be equalized or normalized. Additionally, in some embodiments, when a real person/player commits a foul or offense or infraction of the rules, then that real person/player may be penalized with a handicap in this manner as a penalty for the violation. Alternatively, when a real person/player achieves a “bonus” in the game play, then that real person/player may be helped in this manner as a reward for the achievement.

In other alternatives for embodiments involving FIG. 34, the VR players 680 and 682 may be able to appear to grab hold of each other to hold each other back or push each other forward. For example, the real persons/players 672 and 674 may use the glove 132 or some variation on the control device prop 112 (FIG. 3) to grab, hold or otherwise influence the other VR players 680 and 682. In some embodiments, feedback regarding the strength of the grip of the real person/player 672 or 674 (and/or the speed or manner in which the arms and/or hands of the real person/player 672 or 674 move) may assist in determining whether, or to what extent, the other VR player 680 or 682 is thus affected.

What is claimed is:

1. A video show recorded in a tangible medium for distribution and presentation to an audience, comprising:
video portions of a player based on a real person wearing a head mounted display through which the real person sees a virtual reality object with which the real person attempts to interact while moving within a real environment; and
generated virtual video portions of the virtual reality object within a virtual reality environment and depicting any action of the virtual reality object in response to attempts by the real person to interact with the virtual reality object, at least a portion of the virtual reality environment corresponding to the real environment.

2. A video show as defined in claim 1, wherein:
the video portions of the player include generated virtual video portions of a virtual person generated by motion-capture of the real person moving within the real environment, wearing the head mounted display and attempting to interact with the virtual reality object during the motion-capture.

3. A video show as defined in claim 2, wherein:
when the real person moves a first distance, the virtual person appears to move a second distance relative to the virtual reality environment, and the first distance is not the same as the second distance.

4. A video show as defined in claim 2, wherein:
when the real person moves at a first velocity, the virtual person appears to move at a second velocity relative to the virtual reality environment, and the first velocity is not the same as the second velocity.

5. A video show as defined in claim 2, wherein:
as the real person moves around in a real space, the virtual person appears to move around in a virtual space, and the virtual space does not have the same apparent size as the real space.

6. A video show as defined in claim 1, further comprising:
the video portions of the player include recorded video portions of at least a portion of the real person attempting to interact with the virtual reality object while moving within the real environment;
and wherein the recorded video portions are recorded with a camera having a display screen on which a camera user can see at least a portion of the real environment and at least a portion of the real person and at least a portion of the virtual reality object during the recording.

7. A video show as defined in claim 1, further comprising:
generated virtual video portions of virtual reality body enhancements superimposed onto the real person.

8. A video show as defined in claim 1, further comprising:
generated virtual video portions of a plurality of the virtual reality object comprising one or more of: a target, a virtual reality setting, a wall, a door, a trap, a pit, a building, a hole, a cave, a tunnel, a hallway, a pathway, a prop, a weapon, a projectile, a key, a tool, a vehicle, a flying device, a person, an animal, a monster, a robot, a machine, a mountain, a canyon, a piece of another object, a location marker, a puzzle, a keyboard, a keypad, a display, a set of one or more symbols and an obstacle.

9. A video show as defined in claim 1, wherein:
the real person attempts to interact with the virtual reality object by performing one or more of: battling it, overcoming it, cooperating with it, avoiding it, dodging it, activating it, receiving information from it, reading it, typing on it, pressing it, listening to it, talking to it, destroying it, traversing through it, entering it, standing on it, walking on it, running on it, going around it, climbing it, catching it, throwing it, moving it, attacking it, shooting it, riding it, flying on it, hiding from it and touching it.

10. A video show as defined in claim 1, wherein:
the real person handles a real object with which the real person attempts to interact with the virtual reality object.

11. A video show as defined in claim 1, wherein:
the virtual reality object is superimposed onto a real object.

12. A video show as defined in claim 11, wherein:
as the real object moves within the real environment, the virtual reality object appears to move correspondingly within the virtual reality environment.

13. A video show as defined in claim 11, wherein:
the real object is an article held by the real person.

14. A video show as defined in claim 1, further comprising:
generated virtual video portions of virtual reality setting enhancements.

15. A video show as defined in claim 1, further comprising:
video portions of the virtual reality environment superimposed onto the real environment;
and wherein the virtual reality environment appears to move relative to the real environment in response to a predetermined event.

16. A video show as defined in claim 1, further comprising:
video portions of the virtual reality environment superimposed onto the real environment;
and wherein the virtual reality environment appears to extend beyond physical boundaries of the real environment.

17. A video show as defined in claim 1, further comprising:
generated virtual video portions of a virtual body of the player, but appearing to be separate from the real person.

18. A video show as defined in claim 1, wherein:
the real person moves through the real environment with the aid of a mechanical device;
the mechanical device is one of: skates, a scooter, a motorcycle, a unicycle, a skateboard, a wheelchair, a boat, a bicycle, an automobile and a cart;
the video show further comprises generated virtual video portions of a virtual device superimposed onto, and at least partially obscuring, the mechanical device; and
the virtual device is one of: a flying broomstick, a flying carpet, a spaceship, an airplane, a car, a truck, a tank, a military assault vehicle and a ship.

19. A video show recorded in a tangible medium, comprising:
video portions of a plurality of players on teams, the players being based on a plurality of real persons, each real person wearing a head mounted display through which the real person sees a plurality of virtual reality objects with at least a subset of which the real person attempts to interact while moving within a real environment; and
generated virtual video portions of the virtual reality objects within a virtual reality environment and depicting action of the virtual reality objects in response to attempts by the real persons to interact with the virtual reality objects, at least a portion of the virtual reality environment corresponding to the real environment, at least a portion of the virtual reality objects being first, second and third virtual reality balls;
and wherein:
the video show depicts the players appearing to move within the virtual reality environment while riding on flying broomsticks;
the video show depicts at least a portion of the players attempting to interact with the first virtual reality ball by chasing it, catching it, throwing it and scoring with it;
the video show depicts at least a portion of the players attempting to interact with the second virtual reality ball by chasing it, hitting it, dodging it and being hit by it; and
the video show depicts at least a portion of the players attempting to interact with the third virtual reality ball by chasing it and catching it.

20. A method of making, distributing and presenting a video show, comprising:
generating at least one virtual reality object within a virtual reality environment, at least a portion of which corresponds to a real environment;
displaying the virtual reality object to at least one real person through at least one head mounted display worn by the at least one real person;
displaying the at least one virtual reality object to at least one camera operator through at least one video camera handled by the at least one camera operator;
recording video by the at least one video camera of the at least one real person moving within the real environment while appearing to attempt to interact with the at least one virtual reality object as part of playing a game;
generating virtual video of the at least one virtual reality object within the virtual reality environment depicting any action of the at least one virtual reality object in response to attempts by the at least one real person to interact with the at least one virtual reality object;
generating the video show by combining video of at least one player based on the at least one real person with the generated virtual video of the at least one virtual reality object to form a video of game play; and
transmitting the video show to at least one consumer location for the video show to be presented on at least one display screen at the at least one consumer location.
